(19) United States
(12) Patent Application Publication
(10) Pub. No.: US 2026/0039793 A1
(43) Pub. Date: Feb. 5, 2026

(54) METHOD FOR ENCODING, METHOD FOR DECODING, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Nengfu QIU, Dongguan (CN); Wenhan QIAO, Dongguan (CN); Ming LI, Dongguan (CN)

(21) Appl. No.: 19/353,418

(22) Filed: Oct. 8, 2025

Related U.S. Application Data
(63) Continuation of application No. PCT/CN2023/088533, filed on Apr. 14, 2023.

(51) Int. Cl. H04N 19/105; H04N 19/176; H04N 19/184; H04N 19/186

(52) U.S. Cl. CPC H04N 19/105; H04N 19/176; H04N 19/184; H04N 19/186

(57) ABSTRACT

A method for decoding includes: a first template of a current block is determined, and a BV candidate list of the current block is determined; a bitstream is decoded to determine BV indication information, and determine a first BV according to the BV indication information and the BV candidate list; a matching template and a reference block corresponding to the matching template are determined according to the first BV; model parameters are determined according to the first template and the matching template, the reference block is filtered according to the model parameters, and a filtered reference block is determined; and a prediction value of the current block is determined according to the filtered reference block.

### CROSS-REFERENCE TO RELATED APPLICATION

This application is a continuation of International Application No. PCT/CN2023/088533 filed on Apr. 14, 2023, the disclosure of which is hereby incorporated by reference in its entirety.

### TECHNICAL FIELD

The disclosure relates to the technical field of video encoding and decoding, and in particular to a method for encoding, a method for decoding, and a storage medium.

### BACKGROUND

Intra Block Copy (IBC) is a block-level encoding mode. Similar to an inter technology, it needs to perform a motion search to find a best Block Vector (BV) for each Coding Block (CB), and the BV is a vector pointed from a current block to a reference block. However, the best BV here is obtained by searching in a reconstructed region of a frame where the current block is located (i.e., a current coding frame), and a reference block to which the best BV is pointed is used as a prediction block of the current block.

However, in an actual coding process, reconstructed samples in a best matching reference block are usually directly used as prediction samples of a current CB in the related art. However, there may be significant deviations in some scenarios due to insufficient considerations, resulting in low prediction accuracy.

### BRIEF DESCRIPTION OF THE DRAWINGS

FIG. 1 is a schematic flowchart for acquiring a reconstructed sample value.

FIG. 2A is a schematic diagram of a template type of an IBC mode.

FIG. 2B is another schematic diagram of a template type of an IBC mode.

FIG. 2C is yet another schematic diagram of a template type of an IBC mode.

FIG. 2D is still another schematic diagram of a template type of an IBC mode.

FIG. 2E is still another schematic diagram of a template type of an IBC mode.

FIG. 2F is still another schematic diagram of a template type of an IBC mode.

FIG. 3 is a schematic diagram of a positional relationship between a current block and neighboring blocks.

FIG. 4 is a schematic diagram of a set of Block Vector Prediction (BVP) candidates located in an IBC reference region.

FIG. 5 is a schematic diagram of a relationship between a template position of a current block and a template position of a reference block.

FIG. 6 is a schematic diagram of clustering of BVP candidates.

FIG. 7A is a schematic diagram of a diamond search process.

FIG. 7B is a schematic diagram of another diamond search process.

FIG. 8 is a schematic diagram of a relationship among BV, BVP and Block Vector Difference (BVD).

FIG. 9A is a schematic diagram of a reference region corresponding to a current block.

FIG. 9B is another schematic diagram of a reference region corresponding to a current block.

FIG. 9C is yet another schematic diagram of a reference region corresponding to a current block.

FIG. 9D is still another schematic diagram of a reference region corresponding to a current block.

FIG. 10 is a schematic diagram of a reference region corresponding to a current block.

FIG. 11 is a schematic diagram of a reference region corresponding to a current block.

FIG. 12 is a schematic structural diagram for determining a refined chroma BV.

FIG. 13A is a schematic block diagram of a composition of an encoder provided in an embodiment of the disclosure.

FIG. 13B is a schematic block diagram of a composition of a decoder provided in an embodiment of the disclosure.

FIG. 14 is a schematic diagram of network architecture of an encoding and decoding system provided in an embodiment of the disclosure.

FIG. 15 is a schematic flowchart of a method for decoding provided in an embodiment of the disclosure.

FIG. 16A is a schematic diagram of a template type of an IBC mode provided in an embodiment of the disclosure.

FIG. 16B is another schematic diagram of a template type of an IBC mode provided in an embodiment of the disclosure.

FIG. 16C is yet another schematic diagram of a template type of an IBC mode provided in an embodiment of the disclosure.

FIG. 17 is a schematic structural diagram of an available reconstructed sample provided in an embodiment of the disclosure.

FIG. 18A is a schematic diagram of a boundary padding region provided in an embodiment of the disclosure.

FIG. 18B is a schematic diagram of another boundary padding region provided in an embodiment of the disclosure.

FIG. 19 is a schematic diagram of a shape of a filter provided in an embodiment of the disclosure.

FIG. 20A is a schematic compositional diagram of a filter coefficient provided in an embodiment of the disclosure.

FIG. 20B is a schematic compositional diagram of a prediction sample provided in an embodiment of the disclosure.

FIG. 21 is a schematic flowchart of a method for encoding provided in an embodiment of the disclosure.

FIG. 22 is a schematic diagram of a prediction process based on an Intra Block Copy based on Filter-based Linear Model (IBC-FLM) technology provided in an embodiment of the disclosure.

FIG. 23 is a schematic diagram of compositional structures of an encoder provided in an embodiment of the disclosure.

FIG. 24 is a schematic diagram of specific hardware structures of an encoder provided in an embodiment of the disclosure.

FIG. 25 is a schematic diagram of compositional structures of a decoder provided in an embodiment of the disclosure.

FIG. 26 is a schematic diagram of specific hardware structures of a decoder provided in an embodiment of the disclosure.

FIG. 27 is a schematic diagram of compositional structures of an encoding and decoding system provided in an embodiment of the disclosure.

### DETAILED DESCRIPTION

In order to understand characteristics and technical contents of the embodiments of the disclosure more thoroughly, implementations of the embodiments of the disclosure will be described in detail below with reference to the drawings. The drawings are only for the purpose of reference and explanation, and are not intended to limit the embodiments of the disclosure.

Unless otherwise defined, all technical and scientific terms used here have the same meanings as those usually understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all possible embodiments; however, it may be understood that “some embodiments” may be the same or different subsets of all possible embodiments, and may be combined with each other without conflict. It should also be pointed out that terms “first\second\third” involved in the embodiments of the disclosure are only intended to distinguish similar objects and do not represent a specific sequence of the objects. It may be understood that “first\second\third” may be interchanged in a specific order or sequence if allowable, such that the embodiments of the disclosure described here may be implemented in an order besides that illustrated or described here.

Nouns and terms involved in the embodiments of the disclosure are described first before further describing the embodiments of the disclosure in detail. The nouns and terms involved in the embodiments of the disclosure are applicable to the following explanations:
Coding Block (CB);
Coding Unit (CU);
Block Vector Difference (BVD);
Block Matching (BM);
Template Matching (TM);
Merge;
Advanced Motion Vector Prediction (AMVP);
Advanced Block Vector Prediction (ABVP);
Combined Inter and Intra Prediction (CIIP);
Geometric Partitioning Mode (GPM);
Local Illumination Compensation (LIC);
Reconstruction-Reordered IBC (RRIBC);
Sum of Absolute Difference (SAD);
Sum of Absolute Transformed Difference (SATD);
Mean Square Error (MSE);
Sum of Squared Differences (SSD);
Mean Absolute Deviation (MAD);
Mean Square Differences (MSD);
Normalized Correlation Coefficient (NCC);
Essential Video Coding (EVC);
H.265/High Efficiency Video Coding (HEVC);
H.266/Versatile Video Coding (VVC);
VVC Test Model (VTM), a reference software testing platform for VVC;
Enhanced Compression Model (ECM), a reference software testing platform beyond VVC.

It may be understood that in a video picture, a CB is usually characterized by using a first color component, a second color component, and a third color component. The three color components are a luma component, a blue chroma component, and a red chroma component respectively. Specifically, the luma component is usually represented by a symbol Y, the blue chroma component is usually represented by a symbol Cb or U, and the red chroma component is usually represented by a symbol Cr or V; in this way, the video picture may be represented in a YCbCr format or a YUV format.

It may also be understood that Intra Block Copy (IBC) is an extension tool of VVC for Screen Content Coding (SCC), that is, encoding of a screen content type of video sequence, which significantly improves encoding efficiency of the screen content sequence. The IBC is a block-level encoding mode. Similar to an inter technology, a motion search (BM) is performed at an encoding side, to find a best Block Vector (BV) (which may also be referred to as a Motion Vector (MV)) for each CB, and the BV is a vector pointed from a current block to a reference block. What different from the inter technology is that the best BV of the IBC is obtained by searching in a reconstructed region of a frame (that is, a current coding frame) where the current block is located, while an inter MV is obtained by searching a neighboring reference frame of the current coding frame in a time domain.

An IBC technology is used as an important tool for SCC in encoding standards such as H.265/HEVC SCC, H.266/VVC, AV1, AVS3, EVC, etc. The IBC technology is continuously used as a tool for SCC in an exploratory model ECM of a next generation encoding standard H.266/VVC, and the tool is expanded to a tool set where multiple modes are used in parallel. Furthermore, it is also introduced into an encoding field of ordinary natural videos, making it become a more versatile video encoding tool.

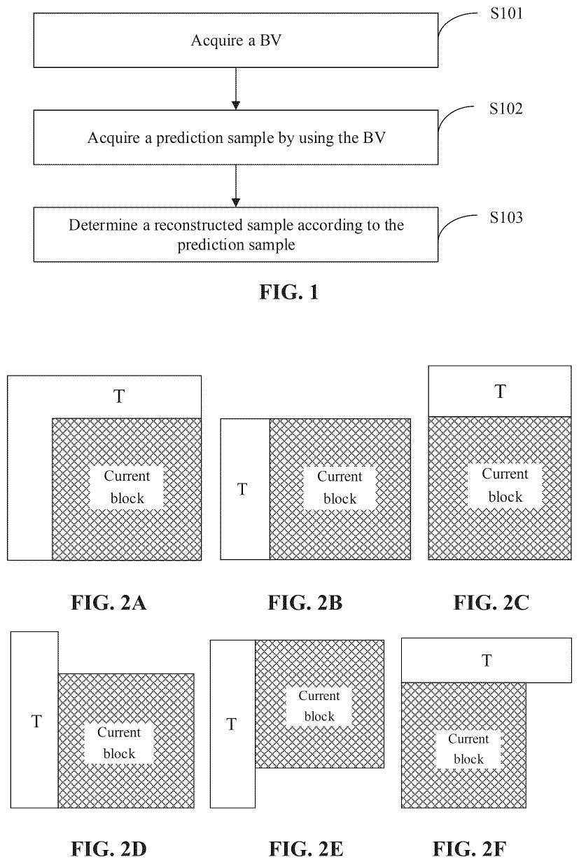

If there is an IBC mode at a decoding side, a basic decoding process includes several parts of acquiring a BV, acquiring a prediction value by using the BV, and determining a reconstructed value. Specifically, FIG. 1 is a schematic flowchart for acquiring a reconstructed sample value. As shown in FIG. 1, the process may include the following operations S101 to S103.

In operation S101, a BV is acquired.

It should be noted that at the decoding side, the BV may be acquired through syntax parsing. In an actual implementation, the BV may be acquired in multiple manners, therefore a bitstream may contain mode information on manners of acquiring the BV and corresponding parameter information. For example, if an IBC merge mode is acquired from a syntax element, a decoder constructs a merge list, parses an option index of the merge list, and then obtains specific information of the BV from a corresponding option in the merge list according to the index. For another example, in case of an ordinary IBC mode, the decoder obtains specific information of the BV by parsing a value of a syntax element that describes the BV or a prediction residual of the BV in the bitstream.

In operation S102, a prediction sample is acquired by using the BV.

It should also be noted that a prediction value may be acquired by using the BV. “using the BV” here usually refers to copying a corresponding region pointed to by the BV, such that the prediction value of the current block may be obtained.

In operation S103, a reconstructed sample is determined according to the prediction sample.

It should also be noted that as to acquisition of the reconstructed value, if there is a prediction residual, it needs to obtain the prediction residual by parsing the bitstream, and then perform addition, summation or other processes on the prediction residual and the prediction value, to obtain a final reconstructed value.

In the embodiments of the disclosure, use of templates and template matching costs are involved in several places, which are uniformly explained in advance here.

FIG. 2A to FIG. 2F are schematic diagrams of template types of an IBC mode. As shown in FIG. 2A to FIG. 2F, a block with grid shading is the current block, a neighboring region of the current block is a template T, and six template types are shown here.

For example, the template type may be represented by refTemplateType. The six template types are as follows:
when a top-left reference sample, a top reference sample and a left reference sample are all available, refTemplateType has a value of 1, and the template shape is shown in FIG. 2A;
when only the left reference sample is available, refTemplateType has a value of 2, and the template shape is shown in FIG. 2B;
when only the top reference sample is available, refTemplateType has a value of 3, and the template shape is shown in FIG. 2C;
when only the left reference sample and the top-left reference sample are available, refTemplateType has a value of 4, and the template shape is shown in FIG. 2D;
when only the left reference sample and a bottom-left reference sample are available, refTemplateType has a value of 5, and the template shape is shown in FIG. 2E; and
when only the top reference sample and a top right reference sample are available, refTemplateType has a value of 6, and the template shape is shown in FIG. 2F.

That is, there may be multiple template types which include, but are not limited to those shown in FIG. 2A to FIG. 2F. The multiple template types may be valid simultaneously, and they may be specified, selected and used by the syntax element, or may be used separately (for example, only the type of FIG. 2A is used).

In the embodiments of the disclosure, a preset cost function may be SAD, SATD, MSE, SSD, MAD, MSD, NCC or the like, which is not specifically limited here.

For example, taking SAD as an example, the cost function at this time is as follows:

$$SAD ( {T}_{i} ) = {\sum }_{m = 0}^{M - 1} \vert {T}_{i , m} - {T}_{m} \vert , m = 0 , 1 , ... , M - 1 \qquad ( 1 )$$

Here Tᵢ is a template in a search process, and M represents a number of samples in the template.

In a specific embodiment, as to the operation S101 of acquiring the BV, a specific process thereof is as follows.

### (i) Luma Component:

Input: luma position (xCb, yCb), which specifies a sample at a top-left corner of the current block relative to a luma sample at a top-left corner of a current picture; a variable cbWidth, which specifies a width of the current block in the luma sample; and a variable cbHeight, which specifies a height of the current block in the luma sample.

Output: Block Vector Luma (bvL) of luma.

The IBC mode may be substantially divided into two modes: IBC merge and IBC ABVP (similar to merge and AMVP modes of an inter mode in VVC), and their processes of acquiring the BV may be treated as the following three operations (1) to (3).

In operation (1), when bvL is derived, it needs to establish an IBC BV candidate list bvCandList.

In operation (2), a candidate in a selected candidate list is determined according to the bitstream.

In operation (3), a final BV is determined according to the candidate finally.

Information specifically stored in the IBC candidate includes at least one of the following information:
a prediction direction (L0 or L1, it is L0 by default in general);
BV information (a horizontal component, a vertical component);
a reference frame (it is the current picture by default);
a flip type (such as non-flip, horizontal flip, and vertical flip); or
whether LIC (a linear model) is used.

An establishment process of the BV candidate list will be introduced below. Taking an establishment process of an IBC merge list as an example, a basic establishment process of an IBC ABVP list is consistent with that of the IBC merge, while a maximum number of candidates is inconsistent between the two processes (for example, a length of the IBC merge candidate list is defined as 6, and a length of the IBC ABVP candidate list is defined as 2). A specific establishment process includes the following operations 1 and 5.

Operation 1: candidates in a spatial domain are derived.

When usage conditions are met (for example, a size condition IsGt4by4 is equal to TRUE, that is, the variable IsGt4by4 is TRUE when a product of multiplying a luma width by a luma height is greater than 16), a derivation process of spatial BV candidates from neighboring CUs specified in a decoding specification is called as an input by using the position (xCb, yCb) of the luma CB, the width cbWidth and height cbHeight of the luma CB, and outputs are availability flags such as availableFlagA1, availableFlagB1 and BVs bvA1 and bvB1.

Detection of availability of each candidate is as follows. The following conditions are judged, and the candidate is available if all the following conditions are met:
whether an offset position obtained by adding the position of the current block to Block Vector Prediction (BVP) does not exceed boundaries of a picture;
whether a block position pointed to by adding the position of the current block to the BVP does not cover the current block;
whether the offset position obtained by adding the position of the current block to the BVP does not exceed an IBC available region;
whether the block position pointed to by adding the position of the current block to the BVP has been reconstructed.

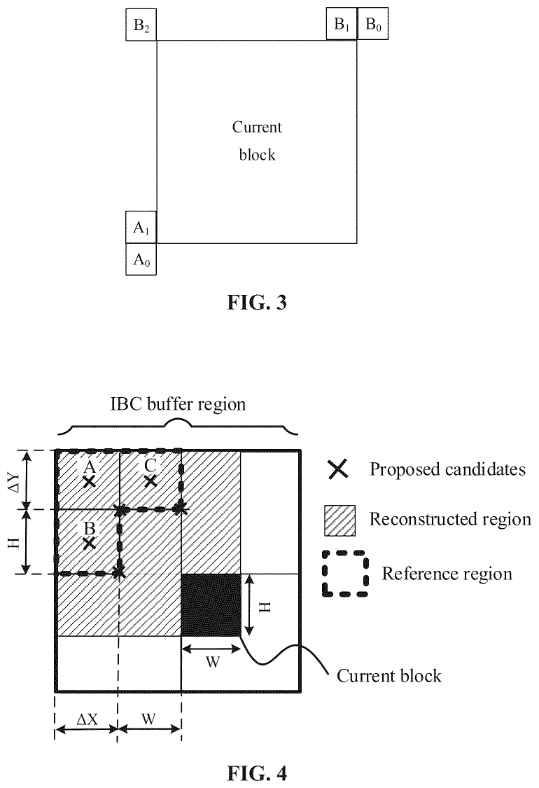

Relative positions of neighboring blocks where A1, B1 or the like are located and the current block are shown in FIG. 3. A traversal order in FIG. 3 may be A1->B1->B0->A0->B2.

Operation 2: candidates in the spatial domain are added to the candidate list.

When the usage conditions are met (for example, the size condition IsGt4by4 is equal to TRUE), the BV candidate list bvCandList is constructed as follows:

$$i = 0 ;$$

$$if ( availableFlagA 1 ) ;$$

$$bvCandList [ i ++ ] = bvA 1 ;$$

$$if ( availableFlagB 1 ) ;$$

$$bvCandList [ i ++ ] = bvB 1 ;$$

$$…$$

Operation 3: a number of valid items in the candidate list is checked.

A derivation process of a variable numCurrCand (a number of candidates obtained currently) is as follows.

If the usage conditions are met (for example, the size condition IsGt4by4 is equal to TRUE), numCurrCand is set to be equal to a number of candidates in bvCandList; otherwise, numCurrCand is set to 0.

Operation 4: if the candidate list does not reach a specified number of items (for example, a specified number of items in the IBC merge mode is 6, and a specified number of items in an IBC ABVP mode is 2), derivation of history-based candidates, detection of availability and addition are performed continuously.

When numCurrCand is less than MaxNumIbcMergeCand (a maximum number of candidates in the IBC merge mode) and NumHmvpIbcCand (a maximum number of candidates for a history-based optimal BV (Hmvp) in the IBC mode) is greater than 0, a derivation process of history-based IBC BV candidates specified in the decoding specification is called with bvCandList and numCurrCand as inputs and with the modified bvCandList and numCurrCand as outputs.

Operation 5: the number of valid items in the candidate list is continuously checked, and other available candidates (such as pairwise average candidates, zero-value BV candidates, etc.) are added, until the specified number of items is reached.

Exemplarily, other available candidates are as follows.

(1) The pairwise average candidate may be constructed by using first and second candidates, specifically:

$$mvAvgLX = ( mvCand 0 LX + mvCand 1 LX + 1 ) ≫ 1.$$

(2) The zero-value BV may be directly set as follows:
bvCandList[numCurrCand][0] is set to be equal to 0. (a horizontal component of bv)
bvCandList[numCurrCand][1] is set to be equal to 0. (a vertical component of bv)

(3) A group of BVP candidates located in an IBC reference region may also be used as candidates that may be added. Coordinates of the group of BVP candidates are determined by the width and height of the current block and parameters ΔX and ΔY, as shown in FIG. 4.

Each time an item is added, numCurrCand is increased by 1.

In this way, establishment of a basic BV candidate list bvCandList is completed.

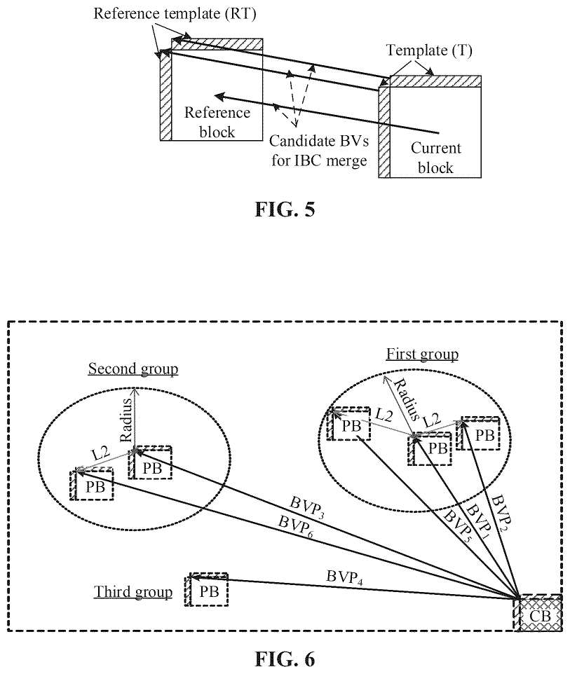

Based on this list, in the IBC merge mode, an order of the list may also be re-sorted by using templates, to adjust an order of the candidate list, fully utilize high spatial correlation, reduce transmission of encoded bits, and effectively improve encoding efficiency. For example, as to the IBC merge mode, after an intermediate candidate list is constructed according to the above list construction method (it is noted that a length of the intermediate candidate list may be equal to or greater than the maximum number of candidates in the IBC merge mode), all candidates in the list are re-sorted by using templates and are sorted in an ascending order of template matching costs, and first N (for example, N=6) candidates are selected from the sorted list. A specific process thereof is as follows. SADs of a template position of a reference block pointed to by each candidate and a template position of the current block (as shown in FIG. 5) are calculated and are sorted in an ascending order, and first 6 candidates are selected as the candidate list of the IBC merge.

Based on this list, in the IBC ABVP mode, an operation of removing redundancy of candidates may also be performed according to a distance between the candidates.

The number of the candidates remains unchanged at two, and candidate lists are established for integer-sample precision and 4-sample precision respectively.

If a non-RRIBC mode is selected for the IBC ABVP, if a number of valid BVP candidates exceeds two, at most six BVP candidates in the candidate list are clustered according to an Euclidean distance between the candidates, a radius (R) is a logarithmic function of a group of BVs determined as the width (cbWidth) and height (cbHeight) of the current block. If the Euclidean distance between reference positions pointed to by several BV candidates is less than R, the BV candidates are clustered:

$$R = {log}_{2} ( ( cbWidth \cdot cbHeight ) ≫ MIN\_PU \_SIZE ) \qquad ( 2 )$$

FIG. 6 is a schematic diagram of clustering of BVP candidates. As shown in FIG. 6, a block padded with grids is the CB, and blocks padded with white are Prediction Blocks (PBs). Three PBs pointed to by BVP₁, BVP₂ and BVP₅ constitute a first group, two PBs pointed to by BVP₃ and BVP₆ constitute a second group, and a PB pointed to by BVP₄ constitutes a third group. Here three BVP candidates in the first group are clustered, and two BVP candidates in the second group may also be clustered. It should be noted that the clustering method is performed in an order of the candidate list, a BVP with a minimum TM cost in each category is selected as a representative candidate of the group, then representative candidates of all categories are sorted by templates, and representative candidates of first two groups are selected for a motion estimation process.

If a RRIBC mode is selected for the IBC ABVP, the candidate may be adjusted to point to a boundary of a valid IBC search region in a horizontal or vertical direction according to the RRIBC mode.

Further, the candidate in the selected candidate list is determined according to the bitstream, and specific operations thereof are as follows.

In the IBV merge mode (general_merge_flag[xCb][yCb] is true) and the IBC ABVP mode (general_merge_flag[xCb][yCb] is false), a candidate index bvIdx is derived as follows, here general_merge_flag indicates whether it is the IBC merge mode:

$$bvIdx = general\_merge \_flax [ xCb ] [ yCb ] ? merge\_idx [ xCb ] [ yCb ] : mvp\_l0 \_flag [ xCb ] [ yCb ] .$$

Further, the final BV is determined according to the candidate.

In the IBC merge mode, a specific bvL may be obtained according to the index bvIdx and the BV candidate list bvCandList:

$$bvL [ 0 ] = bvCandList [ bvIdx ] [ 0 ] ;$$

$$bvL [ 1 ] = bvCandList [ bvIdx ] [ 1 ] ;$$

This bvL is the final BV.

In an IBC Merge with Block Vector Difference (MBVD) mode, similar to Merge with Motion Vector Difference (MMVD) in the inter technology of VVC, a certain candidate in the IBC merge list is used as a starting point, a candidate is selected from a candidate point set corresponding to a predefined distance and direction set, and a BV corresponding to the candidate is used as the final BV.

Exemplarily, in the IBC MBVD, a distance set is defined as {1-pel, 2-pel, 4-pel, 8-pel, 12 pel, 16 pel, 24 pel, 32 pel, 40 pel, 48 pel, 56 pel, 64 pel, 72 pel, 80 pel, 88 pel, 96 pel, 104 pel, 112 pel, 120 pel, 128 pel}, and BVD directions are two horizontal directions that is positive and negative horizontal directions, and two vertical directions that is positive and negative vertical directions.

A base candidate may be selected from first five candidates in the re-sorted IBC merge list, and refinement positions of all possible MBVDs of each base candidate (that is, 20×4 candidates) are re-sorted based on SAD cost between the template and its reference at each refinement position. Finally, first eight refinement positions with a minimum template SAD are retained for encoding of an MBVD index. Candidates of IBC-MBVD do not inherit flip types from neighboring blocks encoded by RR-IBC. The MBVD index is binarized by a Rice code with parameters equal to 1.

In an IBC TM merge mode, after obtaining bvL according to the above information, the BV may also be locally refined by TM, specific operations thereof are that search is performed in a small range centered on the obtained bvL, and an optimal BV in the range is selected with a minimum template matching cost as a standard, as the final BV.

TM refinement is performed on the candidate list in the IBC merge mode, a specific implementation process thereof is as follows.

When candidates are constructed, a flip type is non-flip by default.

As to the IBC TM merge mode, in the IBC merge mode, a syntax element is transmitted to specify whether TM refinement with the integer-sample precision is performed. A refinement MV in each refinement operation and a position where the used template is located must comply with constraints of the reference region.

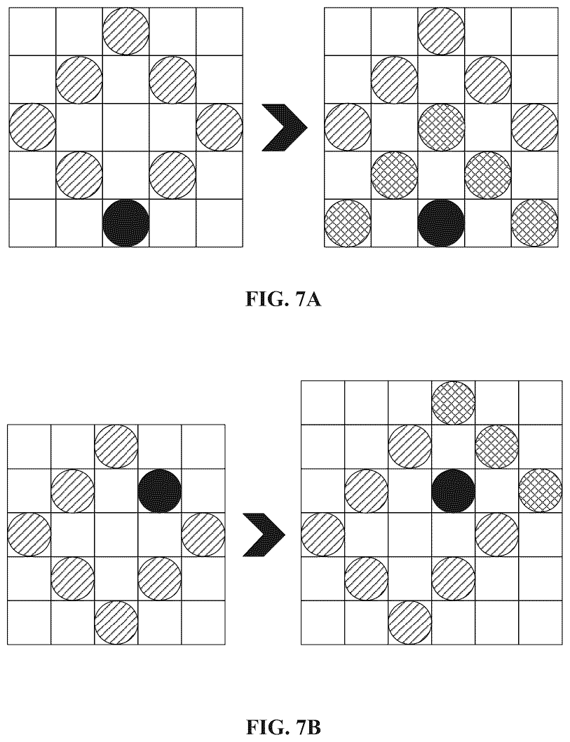

Search is performed near positions pointed to by the candidates, and an optimal position is determined by using SAD between the template of the reference block and the template of the current block, which includes, but is not limited to the following search manners. A search range is [−8, 8], an integer-sample diamond search is performed first to search eight points near a middle position, as shown in FIG. 7A and FIG. 7B; a maximum number of searches is 375, and after the optimal position is determined for the first time, the search is continuously performed to search 5 points at even positions and search 3 points at odd positions in subsequent search processes.

Exemplarily, taking FIG. 7A as an example, a circle is made counterclockwise from a black point, which is an order of indices 0 to 7. The above process is specifically that when the black point position is selected as the optimal position, 5 points at point positions of the grid are continuously searched; taking FIG. 7B as an example, when the black point position is selected as the optimal position, 3 points at point positions of the grid are continuously searched, which is only an exemplary description here and does not make a specific limitation.

After the above diamond search process, an integer-sample cross search is performed and is performed only once. That is, after a current optimal position is found by the diamond search, four positions below, right, above and left of the current optimal position with a sample apart from the current optimal position are checked, to update a final optimal position, that is, update and obtain a refined candidate list.

As to the IBC ABVP mode, bvL obtained by the index bvIdx and the BV candidate list bvCandList is a predicted bvL, and it also needs to add bvL to BVD to obtain a real bvL, a generalized specific process thereof is as follows.

Operation 1: horizontal and vertical components of the BVD are obtained, here MvdL0 is a forward MV difference.

$$bvd [ 0 ] = MvdL 0 [ xCb ] [ yCb ] [ 0 ] ;$$

$$bvd [ 1 ] = MvdL 0 [ xCb ] [ yCb ] [ 1 ] .$$

Operation 2: a rounding operation is performed on the predicted bvL acquired as above, here a parameter AmvrShift is right-shifted to perform rounding, and the parameter AmvrShift is left-shifted to improve resolution. Specifically:

$$offset = ( AmvrShift == 0 ) ? 0 : ( ( 1 ≪ ( AmvrShift - 1 ) ) - 1 ) ;$$

$$bvL [ 0 ] = Sign ( bvL [ 0 ] ) * ( ( ( Abs ( bvL [ 0 ] ) + offset ) ≫ AmvrShift ) ≪ AmvrShift ) ;$$

$$bvL [ 1 ] = Sign ( bvL [ 1 ] ) * ( ( ( Abs ( bvL [ 1 ] ) + offset ) ≫ AmvrShift ) ≪ AmvrShift ) .$$

Operation 3: the real bvL is derived as follows, and its range needs to be controlled between −217 and 217-1:

$$u [ 0 ] = ( bvL [ 0 ] + bvd [ 0 ] + 218 ) \% 218 ;$$

$$bvL [ 0 ] = ( u [ 0 ] >= 217 ) ? ( u [ 0 ] - 218 ) : u [ 0 ] ;$$

$$u [ 1 ] = ( bvL [ 1 ] + bvd [ 1 ] + 218 ) \% 218 ;$$

$$bvL [ 1 ] = ( u [ 1 ] >= 217 ) ? ( u [ 1 ] - 218 ) : u [ 1 ] .$$

It should be noted that the method for acquiring the BVD in Operation 1 may also be inferred from syntax elements obtained through other encoding methods. The BVD of the IBC ABVP takes a fractional-sample, an integer-sample or a 4-sample as a unit. During encoding, its sign may be predicted, and a suffix of an exponential-Golomb code obtained after its binarization may also be predicted. Therefore, its syntax elements may be defined by multiple information of a BVD value: a flag of 0 or not, a prefix, a sign and a suffix, an actual BVD value may be obtained by combining and parsing their information. A specific embodiment thereof is as follows.

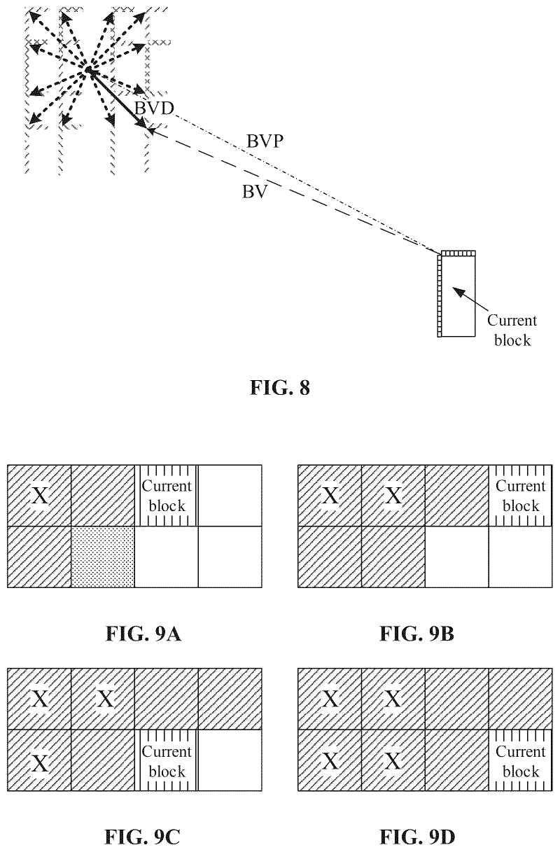

A flag indicating whether the BVD is 0 is context encoded. A value of (absolute value −1) is binarized by first-order exponential-Golomb, first 5 binary data (bins) of an EG1 prefix are context encoded, and remaining prefixes are bypass encoded. At most 4 bins of an EG1 suffix are context encoded to transmit a prediction index, and other bins of the EG1 suffix are bypass encoded. Two bins of the sign bit are context encoded to transmit a sign prediction index. FIG. 8 is a schematic diagram of a relationship among BV, BVP and BVD. As shown in FIG. 8, a dotted line represents the BV, a dash-dotted line represents the BVP, and a bold line represents the BVD. It is a prediction process where there is a suffix bin transmitting a prediction index in each of the horizontal direction and the vertical direction, and a bin transmitting a sign index in each of the horizontal direction and the vertical direction here, and it is sorted by using the template of the current block and the template at the corresponding BV, to derive prediction indices of the suffix and the sign.

In this way, the BV derived finally should meet that it is within a specified range (a coordinate range with row and column as units).

Exemplarily, the IBC reference region is 128×128 in VVC, and as to a Coding Tree Unit (CTU) with a size of 128×128, its reference region is shown in FIG. 9A to FIG. 9D. In FIG. 9A to FIG. 9D, two CTUs are included here no matter it is FIG. 9A, FIG. 9B, FIG. 9C or FIG. 9D, a region padded with oblique lines is the reference region, and a small block padded with vertical lines represents the current block with a size of 64×64; “×” represents an unavailable reference region.

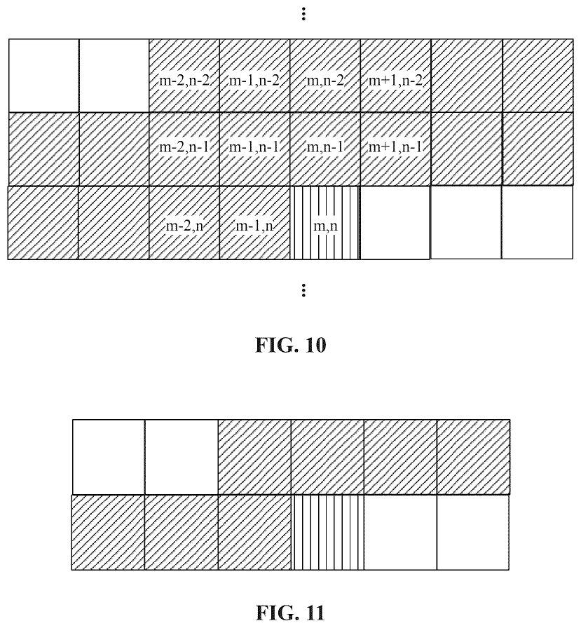

In ECM 7.0, as shown in FIG. 10, a box represents a CTU, a box padded with vertical lines represents a CTU where the current block is located, and boxes padded with oblique lines represent its reference region. Specifically, as to the current block to be encoded, assuming that it is located in CTU (m, n), the reference region includes CTUs with indices (m−2, n−2) . . . (W, n−2) . . . (0, n−1) . . . (W, n−1), (0, n) . . . (m, n). Here W represents a maximum horizontal index in a current tile, slice or picture.

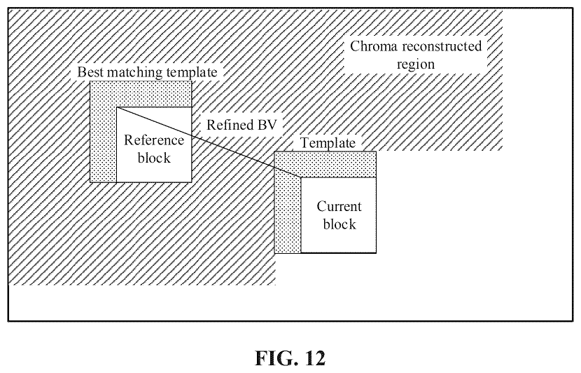

When the CTU has a size of 256×256, two top rows of CTUs may require an additional memory. In order to prevent the IBC from occupying the additional memory, the reference region is adjusted, as shown in FIG. 11. In FIG. 11, a box represents a CTU, a box padded with vertical lines represents a CTU where the current block is located, and boxes padded with oblique lines represent its reference region.

A range of performing BV search (or local search) for each block is limited to [−(C<<1), C>>2] in the horizontal direction and [−C, C>>2] in the vertical direction, to adapt to extension of the reference region, here C represents size of the CTU.

### (ii) Chroma Component:

In an IBC mode of the chroma component, a chroma BV may be derived based on a luma BV, and then prediction and reconstruction may be achieved according to the chroma BV. A process of deriving the chroma BV based on the luma BV is as follows.

Input: bvL of luma ( 1/16 sample precision);

Output: Block Vector Chroma (bvC) of chroma ( 1/32 sample precision).

The derivation process may be directly scaling, or scaling and then refining by TM.

As to the scaling operation, an example thereof is as follows:

$$bvC [ 0 ] = ( ( bvL [ 0 ] ≫ ( 3 + SubWidthC ) ) * 32 ) ;$$

$$bvC [ 1 ] = ( ( bvL [ 1 ] ≫ ( 3 + SubHeightC ) ) * 32 ) .$$

Variables SubWidthC and SubHeightC specifically depend on a chroma format sampling structure specified by sps_chroma_format_idc, and specific correspondences refer to Table 1, which shows correspondences between sps_chroma_format_idc and the chroma format sampling structure.

TABLE 1

| | color sampling | | |
|---|---|---|---|
| sps_chroma_format_idc | format | SubWidthC | SubHeightC |
| 0 | monochrome | 1 | 1 |
| 1 | 4:2:0 | 2 | 2 |
| 2 | 4:2:2 | 2 | 1 |
| 3 | 4:4:4 | 1 | 1 |

The refining operation may include the following manners.

After refining by TM, that is, obtaining the luma BV, an offset position is found by using position of a chroma block and the BV, a fine search is performed near the offset position by using a template, and an optimal BV (that is, a refined BV) is obtained with a minimum TM cost as a standard. As shown in FIG. 12, a region padded with oblique lines represents a chroma reconstructed region. As to the current block, a best matching template and a corresponding refined BV may be found in a TM manner, and a reference block at an optimal offset position obtained according to the refined BV is copied, such that a chroma prediction value of the current block may be determined.

In a specific embodiment, as to the operation S102 of acquiring the prediction sample by using the BV, a specific process thereof is as follows.

Input: luma position (xCb, yCb), which specifies a sample at a top-left corner of the current block relative to a luma sample at a top-left corner of a current picture; a variable cbWidth, which specifies a width of the current block in the luma sample; a variable cbHeight, which specifies a height of the current block in the luma sample; a block vector bv; and a variable cIdx, which specifies a color component index of the current block.

Output: an array predSamples of prediction samples.

In an implementation, an example of a derivation process of obtaining a prediction block by directly copying is as follows.

When cIdx is equal to 0, that is, in case of the luma component, for x=xCb . . . xCb+cbWidth−1 and y=yCb . . . yCb+cbHeight−1:

$$xVb = ( x + ( bvL [ 0 ] ≫ 4 ) ) \& ( IbcBufWidthY - 1 ) ;$$

$$yVb = ( y + ( bvL [ 1 ] ≫ 4 ) ) \& ( CtbSizeY - 1 ) ;$$

$$predSamples [ x ] [ y ] = ibcVirBuf [ 0 ] [ xVb ] [ yVb ] .$$

Here IbcBufWidthY is a width of a luma sample of a reconstructed buffer stored in the IBC, CtbSize Y is a size of the CTU, and ibcVirBuf is a reconstructed sample stored in the IBC.

When cIdx is not equal to 0, that is, in case of the chroma component, for x=xCb/SubWidthC . . . xCb/SubWidthC+cbWidth/SubWidthC−1 and y=yCb/SubHeightC . . . yCb/SubHeightC+cbHeight/SubHeightC−1:

$$xVb = ( x + ( bvC [ 0 ] ≫ 4 ) ) \& ( IbcBufWidthC - 1 ) ;$$

$$yVb = ( y + ( bvC [ 1 ] ≫ 4 ) ) \& ( ( CtbSizeY / subHeightC ) - 1 ) ;$$

$$predSamples [ x ] [ y ] = ibcVirBuf [ cIdx ] [ xVb ] [ yVb ] .$$

Besides the above basic acquisition methods, there is also an acquisition method in which a predicted region needs to be flipped horizontally or vertically in an IBC flip mode, to be used as a prediction value. For example, whether to flip is represented by a syntax element, and if so, whether to flip horizontally or vertically is represented by the syntax element. At the decoding side, samples of the reference region are reversely rearranged in the horizontal or vertical direction according to indication of the syntax, to acquire a prediction sample value of the CB.

Besides the above acquisition processes, a model between the current block and the predicted region may also be established by using a template, and the prediction block is processed based on the model, to obtain the prediction value of the current block. For example, an IBC LIC mode is applied to the IBC merge and the IBC ABVP, to compensate for local illumination variation by using a linear equation. Similar to LIC of inter prediction of VVC, parameters of the linear equation may be represented by a scaling parameter α and an offset parameter β, that is, α*p[x]+β, to compensate for illumination variation, here p[x] is a reference sample pointed to by position x of the BV on the current picture. Parameters of the linear model are derived by a least square method.

Based on the above acquisition of the prediction value, a weighted prediction with other intra prediction manners may also be implemented, and a result after the weighted prediction is used as a final prediction result.

Manners of the weighted prediction include a manner based on CIIP of VVC, that is, at each sample position, performing a weighted combination on the result obtained by the above prediction process and a prediction result obtained by an ordinary intra directional prediction mode; further include a manner based on inter GPM of VVC, that is, using a wedge division as a basis, using results obtained by different prediction modes in different wedge regions, and performing weighted mixing complying with a certain rule near wedge division lines.

An example of operation processes in an IBC CIIP mode is as follows. A weighted fusion is performed on an IBC prediction value of the current block and a prediction value of a certain intra mode, and an IBC prediction part may be obtained by applying conventional merge, TM merge, MBVD and ABVP modes.

In case that the IBC prediction part is conventional IBC merge, TM merge and MBVD modes, a ratio of weights of IBC prediction and intra prediction is 13:3. The intra mode includes a Template-based Intra Mode Derivation (TIMD) mode of the current block and an Intra Prediction Mode (IPM) at a candidate BV. If a second prediction mode in the intra mode is the same as a first prediction mode in the intra mode, it is determined whether the first prediction mode is a PLANAR mode. If so, the second prediction mode is replaced by a horizontal prediction mode; otherwise, the second prediction mode is replaced by the PLANAR mode.

In case that the IBC prediction part is the ABVP mode, a ratio of weights of IBC prediction and intra prediction is 1:1, and a first prediction mode where the TIMD mode is IPM is acquired. If the derived prediction mode is the horizontal prediction mode, a second prediction mode where PLANAR is IPM is acquired; otherwise, a second prediction mode where the horizontal prediction mode is IPM is acquired.

An example of operation processes in an IBC GPM mode is as follows. Conventional merge and TM merge may be applied to the IBC prediction part. Only a mode where a partition is IBC and a partition is INTRA is provided, an IPM candidate list is constructed by using the same method as the inter GPM, and a size of the IPM candidate list is predefined as 3.

In a specific implementation, there are 48 GPMs in total, which may be divided into two GPM sets. Table 2 is a first GPM set, and Table 3 is a second GPM set.

TABLE 2

| | | | | | | | | |
|---|---|---|---|---|---|---|---|---|
| ibc_gpm_partition_idx | 0 | 1 | 2 | 3 | 4 | 5 | 6 | 7 |
| angleIdx | 0 | 0 | 8 | 8 | 16 | 16 | 24 | 24 |
| distanceIdx | 1 | 3 | 1 | 3 | 1 | 3 | 1 | 3 |

TABLE 3

| | | | | | | | | | | |
|---|---|---|---|---|---|---|---|---|---|---|
| ibc_gpm_partition_idx | 0 | 1 | 2 | 3 | 4 | 5 | 6 | 7 | 8 | 9 |
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When the IBC GPM is used, a flag of a GPM set of the IBC GPM is transmitted to indicate whether the first GMP set or the second GMP set is selected, and then a GPM index is transmitted; then an IBC-GPM intra partition flag is transmitted to indicate whether the intra prediction is used for a first sub-partition. An intra prediction part needs to transmit an IPM index, and the IBC prediction part needs to transmit a MEGRE index.

Further, as to the operation S103 of determining the reconstructed sample, it may specifically be as follows.

If there is a residual, a decoding process of a residual signal specified in the decoding specification is called.

A picture reconstruction process of a specified color component specified in the decoding specification is called.

That is, after acquiring the prediction value, if there is a residual, the decoding process of the residual signal specified in the decoding specification may be called to obtain a residual value; then the reconstructed value may be obtained according to a sum of the prediction value and the residual value.

It may be seen that the IBC is a block-level encoding mode. Similar to the inter technology, a motion search (BM) is performed at the encoding side, to find a best BV for each CB, and the BV is a vector pointed from the current block to the reference block. However, in an actual coding process, direct usage of reconstructed samples in a best matching reference block as prediction samples of the current block is not optimal in some cases. For example, when there is a linear illumination variation between the best matching reference block and the current block, there may be a large deviation when the reconstructed samples in the best matching reference block are directly used as the prediction samples of the current block, and an optimal prediction effect cannot be achieved. Furthermore, when the IBC is used for encoding of a natural scene video, precision of the BV is limited, which easily results in a poor prediction result too. Even though the LIC mode is applied or weighted fusion with other Intra modes is performed, a good prediction precision cannot be achieved.

Based on this, an embodiment of the disclosure provides a method for encoding, in which a first template of a current block is determined, and a BV candidate list of the current block is determined; a first BV is determined according to the BV candidate list; a matching template and a reference block corresponding to the matching template are determined according to the first BV; model parameters are determined according to the first template and the matching template, the reference block is filtered according to the model parameters, and a filtered reference block is determined; and a prediction value of the current block is determined according to the filtered reference block.

An embodiment of the disclosure further provides a method for decoding, in which a first template of a current block is determined, and a BV candidate list of the current block is determined; a bitstream is decoded to determine BV indication information, and determine a first BV according to the BV indication information and the BV candidate list; a matching template and a reference block corresponding to the matching template are determined according to the first BV; model parameters are determined according to the first template and the matching template, the reference block is filtered according to the model parameters, and a filtered reference block is determined; and a prediction value of the current block is determined according to the filtered reference block.

In this way, the model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

The embodiments of the disclosure will be described in detail below with reference to the drawings.

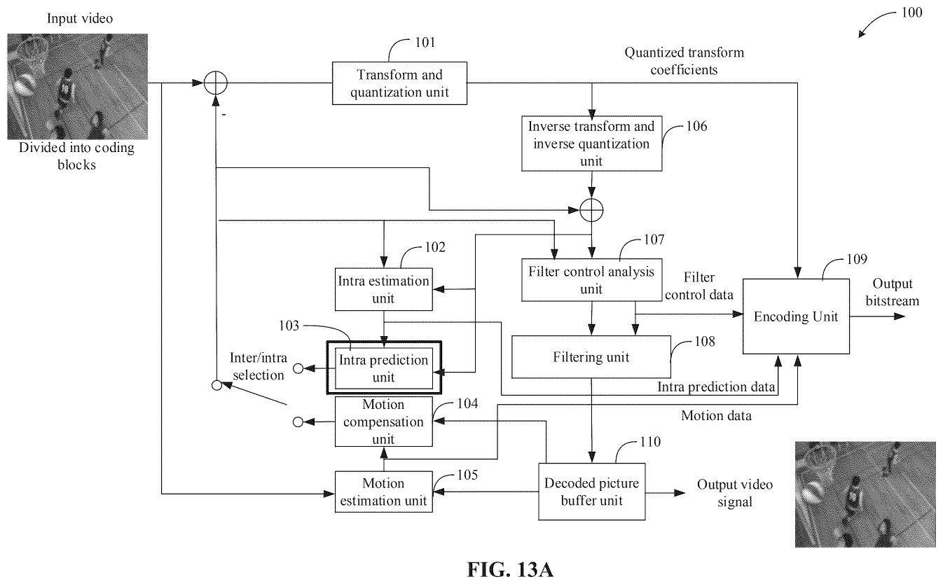

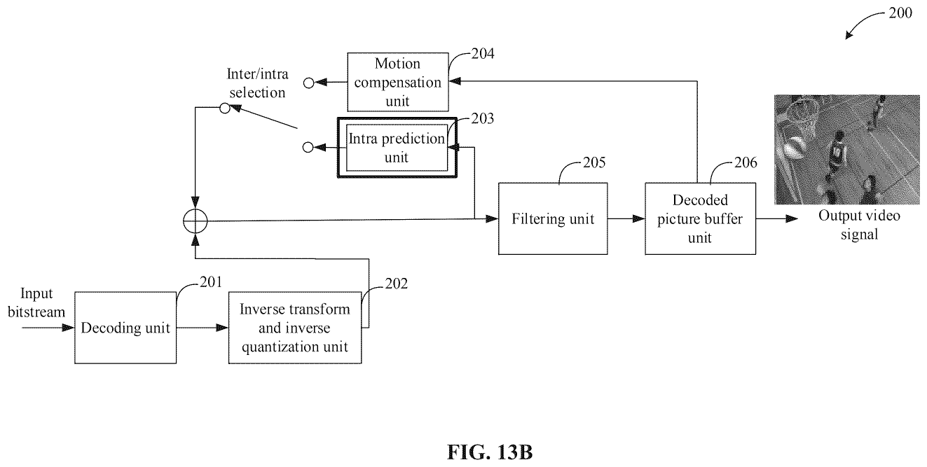

With reference to FIG. 13A, a schematic block diagram of a composition of an encoder provided in an embodiment of the disclosure is shown. As shown in FIG. 13A, the encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a CU 109, and a decoded picture buffer (DPB) unit 110, etc. The filtering unit 108 may implement de-blocking filtering and Sample Adaptive Offset (SAO) filtering, and the CU 109 may implement header information encoding and Context-based Adaptive Binary Arithmetic Coding (CABAC). As to an input original video signal, a video CB may be obtained through division of a CTU, and then the video CB is transformed by the transform and quantization unit 101 based on residual sample information obtained after intra or inter prediction, which includes transforming the residual information from a sample domain to a transform domain, and quantizing the obtained transform coefficients, to further reduce the bit rate. The intra estimation unit 102 and the intra prediction unit 103 are configured to perform intra prediction on the video CB; specifically, the intra estimation unit 102 and the intra prediction unit 103 are configured to determine an intra prediction mode to be used to encode the video CB. The motion compensation unit 104 and the motion estimation unit 105 are configured to perform inter prediction encoding of the received video CB relative to one or more blocks in one or more reference frames, to provide temporal prediction information; motion estimation performed by the motion estimation unit 105 is a process of generating a MV, the MV may estimate motion of the video CB, and then motion compensation is performed by the motion compensation unit 104 based on the MV determined by the motion estimation unit 105. After determining the intra prediction mode, the intra prediction unit 103 is further configured to provide the selected intra prediction data to the CU 109, and the motion estimation unit 105 also sends the calculated MV data to the CU 109. Furthermore, the inverse transform and inverse quantization unit 106 is configured to reconstruct the video CB and reconstruct a residual block in the sample domain, block effect artifacts are removed from the reconstructed residual block by the filter control analysis unit 107 and the filtering unit 108, and then the reconstructed residual block is added to a predictive block in a frame of the DPB unit 110, to generate a reconstructed video CB. The CU 109 is configured to encode various encoding parameters and quantized transform coefficients. In a CABAC-based encoding algorithm, a context content may be based on neighboring CBs, and may be configured to encode information indicating the determined intra prediction mode and output a bitstream of the video signal. The DPB unit 110 is configured to store the reconstructed video CB for reference of prediction. As encoding of the video picture proceeds, new reconstructed video CBs may be generated continuously, and these reconstructed video CBs may be stored in the DPB unit 110.

With reference to FIG. 13B, a schematic block diagram of a composition of a decoder provided in an embodiment of the disclosure is shown. As shown in FIG. 13B, the decoder (specifically, a “video decoder”) 200 includes a decoding unit 201, an inverse transform and inverse quantization unit 202, an intra prediction unit 203, a motion compensation unit 204, a filtering unit 205, and a DPB unit 206, etc. The decoding unit 201 may implement header information decoding and CABAC decoding, and the filtering unit 205 may implement de-blocking filtering and SAO filtering. After the input video signal is encoded in FIG. 13A, a bitstream of the video signal is output. The bitstream is input to the decoder 200, and passes through the decoding unit 201 first to obtain the decoded transform coefficients. The transform coefficients are processed by the inverse transform and inverse quantization unit 202, to generate a residual block in the sample domain. The intra prediction unit 203 may be configured to generate prediction data of a current video decoding block based on the determined intra prediction mode and data from a previously decoded block of the current frame or picture. The motion compensation unit 204 is configured to determine prediction information for the video decoding block by analyzing the MV and other associated syntax elements, and use the prediction information to generate a predictive block of the video decoding block being decoded. A decoded video block is formed by summing the residual block from the inverse transform and inverse quantization unit 202 and the corresponding predictive block generated by the intra prediction unit 203 or the motion compensation unit 204. The decoded video signal passes through the filtering unit 205 to remove block effect artifacts therefrom, which may improve video quality. Then, the decoded video block is stored in the DPB unit 206, the DPB unit 206 stores reference pictures used for subsequent intra prediction or motion compensation, and is also used for output of the video signal, that is, the restored original video signal is obtained.

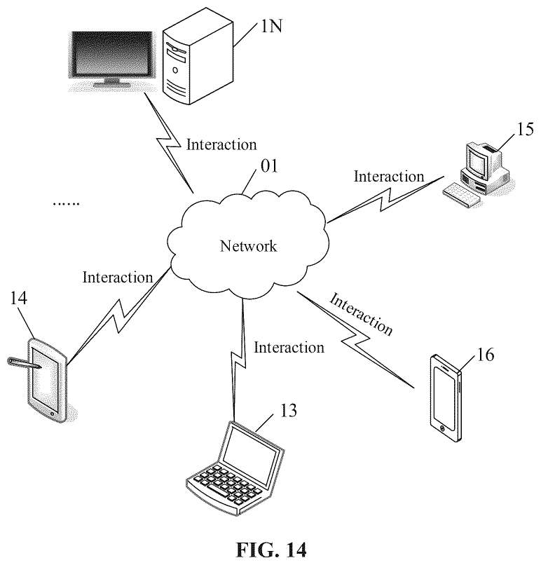

Further, an embodiment of the disclosure further provides network architecture of an encoding and decoding system including an encoder and a decoder, here FIG. 14 shows a schematic diagram of network architecture of an encoding and decoding system provided in an embodiment of the disclosure. As shown in FIG. 14, the network architecture includes one or more electronic devices 13 to 1N and a communication network 01, here the electronic devices 13 to 1N may perform video interaction through the communication network 01. The electronic devices may be various types of devices with video encoding and decoding functions during implementation, for example, the electronic devices may include a smart phone, a tablet computer, a personal computer, a Personal Digital Assistant (PDA), a navigator, a digital phone, a video phone, a television, a sensor device, a server, or the like, which is not specifically limited in the embodiments of the disclosure. Here, the decoder or the encoder described in the embodiments of the disclosure may be the above electronic devices.

It should be noted that methods of the embodiments of the disclosure are mainly applied to the intra prediction unit 103 part shown in FIG. 13A and the intra prediction unit 203 part shown in FIG. 13B. That is, the embodiments of the disclosure may be applied to the encoder, or may be applied to the decoder, or may even be applied to the encoder and the decoder simultaneously, which is not specifically limited in the embodiments of the disclosure.

It should also be noted that when the methods are applied to the intra prediction unit 103 part, “current block” specifically refers to a CB to be intra predicted currently; when the methods are applied to the intra prediction unit 203 part, “current block” specifically refers to a decoding block to be intra predicted currently.

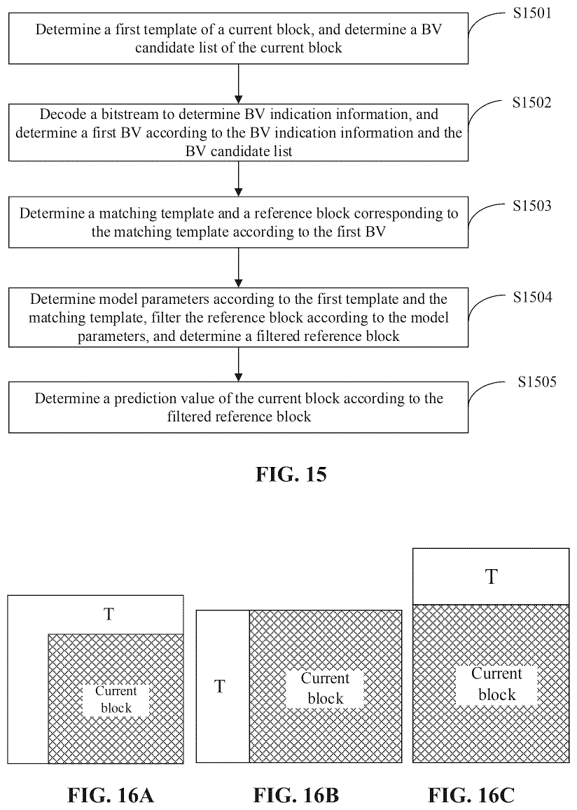

In an embodiment of the disclosure, with reference to FIG. 15, a schematic flowchart of a method for decoding provided in an embodiment of the disclosure is shown. As shown in FIG. 15, the method may include the following operations S1501 to S1505.

In operation S1501, a first template of a current block is determined, and a BV candidate list of the current block is determined.

It should be noted that the method for decoding according to the embodiment of the disclosure is applied to a decoder. Furthermore, the method for decoding may specifically refer to an intra prediction method, and more specifically, refers to an intra prediction method based on an Intra Block Copy based on Filter-based Linear Model (IBC-FLM) technology, but is not limited to the IBC mode, and may be applicable to other modes to which the BV is applied. The video picture may be divided into multiple decoding blocks, and the current block in the embodiment of the disclosure refers to a decoding block to be intra predicted currently from the video picture. Furthermore, both the luma component and the chroma component may be predicted by the method for decoding according to the embodiment of the disclosure, which is not specifically limited here.

It should also be noted that in the embodiment of the disclosure, it needs to determine the first template of the current block first, such that a matching template and a reference block corresponding to the matching template may be determined according to the first template. In some embodiments, the operation of determining the first template of the current block may include the following operations.

A template type of the current block is determined.

The first template of the current block is determined according to the template type of the current block.

The template type may be represented by refTemplateType. In some embodiments, the operation of determining the template type of the current block may include the following operation. The template type of the current block is determined according to reference samples of the current block.

The reference samples of the current block include at least one of a left neighboring reference sample of the current block, a top neighboring reference sample of the current block, or a top-left neighboring reference sample of the current block.

Exemplarily, FIG. 16A to FIG. 16C show schematic diagrams of template types of an IBC mode provided in an embodiment of the disclosure. When a top-left reference sample, a top reference sample and a left reference sample are all available, refTemplateType has a value of 1, and shape of the template type is shown in FIG. 16A; when only the left reference sample is available, refTemplateType has a value of 2, and the shape of the template type is shown in FIG. 16B; and when only the top reference sample is available, refTemplateType has a value of 3, and the shape of the template type is shown in FIG. 16C.

That is, in the embodiment of the disclosure, reference samples of the current block are determined based on neighboring reconstructed regions of the current block. The neighboring reconstructed regions of the current block include at least one of a left neighboring region, a top neighboring region, or a top-left neighboring region. For example, a left neighboring reference sample of the current block may be determined by at least one column of reconstructed samples in the left neighboring region, a top neighboring reference sample of the current block may be determined by at least one row of reconstructed samples in the top neighboring region, a top-left neighboring reference sample of the current block may be determined by at least one column of reconstructed samples in the top-left neighboring region, or the like, which is not specifically limited here.

Further, the template types may be classified and the template type of the current block may be determined according to availability of neighboring reference samples. In some embodiments, the operation of determining the template type of the current block may include the following operation.

If both the left neighboring reference sample of the current block and the top neighboring reference sample of the current block are available, a bitstream is decoded to determine the template type of the current block.

It should be noted that in the embodiment of the disclosure, the template type of the current block may be preset, or may be determined by decoding the bitstream. If all the left neighboring reference sample of the current block, the top neighboring reference sample of the current block and the top-left neighboring reference sample of the current block are available, the template type of the current block is determined as a first type value; if the left neighboring reference sample of the current block is available, the template type of the current block is determined as a second type value; and if the top neighboring reference sample of the current block is available, the template type of the current block is determined as a third type value. Exemplarily, if both the left neighboring reference sample and the top neighboring reference sample are available, there may also be a second type of template and a third type of template. At this time, which template is used may be specified by the bitstream.

In the embodiment of the disclosure, the first type value, the second type value and the third type value may be different from each other. Exemplarily, the first type value may be set to 1, the second type value may be set to 2, and the third type value may be set to 3. Furthermore, as to the three template types, reference may be made to FIG. 16A to FIG. 16C for their details.

It should also be noted that in the embodiment of the disclosure, the template type of the current block is usually L-shaped, that is, the template type of FIG. 16A. As to the L-shaped template, it may consist of the left neighboring reference sample of the current block and the top neighboring reference sample of the current block, or may consist of the left neighboring reference sample of the current block, the top neighboring reference sample of the current block and the top-left neighboring reference sample of the current block. It is unnecessary to specifically point out the top-left neighboring reference sample in general, since the L-shaped template may not include a top-left sample actually; in other words, when both left and top samples are available, the top-left neighboring sample is also available.

In some embodiments, the operation of determining the first template of the current block according to the template type of the current block may include the following operations. Template samples of the current block are acquired according to the template type of the current block and a corresponding template size. The template samples of the current block are determined as the first template of the current block.

In the embodiment of the disclosure, the template size may be preset, or may be determined according to a size of the current block, or may even be related to the template type of the current block, which is not specifically limited here.

Exemplarily, if the template type indicates that only a left template is acquired, a template width templateW_size may be set to 4; and if the template type indicates that only a top template is acquired, a template height templateH_size may be set to 4.

Furthermore, which part of reconstructed samples are acquired by the first template, may be determined according to the value of the template type. For example, when refTemplateType has a value of 1, reconstructed samples at a left side, a top-left side and a top side of the current block are acquired; when refTemplateType has a value of 2, only reconstructed samples on left four columns of the current block are acquired; and when refTemplateType has a value of 3, only reconstructed samples on top four rows of the current block are acquired.

It should also be noted that in the embodiment of the disclosure, the template type of the current block may also be signalled into the bitstream. In this way, at the decoding side, the template type of the current block may be determined by decoding the bitstream; and then the first template of the current block may be determined according to the template type, which is not limited in any way.

It may be understood that in the embodiment of the disclosure, it also needs to construct the BV candidate list for the IBC mode here. Taking an establishment process of an IBC merge candidate list as an example, an establishment process of an IBC ABVP candidate list is consistent with that of the IBC merge, while a maximum number of candidates is inconsistent between the two processes. For example, a length of the IBC merge candidate list may be defined as 6, and a length of the IBC ABVP candidate list may be defined as 2.

In some embodiments, the operation of determining the BV candidate list of the current block may include the following operations. At least one first candidate BV neighboring to the current block is determined based on a derivation manner of spatial BV candidates. The at least one first candidate BV is added to the BV candidate list. If a number of candidates in the BV candidate list meets a preset threshold, a current BV candidate list is used as the BV candidate list of the current block.

It should be noted that during construction of the BV candidate list, candidates in a spatial domain are derived first. Specifically, when usage conditions are met (for example, a size condition IsGt4by4 is equal to TRUE, that is, the variable IsGt4by4 is TRUE when a product of multiplying a luma width by a luma height is greater than 16), a derivation process of spatial BV candidates from neighboring CUs specified in a decoding specification is called as an input by using the position (xCb, yCb) of the luma CB, the width cbWidth and height cbHeight of the luma CB, and outputs are availability flags such as availableFlagA1, availableFlagB1 and BVs bvA1 and bvB1.

Detection of availability of each candidate is as follows. The following conditions are judged, and the candidate is available if all the following conditions are met:
whether an offset position obtained by adding the position of the current block to BVP does not exceed boundaries of a picture;
whether a block position pointed to by adding the position of the current block to the BVP does not cover the current block;
whether the offset position obtained by adding the position of the current block to the BVP does not exceed an IBC available region;
whether the block position pointed to by adding the position of the current block to the BVP has been reconstructed.

It should also be noted that in the embodiment of the disclosure, taking FIG. 3 as an example, relative positions of neighboring blocks where A1, B1 or the like are located and the current block refer to FIG. 3, and a traversal order in FIG. 3 may be A1->B1->B0->A0->B2.

Secondly, candidates in the spatial domain are added to the candidate list. When the usage conditions are met (for example, the size condition IsGt4by4 is equal to TRUE), the BV candidate list bvCandList is constructed as follows:

$$i = 0 ;$$

$$if ( availableFlagA 1 ) ;$$

$$bvCandList [ i ++ ] = bvA 1 ;$$

$$if ( availableFlagB 1 ) ;$$

$$bvCandList [ i ++ ] = bvB 1 ;$$

$$…$$

Thirdly, a number of valid candidates in the BV candidate list is checked. A derivation process of a variable numCurrCand (a number of candidates obtained currently) is as follows.

If the usage conditions are met (for example, the size condition IsGt4by4 is equal to TRUE), numCurrCand is set to be equal to a number of candidates in bvCandList; otherwise, numCurrCand is set to 0.

Further, in some embodiments, the method may further include the following operations. If the number of candidates in the BV candidate list does not meet the preset threshold, at least one second candidate BV is determined based on a derivation manner of history-based BV candidates, and the at least one second candidate BV is continuously added to the BV candidate list. If the number of candidates in the BV candidate list meets the preset threshold, the current BV candidate list is used as the BV candidate list of the current block.

It should also be noted that if the candidate list does not reach a specified number of items (for example, a specified number of items in the IBC merge mode is 6, and a specified number of items in an IBC ABVP mode is 2), derivation of history-based candidates, detection of availability and addition are performed continuously.

When numCurrCand is less than MaxNumIbcMergeCand (a maximum number of candidates in the IBC merge mode) and NumHmvpIbcCand (a maximum number of candidates for a history-based optimal BV (Hmvp) in the IBC mode) is greater than 0, a derivation process of history-based IBC BV candidates specified in the decoding specification is called with bvCandList and numCurrCand as inputs and with the modified bvCandList and numCurrCand as outputs.

Further, in some embodiments, the method may further include the following operation. If the number of candidates in the BV candidate list does not meet the preset threshold, at least one third candidate BV is determined based on derivation manners of other available candidates, and the at least one third candidate BV is continuously added to the BV candidate list, until the number of candidates in the BV candidate list meets the preset threshold.

In the embodiment of the disclosure, the derivation manners of other available candidates may include at least one of a derivation manner of pairwise average candidates, a derivation manner of zero-value BV candidates, or a derivation manner of candidates in a reference region corresponding to IBC.

It should also be noted that after the at least one second candidate BV is continuously added to the BV candidate list, the number of valid items in the candidate list is continuously checked, and other available candidates (such as pairwise average candidates, zero-value BV candidates, etc.) are added, until the specified number of items is reached.

Exemplarily, other available candidates are as follows.

(1) The pairwise average candidate may be constructed by using first and second candidates, specifically:

$$mvAvgLx = ( m v C and 0 LX + mvCand 1 LX + 1 ) ≫ 1.$$

(2) The zero-value BV may be directly set as follows:
bvCandList[numCurrCand][0] is set to be equal to 0. (a horizontal component of bv)
bvCandList[numCurrCand][1] is set to be equal to 0. (a vertical component of bv)

(3) A group of BVP candidates located in an IBC reference region may also be used as candidates that may be added. Coordinates of the group of BVP candidates are determined by the width and height of the current block and parameters ΔX and ΔY, as shown in FIG. 4.

It should also be noted that in the embodiment of the disclosure, each time an item is added, numCurrCand is increased by 1. In this way, establishment of a basic BV candidate list bvCandList is completed until numCurrCand meets the preset threshold.

Further, the method may further include the following operation after construction of the BV candidate list is completed. After determining the BV candidate list of the current block, the BV candidate list is sorted.

It should be noted that in the embodiment of the disclosure, in the IBC merge mode, an order of the list may also be re-sorted by using templates, to adjust an order of the candidate list, fully utilize high spatial correlation, reduce transmission of encoded bits, and effectively improve encoding efficiency. For example, as to the IBC merge mode, after an intermediate candidate list is constructed according to the above list construction method (it is noted that a length of the intermediate candidate list may be equal to or greater than the maximum number of candidates in the IBC merge mode), all candidates in the list are re-sorted by using templates and are sorted in an ascending order of template matching costs, and first N (for example, N=6) candidates are selected from the sorted list. A specific process thereof is as follows. SADs of a template position of a reference block pointed to by each candidate and a template position of the current block (as shown in FIG. 5) are calculated and are sorted in an ascending order, and first 6 candidates are selected as the candidate list of the IBC merge.

Further, the method may further include the following operation after construction of the BV candidate list is completed. After determining the BV candidate list of the current block, redundancy is removed according to a distance between candidate BVs in the BV candidate list.

It should be noted that in the embodiment of the disclosure, the operation of removing the redundancy may include the following operation. If a non-flip IBC mode is selected for the current block, at least one of at least two candidate BVs in the BV candidate list is deleted when a distance between the at least two candidate BVs meets a preset condition.

It should also be noted that in the embodiment of the disclosure, in the IBC ABVP mode, an operation of removing redundancy of candidates may also be performed according to a distance between the candidates. The number of the candidates remains unchanged at two, and candidate lists are established for integer-sample precision and 4-sample precision respectively.

If a non-RRIBC mode is selected for the IBC ABVP, if a number of valid BVP candidates exceeds two, at most six BVP candidates in the candidate list are clustered according to an Euclidean distance between the candidates, a radius (R) is a logarithmic function of a group of BVs determined as the width (cbWidth) and height (cbHeight) of the current block. If the Euclidean distance between reference positions pointed to by several BV candidates is less than R, the BV candidates are clustered: R=log₂((cbWidth·cbHeight)>>MIN_PU_SIZE).

Further, in some embodiments, the method may further include the following operations. If a flip IBC mode is selected for the current block, the candidate BV in the BV candidate list is adjusted to point to a boundary of a valid block copy search region according to a preset direction of the flip IBC mode. That is, if a RRIBC mode is selected for the IBC ABVP, the candidate may be adjusted to point to a boundary of a valid IBC search region in a horizontal or vertical direction according to the RRIBC mode.

In this way, construction of the BV candidate list is completed.

In operation S1502, a bitstream is decoded to determine BV indication information, and determine a first BV according to the BV indication information and the BV candidate list.

It should be noted that in the embodiment of the disclosure, the BV indication information may be different in different prediction modes, for example, the BV indication information may be a BV index number, a BVD value or the like, which is not specifically limited here.

In a possible implementation, the BV indication information may include a BV index number. The operation of determining the first BV according to the BV indication information and the BV candidate list may include the following operations. A candidate BV corresponding to the BV index number is determined from the BV candidate list. The candidate BV is used as the first BV.

Exemplarily, in the IBC merge mode, a specific bvL may be obtained according to the BV index number bvIdx and the BV candidate list bvCandList:

$$b v L [ 0 ] = b v CandLis t [ b v I d x ] [ 0 ] ;$$

$$bvL [ 1 ] = b v CandLis t [ b v I d x ] [ 1 ] ;$$

This bvL is the final BV.

In another possible implementation, the BV indication information includes a BV index number and a BVD value. The operation of determining the first BV according to the BV indication information and the BV candidate list may include the following operations. A candidate BV corresponding to the BV index number is determined from the BV candidate list. The first BV is determined according to the candidate BV and the BVD value.

Exemplarily, as to the IBC ABVP mode, bvL obtained by the BV index number bvIdx and the BV candidate list bvCandList is a predicted bvL, and it also needs to add bvL to BVD to obtain a real bvL, a generalized specific process thereof is as follows.

Operation 1: horizontal and vertical components of the BVD are obtained, here MvdL0 is a forward MV difference.

$$b v d [ 0 ] = MvdL 0 [ x C b ] [ y C b ] [ 0 ] ;$$

$$bvd [ 1 ] = MvdL 0 [ x C b ] [ y C b ] [ 1 ] .$$

Operation 2: a rounding operation is performed on the predicted bvL acquired as above, here a parameter AmvrShift is right-shifted to perform rounding, and the parameter AmvrShift is left-shifted to improve resolution. Specifically:

$$offset = ( A m v r S hift == 0 ) ? 0 : ( ( 1 ≪ ( AmvrShift - 1 ) ) - 1 ) ;$$

$$bvL [ 0 ] = Sign ( bvL [ 0 ] ) * ( ( ( Abs ( bv L [ 0 ] ) + offset ) ≫ AmvrShift ) ≪ AmvrShift ) ;$$

$$bvL [ 1 ] = Sign ( bvL [ 1 ] ) * ( ( ( Abs ( bv L [ 1 ] ) + offset ) ≫ AmvrShift ) ≪ AmvrShift ) .$$

Operation 3: the real bvL is derived as follows, and its range needs to be controlled between −217 and 217-1:

$$u [ 0 ] = ( b v L [ 0 ] + b v d [ 0 ] + 218 ) \%218 ;$$

$$bvL [ 0 ] = ( u [ 0 ] >= 217 ) ? ( u [ 0 ] - 2 \; 18 ) : u [ 0 ] ;$$

$$u [ 1 ] = ( b v L [ 1 ] + b v d [ 1 ] + 2 \; 18 ) \%218 ;$$

$$bvL [ 1 ] = ( u [ 1 ] >= 217 ) ? ( u [ 1 ] - 2 \; 18 ) : u [ 1 ] .$$

It should be noted that the method for acquiring the BVD in Operation 1 may also be inferred from syntax elements obtained through other encoding methods. The BVD of the IBC ABVP takes a fractional-sample, an integer-sample or a 4-sample as a unit. During encoding, its sign may be predicted, and a suffix of an exponential-Golomb code obtained after its binarization may also be predicted. Therefore, its syntax elements may be defined by multiple information of the BVD value: a flag of 0 or not, a prefix, a sign and a suffix, an actual BVD value may be obtained by combining and parsing their information. A specific embodiment thereof is as follows.

It should also be noted that a flag indicating whether the BVD is 0 is context encoded. A value of (absolute value −1) is binarized by first-order exponential-Golomb, first 5 binary data (bins) of an EG1 prefix are context encoded, and remaining prefixes are bypass encoded. At most 4 bins of an EG1 suffix are context encoded to transmit a prediction index, and other bins of the EG1 suffix are bypass encoded. Two bins of the sign bit are context encoded to transmit a sign prediction index. FIG. 8 is a schematic diagram of a relationship among BV, BVP and BVD. As shown in FIG. 8, it is a prediction process where there is a suffix bin transmitting a prediction index in each of the horizontal direction and the vertical direction, and a bin transmitting a sign index in each of the horizontal direction and the vertical direction here, and it is sorted by using the template of the current block and the template at the corresponding BV, to derive prediction indices of the suffix and the sign.

In yet another possible implementation, the BV indication information includes a BV index number. The operation of determining the first BV according to the BV indication information and the BV candidate list may include the following operations. A candidate BV corresponding to the BV index number is determined from the BV candidate list. A first candidate set is determined according to the candidate BV and predefined parameters. A BV search is performed within the first candidate set, to determine the first BV.

Exemplarily, in an IBC MBVD mode, similar to MMVD in the inter technology of VVC, a certain candidate in the IBC merge list is used as a starting point, a candidate is selected from a candidate point set corresponding to a predefined distance and direction set, and a BV corresponding to the candidate is used as the final BV.

Exemplarily, in the IBC MBVD, a distance set is defined as {1-pel, 2-pel, 4-pel, 8-pel, 12 pel, 16 pel, 24 pel, 32 pel, 40 pel, 48 pel, 56 pel, 64 pel, 72 pel, 80 pel, 88 pel, 96 pel, 104 pel, 112 pel, 120 pel, 128 pel}, and BVD directions are two horizontal directions that is positive and negative horizontal directions, and two vertical directions that is positive and negative vertical directions.

In this way, a base candidate may be selected from first five candidates in the re-sorted IBC merge list, and refinement positions of all possible MBVDs of each base candidate (that is, 20×4 candidates) are re-sorted based on SAD cost between the template and its reference at each refinement position. Finally, first eight refinement positions with a minimum template SAD are retained for encoding of an MBVD index. Candidates of IBC-MBVD do not inherit flip types from neighboring blocks encoded by RR-IBC. The MBVD index is binarized by a Rice code with parameters equal to 1.

In yet another possible implementation, the BV indication information includes a BV index number. The operation of determining the first BV according to the BV indication information and the BV candidate list may include the following operations. A candidate BV corresponding to the BV index number is determined from the BV candidate list. A first search region centered on the candidate BV is determined, and search is performed in the first search region based on a template matching manner, to determine the first BV.

In an IBC TM merge mode, after obtaining bvL according to the above information, the BV may also be locally refined by TM, specific operations thereof are that search is performed in a small range centered on the obtained bvL, and an optimal BV in the range is selected with a minimum template matching cost as a standard, as the final BV.

TM refinement is performed on the candidate list in the IBC merge mode, a specific implementation process thereof is as follows.

When candidates are constructed, a flip type is non-flip by default.

As to the IBC TM merge mode, in the IBC merge mode, a syntax element is transmitted to specify whether TM refinement with the integer-sample precision is performed. A refinement MV in each refinement operation and a position where the used template is located must comply with constraints of the reference region.

Search is performed near positions pointed to by the candidates, and an optimal position is determined by using SAD between the template of the reference block and the template of the current block, which includes, but is not limited to the following search manners. A search range is [−8, 8], an integer-sample diamond search is performed first to search eight points near a middle position, as shown in FIG. 7A and FIG. 7B; a maximum number of searches is 375, and after the optimal position is determined for the first time, the search is continuously performed to search 5 points at even positions and search 3 points at odd positions in subsequent search processes.

After the above diamond search process, an integer-sample cross search is performed and is performed only once. That is, after a current optimal position is found by the diamond search, four positions below, right, above and left of the current optimal position with a sample apart from the current optimal position are checked, to update a final optimal position, that is, update and obtain a refined candidate list.

It should be noted that in the embodiment of the disclosure, the BV derived finally should meet that it is within a specified range (a coordinate range with row and column as units), which is specifically shown in FIG. 9A to FIG. 9D, FIG. 10 and FIG. 11.

It may be understood that in the embodiment of the disclosure, the first BV may be a luma BV or a chroma BV, which is not specifically limited here. If the first BV is a luma BV, the luma BV is configured to determine a luma component-based prediction value of the current block at this time; and if the first BV is a chroma BV, the chroma BV is configured to determine a chroma component-based prediction value of the current block at this time.

Further, in an IBC mode of the chroma component, a chroma BV may be derived based on a luma BV. In a possible implementation, the first BV is a luma BV, the method may further include the following operation. The luma BV is scaled according to a preset chroma sampling format, to determine a chroma BV, here the chroma BV is configured to determine a chroma component-based prediction value of the current block.

In another possible implementation, the first BV is a luma BV, the method may further include the following operations. The luma BV is scaled according to a preset chroma sampling format, to determine a scaled BV. The scaled BV is refined to determine a chroma BV, here the chroma BV is configured to determine a chroma component-based prediction value of the current block.

In the embodiment of the disclosure, a process of deriving the chroma BV based on the luma BV is as follows.

Input: bvL of luma ( 1/16 sample precision); Output: bvC of chroma ( 1/32 sample precision).

The derivation process may be directly scaling, or scaling and then refining by TM, which is not specifically limited here.

As to the scaling operation, an example thereof is as follows:

$$b v C [ 0 ] = ( ( b v L [ 0 ] ≫ ( 3 + SubWidthC ) * 32 ) ;$$

$$bvC [ 1 ] = ( ( b v L [ 1 ] ≫ ( 3 + SubHeightC ) * 32 ) .$$

Variables SubWidthC and SubHeightC specifically depend on a chroma format sampling structure specified by sps_chroma_format_idc, and specific correspondences refer to Table 1, which shows correspondences between sps_chroma_format_idc and the chroma format sampling structure.

The refining operation may include the following manners. After refining by TM, that is, obtaining the luma BV, an offset position is found by using position of a chroma block and the BV, a fine search is performed near the offset position by using a template, and an optimal BV (that is, a refined BV) is obtained with a minimum TM cost as a standard. As shown in FIG. 12, a region padded with oblique lines represents a chroma reconstructed region. As to the current block, a best matching template and a corresponding refined BV may be found in a TM manner, and a reference block at an optimal offset position obtained according to the refined BV is copied, such that a chroma prediction value of the current block may be determined.

In operation S1503, a matching template and a reference block corresponding to the matching template are determined according to the first BV.

It should be noted that in the embodiment of the disclosure, after the first BV is determined, a matching template and a reference block corresponding to the matching template may be determined according to the first BV. In some embodiments, the operation of determining the matching template and the reference block corresponding to the matching template according to the first BV may include the following operations.

A reference template and the corresponding reference block are determined according to the first BV.

If the reference template meets a first preset condition, first processing is performed on a neighboring region of the reference template, to determine the matching template.

In some embodiments, the operation of determining the matching template and the reference block corresponding to the matching template according to the first BV may include the following operations.

A reference template and the corresponding reference block are determined according to the first BV.

If the reference template meets a second preset condition, the reference template is used as the matching template.

It should also be noted that in the embodiment of the disclosure, the matching template may include samples in the reference template and samples in a neighboring region of the reference template.

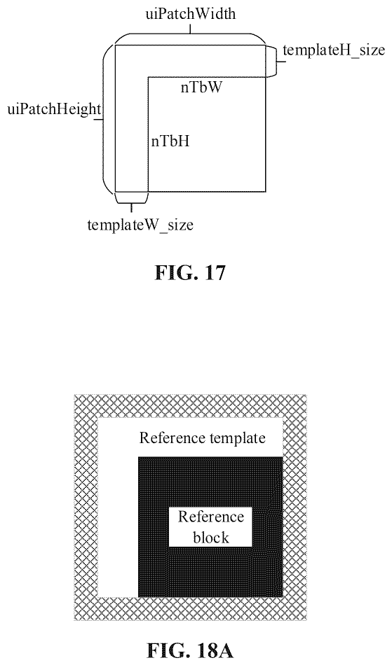

It should also be noted that in the embodiment of the disclosure, available reconstructed samples may be determined according to the template type refTemplateType of the current block. For example, when the template type refTemplateType is 1, as shown in FIG. 17, it indicates that left, top-left and top neighboring reconstructed samples are available, a number of available reconstructed samples at the left side is templateW_size*nTbH, a number of available reconstructed samples at the top side is templateH_size*nTbW, and a number of available reconstructed samples at the top-left side is template W_size*templateH_size.

In the embodiment of the disclosure, the first preset condition is different from the second preset condition. In some embodiments, the method may further include the following operation. If samples outside the reference template and the reference block are used, it is determined that the reference template meets the first preset condition.

In some embodiments, the method may further include the following operation. If samples outside the reference template and the reference block are not used, it is determined that the reference template meets the second preset condition.

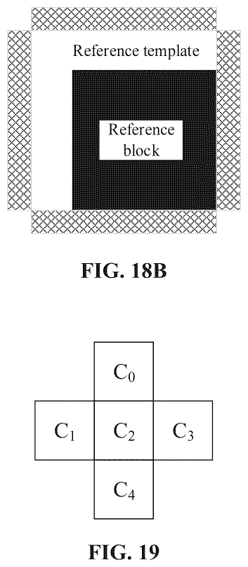

It should be noted that in the embodiment of the disclosure, considering that reconstructed samples outside the reference template and the reference block may be used by the filter, it needs to pad boundary samples. Regions required to be padded at the boundaries are different according to different shapes of filters. A type of boundary padding region is shown in FIG. 18A, another type of boundary padding region is shown in FIG. 18B, here grid regions are regions required to be padded.

In some embodiments, when the reference template meets the first preset condition, the operation of performing the first processing on the neighboring region of the reference template may include the following operation. If the samples outside the reference template and the reference block are used, padding processing is performed on samples in the neighboring region of the reference template.

In the embodiment of the disclosure, regarding the padding processing, it needs to determine first whether the samples in the neighboring region of the reference template are available. In some embodiments, the operation of performing the padding processing on the samples in the neighboring region of the reference template may include the following operations.

It is determined whether the samples in the neighboring region of the reference template are available.

If the samples in the neighboring region of the reference template are available, the samples in the neighboring region of the reference template are directly used.

If the samples in the neighboring region of the reference template are unavailable, padding processing is performed on the neighboring region of the reference template by copying reconstructed samples in neighboring reference templates or neighboring reference blocks of the samples, to obtain the samples in the neighboring region of the reference template.

It should be noted that the samples in the neighboring region of the reference template being available may include at least one of:
the samples do not exceed a preset search range;
the samples do not exceed boundaries of a picture;
the samples do not exceed boundaries of a tile; or
the samples have been reconstructed.

In the embodiment of the disclosure, regarding the padding processing, a copying operation may also be directly performed without determining whether the samples in the neighboring region of the reference template are available. In some embodiments, the operation of performing the padding processing on the samples in the neighboring region of the reference template may include the following operation. Padding processing is performed on the neighboring region of the reference template by directly copying reconstructed samples in neighboring reference templates or neighboring reference blocks of the samples, to obtain the samples in the neighboring region of the reference template. It should be noted that “directly copying” here means that it is unnecessary to determine whether the samples in the neighboring region of the reference template are available.

In some embodiments, regarding the padding processing, the method may further include the following operation. If the samples outside the reference template and the reference block are used, padding processing is not performed on samples in the neighboring region of the reference template, and the samples are skipped when the model parameters are determined.

That is, there are also multiple different methods for the padding processing in the embodiment of the disclosure. A padding manner is to determine whether the grid regions are available. If the grid regions are available, the reconstructed samples are directly used; if the grid regions are unavailable, the grid regions are padded by copying reconstructed samples of the neighboring reference template or reference block. Or, another padding manner is to pad the grid regions by directly copying reconstructed samples of the neighboring reference template or reference block, without considering whether the grid regions are available. Or, yet another padding manner is that it may abandon using corresponding data to participate in calculation when boundary positions are encountered, without padding them, which is not specifically limited here.

In operation S1504, model parameters are determined according to the first template and the matching template, the reference block is filtered according to the model parameters, and a filtered reference block is determined.

It should be noted that in the embodiment of the disclosure, after determining the number of available reconstructed samples, a reconstructed region for calculating filter coefficients (that is, model parameters) is determined according to the available reconstructed samples, this region is referred to as R, and R usually includes all available reconstructed samples in the template. For example, when refTemplateType is 1, R includes all available reconstructed samples at left, top-left and top sides.

It should also be noted that in the embodiment of the disclosure, the model parameters may include coefficients of a target filter. In some embodiments, the method may further include the following operation. The coefficients of the target filter are determined according to sample reference values in the first template and sample reference values in the matching template.

It should also be noted that in the embodiment of the disclosure, the coefficients of the target filter may be determined by solving an optimization problem. Correspondingly, in some embodiments, the method further includes the following operation. The coefficients of the target filter are coefficients used by the target filter when a first error between output values after processing the sample reference values in the matching template by the target filter and the sample reference values in the first template meets a first condition.

It should be understood that as to the first error meeting the first condition, in a possible implementation, the first condition is that the first error is minimum. Or, in another possible implementation, the first condition is that the first error is within a first preset threshold range. Or, in yet another possible implementation, the first condition is that variation of the first error is within a second preset threshold range.

It should also be understood that both the first preset threshold range and the second preset threshold range are measurement criteria preset by the decoding side to determine whether the first error meets the first condition. Furthermore, the first error here may be MSE, or may be Sum of Squared Errors (SSE), or may be SAD, or may be SATD after a Hadamard transform, or may be Mean Absolute Error (MAE) or the like, which is not specifically limited in the embodiment of the disclosure, either.

In some embodiments, the operation of determining the coefficients of the target filter according to the sample reference values in the first template and the sample reference values in the matching template may include the following operations.

Autocorrelation parameters are determined according to the sample reference values in the matching template.

Cross-correlation parameters are determined according to the sample reference values in the first template and the sample reference values in the matching template.

The coefficients of the target filter are determined according to the autocorrelation parameters and the cross-correlation parameters.

It should be noted that in the embodiment of the disclosure, the sample reference values include at least one of a reconstructed sample value, a sample gradient value, or sample position information.

That is, in the embodiment of the disclosure, the target filter is used as a filter model in the embodiment of the disclosure, and input information of the target filter includes the sample reference values in the matching template. Here, the coefficients of the target filter may be represented by c_{k,l}, which may also be referred to as filter coefficients in the embodiment. Input information for calculating the filter coefficients may be the available reconstructed samples in the matching template; or, gradients (including, but not limited to a horizontal gradient, a vertical gradient, etc.) of each reconstructed sample in the matching template may be calculated, and the calculated gradients are used as the input information for calculating the filter coefficients; or, position information of each reconstructed sample may be used as the input information for calculating the filter coefficients, and the position information here may be information of an absolute position of each reconstructed sample in the entire picture, or may be information of a relative position of each reconstructed sample relative to a certain reference point, which is not specifically limited here.

In a specific embodiment, a reconstructed region R for calculating the filter coefficients is determined first, and then a group of filter coefficients may be derived by minimizing MSE between reconstructed samples in the region R and reconstructed samples in the first template, that is:

$$MSE = E [ {( predTemp [ i ] [ j ] - recTemp [ i ] [ j ] )}^{2} ] = E [ {( {\sum }_{k , l = - 1 ∼ 1} {c}_{k , l} \cdot refTemp [ i + k ] [ j + l ] - recTemp [ i ] [ j ] )}^{2} ] \qquad ( 3 )$$

Here refTemp[i][j] represents an input reconstructed sample value, recTemp[i][j] represents a reconstructed sample value of the template of the current block, (i, j) represents a coordinate position, here (i, j)∈R, k, l represent coordinate offsets of a filter coefficient position relative to a center position of the filter, here k, l are between −1 and 1, and values of (k, l) may include (0, 0), (0, −1), (−1, 0), (0, 1), (1, 0), c_{k,l} represents a required filter coefficient. Furthermore, E represents an operation of calculating an average value. The calculation formula at this time is as follows:

$$MSE = \frac{1}{{N}_{p o s}} {\sum }_{i} {\sum }_{j} {\vert predTemp [ i ] [ j ] - recTemp [ i ] [ j ] \vert}^{2} \qquad ( 4 )$$

Here Nₚₒₛ refers to a number of (i, j) pairs participating in calculation of |predTemp[i][j]−recTemp[i][j]|². For example, if there are 5 (i, j) pairs participating in the calculation, value of Nₚₒₛ is equal to 5.

Further, a process of deriving the filter coefficients by minimizing MSE is specifically as follows.

First, a partial derivative of c_{k,l} is calculated and is set to 0, that is:

$$\frac{\partial M S E}{\partial {c}_{m}} = E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] \qquad ( 5 )$$

$$E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ 1 + n ] ] = 0 \qquad ( 6 )$$

Here k, l are between −1 and 1, and m, n are between −1 and 1.

Secondly, the following formula is obtained by organizing according to formula (5) and formula (6):

$${\sum }_{k , l = - 1 ∼ 1} {c}_{k , l} \cdot E ( refTemp [ i + k ] [ j + l ] \cdot refTemp [ i + m ] [ j + n ] ) = E ( recTEmp [ i ] [ j ] \cdot refTemp [ i + m ] [ j + n ] ) \qquad ( 7 )$$

Thirdly, after determining the reconstructed region R, the obtained equation, that is, formula (7) is expanded into a matrix form, which is specifically as follows:

$$A \times [ \begin{matrix}{c}_{0 , 0} \\ {c}_{- 1 , 0} \\ ⋮ \\ {c}_{0 , 1}\end{matrix} ] = B \qquad ( 8 )$$

As to A, the sample reference value in the matching template is represented by refTemp[i][j], and A represents an autocorrelation parameter of refTemp[i][j], which is specifically as follows:

$$( 9 )$$

$$A = [ \begin{matrix}\begin{matrix}E ( refTemp [ i ] [ j ] \cdot \\ refTemp [ i ] [ j ] )\end{matrix} & \begin{matrix}E ( refTemp [ i - 1 ] [ j ] \cdot \\ refTemp [ i ] [ j ] )\end{matrix} & … & \begin{matrix}E ( refTemp [ i ] [ j + 1 ] \cdot \\ refTemp [ i ] [ j ] )\end{matrix} \\ \begin{matrix}E ( refTemp [ i ] [ j ] \cdot \\ refTemp [ i - 1 ] [ j ] )\end{matrix} & \begin{matrix}E ( refTemp [ i - 1 ] [ j ] \cdot \\ refTemp [ i - 1 ] [ j ] )\end{matrix} & … & \begin{matrix}E ( refTemp [ i ] [ j + 1 ] \cdot \\ refTemp [ i - 1 ] [ j ] )\end{matrix} \\ ⋮ & ⋮ & ⋱ & ⋮ \\ \begin{matrix}E ( refTemp [ i ] [ j ] \cdot \\ refTemp [ i ] [ j + 1 ] )\end{matrix} & \begin{matrix}E ( refTemp [ i - 1 ] [ j ] \cdot \\ refTemp [ i ] [ j + 1 ] )\end{matrix} & … & \begin{matrix}E ( refTemp [ i ] [ j + 1 ] \cdot \\ refTemp [ i ] [ j + 1 ] )\end{matrix}\end{matrix} ]$$

As to B, the sample reference value in the first template is represented by recTemp[i][j], and B represents a cross-correlation parameter of recTemp[i][j] and refTemp[i][j], which is specifically as follows:

$$B = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j + 1 ] )\end{matrix} ] \qquad ( 10 )$$

That is, since an autocorrelation matrix of refTemp in the reconstructed region R and cross-correlation vectors of refTemp and recTemp are known quantities, the filter coefficients c_{k,l} may be calculated by solving a set of equations shown in formula (7), and the filter coefficients c_{k,l} may be implemented by fixed-points, or may not be implemented by fixed-points.

In the embodiment of the disclosure, as to the target filter, it also needs to determine a number of the coefficients of the target filter, a shape of the target filter, etc. The number of the coefficients of the target filter and the shape of the target filter may be preset fixed values, or may be directly determined by decoding the bitstream.

In some embodiments, as to the number of the coefficients of the target filter, the method may further include the following operation. A number of the coefficients of the target filter is equal to a first preset value.

In some embodiments, as to the number of the coefficients of the target filter, the method may further include the following operation. The bitstream is decoded to determine a number of the coefficients of the target filter.

It should be noted that the number of the coefficients of the target filter may be represented by nTap. Exemplarily, value of nTap may be 4, 5, 6, 7, 8, 9 or the like, while it is not specifically limited.

It should also be noted that the number of the coefficients of the target filter may also be referred to as a number of taps of the target filter. Here, the number of the coefficients of the target filter may be a preset constant value, or may be determined by decoding the bitstream, or may even be determined according to syntax element identification information of the current block.

In some embodiments, as to the shape of the target filter, the method may further include the following operation. The target filter is a one-dimensional or two-dimensional filter with a preset shape.

In some embodiments, as to the shape of the target filter, the method may further include the following operation. The bitstream is decoded to determine a shape of the target filter.

In some embodiments, as to the shape of the target filter, the method may further include the following operation. The bitstream is decoded to determine a value of a filter shape parameter, here the filter shape parameter indicates a shape of the target filter.

It should be noted that the filter shape parameter may be represented by FilterIdx, and FilterIdx indicates the shape of the target filter. In the embodiment of the disclosure, the shape of the target filter may be a diamond shape, a rectangular shape, a cross shape, a strip shape, or may even be a one-dimensional filter, a two-dimensional filter or the like, while it is not specifically limited.

Exemplarily, if value of FilterIdx is equal to 0, the shape of the target filter is determined as a diamond shape; if the value of FilterIdx is equal to 1, the shape of the target filter is determined as a cross shape; if the value of FilterIdx is equal to 2, the shape of the target filter is determined as a rectangular shape.

Exemplarily, FIG. 19 is a schematic diagram of a shape of a filter provided in an embodiment of the disclosure. As shown in FIG. 19, the shape of the filter is a cross shape, and a number of taps of the filter is 5. Here, the number of taps of the filter may be dynamically adjusted according to the size of the current block.

It should also be noted that the shape of the target filter may be a preset shape, or may be determined by decoding the bitstream, or may even be determined according to the syntax element identification information of the current block.

It should be noted that in the embodiment of the disclosure, after determining the model parameters, a prediction value of the current block may be determined according to the model parameters and the reference block. Specifically, the reference block is filtered according to the model parameters, and then the prediction value of the current block is determined according to the filtered reference block.

In some embodiments, the operation of filtering the reference block according to the model parameters, and determining the filtered reference block may include the following operations. The reference block is filtered according to the model parameters, and a first output value of the target filter is determined. The filtered reference block is determined based on the first output value of the target filter.

In some embodiments, the operation of filtering the reference block according to the model parameters, and determining the filtered reference block may include the following operation. If samples in a neighboring region of the reference block are used, padding processing is performed on the samples in the neighboring region of the reference block. That is, in the embodiment of the disclosure, if it needs to use the samples in the neighboring region of the reference block, it means that it needs to pad the samples in the neighboring region of the reference block.

In the embodiment of the disclosure, the first output value of the target filter may be calculated according to a reconstructed sample value of the reference block and the coefficients of the target filter from the model parameters, and then the filtered reference block may be determined according to the first output value of the target filter. The target filter here may be a linear filter model or a non-linear filter model, which is not specifically limited.

In a possible implementation, the operation of filtering the reference block according to the model parameters, and determining the first output value of the target filter may include the following operations.

A product of a reconstructed sample value of the reference block and a corresponding one of the coefficients of the target filter is calculated.

The first output value of the target filter is set to be equal to a sum of n products, here n represents a number of the coefficients of the target filter, and n is a positive integer.

It should be noted that the target filter in the embodiment of the disclosure is a linear filter model. The first output value of the target filter may be calculated by the following formula:

$${Y}^{pred} [ i ] [ j ] = {\sum }_{k} {\sum }_{l} ref [ i + k ] [ j + l ] \times {C}_{k , l} \qquad ( 11 )$$

Here ref[i+k][j+l] represents the reconstructed sample value of the reference block, and C_{k,l} represents the coefficients of the target filter.

In another possible implementation, the operation of filtering the reference block according to the model parameters, and determining the first output value of the target filter may include the following operations.

A first value of a reconstructed sample value of the reference block under a first mapping relationship is determined.

A product of the first value and a corresponding one of the coefficients of the target filter is calculated.

The first output value of the target filter is set to be equal to a sum of n products, here n represents a number of the coefficients of the target filter, and n is a positive integer.

It should be noted that the target filter in the embodiment of the disclosure is a non-linear filter model. Exemplarily, when MSE of the filter coefficients is minimized, the calculation formula is adjusted as follows at this time:

$$M S E = E [ {( predTemp [ i ] [ j ] - recTemp [ i ] [ j ] )}^{2} ] = E [ {( {\sum }_{k , l = - 1 ∼ 1} {c}_{k , l} \cdot {( refTemp [ i + k ] [ j + l ] )}^{2} - recTemp [ i ] [ j ] )}^{2} ] \qquad ( 12 )$$

Then, the first output value of the target filter may be calculated by the following formula:

$${Y}^{pred} [ i ] [ j ] = {\sum }_{k} {\sum }_{l} {( r e f [ i + k ] [ j + l ] )}^{2} \times {C}_{k , l} \qquad ( 13 )$$

Here ref[i+k][j+l] represents the reconstructed sample value of the reference block, and C_{k,l} represents the coefficients of the target filter.

It should also be noted that in the embodiment of the disclosure, as to determining the filtered reference block based on the first output value of the target filter, it may be that the first output value of the target filter is directly set as the filtered reference block; or may be that first filtering is performed on the first output value of the target filter, to obtain the filtered reference block. The first filtering here may be low-pass filtering, up/down sampling filtering or the like, which is not specifically limited here.

It should also be noted that in the embodiment of the disclosure, after determining the first output value of the target filter, a first offset value (represented by bias) may be added to the first output value, to determine the filtered reference block.

In some embodiments, the operation of determining the filtered reference block based on the first output value of the target filter may include the following operations. A first offset value is determined. An addition operation is performed according to the first output value and the first offset value, to determine the filtered reference block.

In a possible implementation, the operation of determining the first offset value may include the following operation. The first offset value is set to be equal to a second preset value.

In another possible implementation, the operation of determining the first offset value may include the following operations. A number of samples corresponding to the target filter and participating in filtering is determined based on a shape of the target filter. If the number of samples corresponding to the target filter and participating in filtering is m, (m+1) coefficients of the target filter are determined, here m is a positive integer. The first offset value is determined according to a second offset value and one of the (m+1) coefficients.

In the embodiment of the disclosure, as to the target filter, the number of samples participating in a filtering operation is m, while with consideration of the second offset value, the target filter needs to determine (m+1) coefficients at this time; and then a weighted calculation is performed on m samples participating in the operation and a second offset value according to the (m+1) coefficients. As to the second offset value, a coefficient used by the second offset value may be a (m+1)-th coefficient; however, the coefficient used by the second offset value may also be other coefficients, which is not specifically limited here.

In the embodiment of the disclosure, as to the second offset value, the method may further include the following operations. The second offset value is set to be equal to a third preset value. Or, the second offset value is set to be equal to a value of a reconstructed sample value of the reference block under a second mapping relationship.

It should be noted that the second mapping relationship may be a linear mapping relationship or a non-linear mapping relationship, and there may be multiple non-linear mapping relationships, which is not specifically limited here.

In the embodiment of the disclosure, the calculated filter coefficients are used as a number of taps corresponding to a filter template, that is, the number of the filter coefficients is equal to the number of taps of the filter template, nTap. Furthermore, several biases may be added to the filter template. Exemplarily, in the embodiment of the disclosure, when nTap=5, the filter coefficients are tap coefficients c₀ to c₄ corresponding to the filter template at this time, and a prediction value at a position (i, j) of the filtered reference block is calculated as follows:

$${Y}^{pred} [ i ] [ j ] = {\sum }_{n = 0}^{4} r e f [ k ] [ l ] \times {C}_{n} \qquad ( 14 )$$

At this time, a bias may be added, as shown in the following formula:

$${Y}^{pred} [ i ] [ j ] = {\sum }_{n = 0}^{4} r e f [ k ] [ l ] \times {C}_{n} + {C}_{5} \times Constant \qquad ( 15 )$$

In the embodiment of the disclosure, cₙ=c_{i,j,k,l}. Here Constant may be a fixed constant, such as Constant=1<<(BitDepth−1); or, Constant may be a number related to a reconstructed sample value at the position (i, j) of the reference block, such as Constant=f(ref[i][j]); or, Constant may be a number related to a reconstructed sample value corresponding to a certain tap in the filter template except the (i, j) position, such as Constant=f(ref[k][l]). Constant=f(ref[i][j]) or Constant=f(ref[k][l]) may be a linear mapping relationship or a non-linear mapping relationship. One or more biases may be added, which is not specifically limited here.

In operation S1505, a prediction value of the current block is determined according to the filtered reference block.

It should be noted that in the embodiment of the disclosure, the operation of determining the prediction value of the current block according to the filtered reference block may include the following operation. Second processing is performed on the filtered reference block, to obtain the prediction value of the current block.

In the embodiment of the disclosure, the second processing may be that the prediction value of the current block is set to be equal to the filtered reference block; or, the second processing may be a clip operation that limits the filtered reference block within a preset numerical range; or, the second processing may be other operations, which is not specifically limited here.

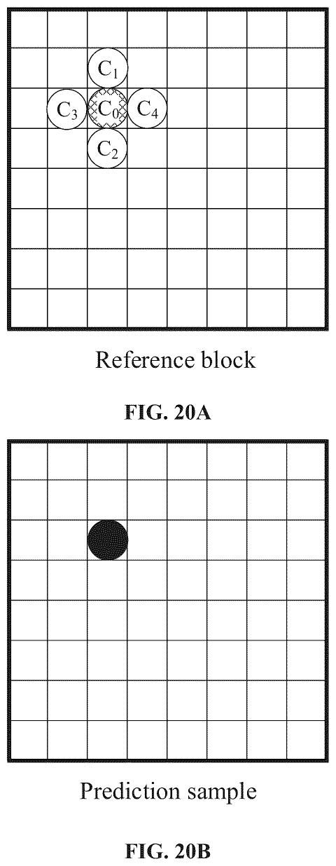

Exemplarily, assuming that the number of taps of the filter, nTap is 5, the shape of the filter is shown in FIG. 20A, C₀ to C₄ are tap coefficients of the filter respectively, here a dot padded in a grid corresponding to the tap coefficient C₀ are a reconstructed sample ref[i][j] at a corresponding position of a current to-be-predicted sample Y^{pred}[i][j] in the reference block, and remaining dots padded in white are reconstructed samples neighboring to a current spatial position in the reference block. In this way, a prediction sample Y^{pred}[i][j] obtained finally according to the filter of FIG. 20A is shown as a dot padded in black in FIG. 20B.

Furthermore, in the embodiment of the disclosure, as to the clip operation, the preset numerical range here may be between 0 and (1<<BitDepth)−1, here BitDepth represents a bit depth. If the filtered reference block exceeds values of the preset numerical range, it needs to perform a corresponding correction operation on the filtered reference block. Exemplarily, the filtered reference block may also be represented by Y^{pred}[i][j], and the correction operation may be performed on Y^{pred}[i][j] at this time, which is specifically as follows.

When value of Y^{pred}[i][j] is less than 0, the value is set to 0.

When the value of Y^{pred}[i][j] is equal to or greater than 0 and less than or equal to (1<<BitDepth)−1, the value is equal to Y^{pred}[i][j].

When the value of Y^{pred}[i][j] is greater than (1<<BitDepth)−1, the value is set to (1<<BitDepth)−1.

In this way, after performing the correction operation on Y^{pred}[i][j], it may be ensured that all sample values in the filtered reference block are between 0 and (1<<BitDepth)−1.

Further, a number of filter models may be expanded, multiple filter models may be established besides establishing only one filter model. Therefore, in some embodiments, the method may further include the following operations.

Multiple groups of model parameters are determined according to the first template and the matching template.

Multiple filter models are constructed according to the multiple groups of model parameters, the reference block is filtered according to the multiple filter models respectively, and multiple filtered reference blocks are determined.

The prediction value of the current block is determined according to the multiple filtered reference blocks.

In some embodiments, the operation of determining the multiple groups of model parameters according to the first template and the matching template may include the following operations. Reconstructed samples in the first template and the matching template are classified respectively according to a preset manner, to obtain multiple groups of sub-templates and multiple groups of sub-matching templates. The multiple groups of model parameters are determined according to the multiple groups of sub-templates and the multiple groups of sub-matching templates.

It should be noted that in the embodiment of the disclosure, the preset manner here may be values of the reconstructed samples, or may be position information of the reconstructed samples, or may be the shape of the filter or the like, which is not limited. After classifying according to the preset manner, a group of model parameters may be calculated according to each group of sub-templates and corresponding sub-matching templates, and a filter model may be determined according to each group of model parameters, such that multiple filter models may be constructed.

In a possible implementation, the method may further include the following operations. The bitstream is decoded to determine a target model index value. A target filter corresponding to the target model index value is determined from the multiple filter models according to the target model index value. The reference block is filtered according to the target filter, and the prediction value of the current block is determined.

In another possible implementation, the reference block is filtered according to multiple filter models respectively, and multiple filtered reference blocks may be determined. In some embodiments, the operation of determining the prediction value of the current block according to the multiple filtered reference blocks may include the following operation. A weighted calculation is performed on the multiple filtered reference blocks, to determine the prediction value of the current block.

It should also be noted that if a weight value of each filtered reference block is equal and equal to a reciprocal of a number of reference blocks, the weighted calculation here may also be considered as an averaging calculation. In other words, an averaging calculation is performed on the multiple filtered reference blocks, to determine the prediction value of the current block.

Exemplarily, input information for calculating the filter coefficients is classified, and a filter model is established for each category of input information respectively. For example, when the filter model is established by using reconstruction information, an implementable manner is to classify by an average value of the reconstruction information, to establish a filter model for reconstruction information greater than the average value, and establish a filter model for reconstruction information less than the average value. Another implementable manner is to classify by positions of the reconstruction information, for example, a filter model may be established by using available reconstruction information at left and top sides, a second filter model may be established by using available reconstruction information at left and top-left sides, or the like, and usage of which model is determined at the encoding side. An implementable decision-making manner is that usage of which model is determined at the encoding side in a Rate Distortion Optimization (RDO) manner, and corresponding decoding parameters are transmitted by the encoding side to the decoding side, such that which filter model is clearly selected at the decoding side. Another implementable manner is to classify by the shape of the filter, multiple different shapes of filters may be used, a filter model is established for each shape of filter, and usage of which shape of filter is determined at the encoding side. An implementable decision-making manner is that usage of which filter is determined at the encoding side in a RDO manner, and corresponding decoding parameters are transmitted by the encoding side to the decoding side, such that which filter model is clearly selected at the decoding side.

It should also be noted that in the embodiment of the disclosure, after determining the prediction value of the current block, a reconstructed value of the current block may also be restored. In some embodiments, the method may further include the following operations. The bitstream is decoded to determine a prediction residual of the current block. The reconstructed value of the current block is determined according to the prediction value of the current block and the prediction residual of the current block.

In a specific embodiment, the operation of determining the reconstructed value of the current block according to the prediction value of the current block and the prediction residual of the current block may include the following operations. An addition operation is performed on the prediction value of the current block and the prediction residual of the current block, to determine the reconstructed value of the current block.

It should also be noted that in the embodiment of the disclosure, whether the IBC is applied to the current block or whether the current block is used for the filter model, may be determined by different syntax element identification information here. In some embodiments, the method may further include the following operations. The bitstream is decoded to determine a value of first syntax element identification information.

If the first syntax element identification information indicates that IBC is applied to the current block, the bitstream is decoded to determine a value of second syntax element identification information.

If the second syntax element identification information indicates that a filter model is applied to the current block, operations of filtering the reference block according to the model parameters, and determining the filtered reference block; and determining the prediction value of the current block according to the filtered reference block are performed.

Further, in some embodiments, the method may further include the following operation. If the second syntax element identification information indicates that the filter model is not applied to the current block, a reconstructed sample value in the reference block is used as the prediction value of the current block.

In the embodiment of the disclosure, as to the first syntax element identification information, if the value of the first syntax element identification information is a first value, it is determined that the first syntax element identification information indicates that the IBC is applied to the current block; or, if the value of the first syntax element identification information is a second value, it is determined that the first syntax element identification information indicates that the IBC is not applied to the current block.

In the embodiment of the disclosure, as to the second syntax element identification information, if the value of the second syntax element identification information is a first value, it is determined that the second syntax element identification information indicates that the filter model is applied to the current block; or, if the value of the second syntax element identification information is a second value, it is determined that the second syntax element identification information indicates that the filter model is not applied to the current block.

It should be noted that in the embodiment of the disclosure, the first value is different from the second value, and the first value and the second value may be in a parameter form or in a numeral form. Specifically, the first syntax element identification information and the second syntax element identification information may be parameters written into a profile or a value of a flag, which is not specifically limited here.

Exemplarily, as to the first value and the second value, the first value may be set to 1, and the second value may be set to 0; or, the first value may be set to true, and the second value may be set to false. However, specific limitation is not made thereto here.

It should also be noted that in the embodiment of the disclosure, whether the current block uses the filtered reference block as a final prediction value is determined by certain conditions, which include, but are not limited to the following three manners. Exemplarily, the three manners may be as follows.

Manner 1: whether the matching template is filtered is determined by comparing a distortion between the matching template and template of the current block, such as SAD, MSE, SATD, SSE or the like with a threshold T_Distortion1.

Manner 2: based on that Manner 1 is met and the filter model is used, whether the reference block is filtered is determined by comparing a distortion between the filtered matching template and template of the current block, such as SAD, MSE, SATD, SSE or the like with a threshold T_Distortion2.

Manner 3: the encoding side transmits a flag to indicate whether the filter model is applied. tmpFlag indicates whether intra template matching is applied to the current block, and filterFlag indicates whether the filter model is applied to the current block. When tmpFlag is 1, whether the reference block is filtered is determined at the encoding side by comparing distortions between the reference block before and after filtering and the current block, such as SAD, MSE, SATD or SSE. If the distortion after filtering is less than the distortion before filtering, filterFlag is 1, and the current block uses the filtered reference block as the prediction block; otherwise, filterFlag is 0, and the current block uses the reference block before filtering as the prediction block. filterFlag is transmitted by the encoding side to the decoding side.

Further, in some embodiments, the method may further include the following operations. Multiple reference blocks in a second search region and model parameters of each of the multiple reference blocks are determined. The multiple reference blocks are filtered respectively according to the model parameters of each of the multiple reference blocks, and multiple filtered reference blocks are determined. The prediction value of the current block is determined according to the multiple filtered reference blocks.

In a specific embodiment, the operation of determining the prediction value of the current block according to the multiple filtered reference blocks may include the following operations. The bitstream is decoded to determine a reference block index number. The filtered reference block is determined from the multiple filtered reference blocks according to the reference block index number.

It should be noted that in the embodiment of the disclosure, as to the reference block to which the filter coefficients are applied, according to the foregoing embodiments, the filter coefficients are calculated only for the best matching template after the search completes, and the filter coefficients are applied to the best matching reference block; furthermore, the filter coefficients may also be applied to all or part of reference blocks in the search region here, and which filtered reference block is used as a final prediction block is determined by certain conditions, which include, but are not limited to the following manners.

Manner 1: the filter coefficients are solved for templates in the search range and used for filtering, and their costs with the current template are calculated to determine which template is used, that is, the filter coefficients are calculated for part or all of to-be-searched templates in the search range, then the filter coefficients are applied to the to-be-searched templates, costs of the templates with the current template are calculated, a filtered best matching template is selected according to the costs, and the reference block corresponding to the best matching template is filtered and used as the final prediction value.

Manner 2: the encoding side transmits a flag to indicate which filtered reference block is used as the final prediction block. tmpFlag indicates whether TM is applied to the current CB, and filterIdx indicates whether the filter model is applied to which reference block in a current search range. When tmpFlag is 1, an optimal reference block is selected at the encoding side by comparing distortions between reference blocks to which the filter coefficients are applied in the search range and a current original block, such as SAD, MSE, SATD or SSE, and a corresponding index is transmitted by the encoding side to the decoding side.

Further, in some embodiments, “samples in the template” may be replaced by “identified samples in the template”; and “samples in the reconstructed block corresponding to the template” may be replaced by “identified samples in the reconstructed block corresponding to the template”. The identified samples in the template refer to one or more samples located at a corner position of the template region, such as samples at a top-left corner and a bottom-right corner of a top template region when there is only a top template, or only samples at the bottom-right corner of the top template region. The identified samples in the reconstructed block corresponding to the template refer to one or more samples located at a corner position of the reconstructed block region, such as samples at a top-left corner and a bottom-right corner of the reconstructed block region, or only samples at the bottom-right corner of the reconstructed block region.

It should be noted that in the embodiment of the disclosure, considering that the filter may use reconstructed samples outside the reference template and the reference block, it needs to pad boundary samples. A boundary padding implementation is shown in FIG. 18A and FIG. 18B, here grid regions are regions required to be padded.

In some embodiments, a padding manner is to determine whether samples in the grid regions are available, one by one. If the samples are available, the reconstructed samples are directly used; if the samples are unavailable, the grid regions are padded by copying reconstructed samples of a nearest reference template or reference block.

A method for determining whether the samples are available includes, but is not limited to meeting one or more of the following conditions:
the samples are within boundaries of a picture;
the samples are within boundaries of a tile; or
the samples have been reconstructed.

In some other embodiments, a padding manner is to determine whether positions of the padding regions exceed a BV search range, according to the BV search range. If the positions of the padding regions do not exceed the search range, the reconstructed samples are directly used; if the positions of the padding regions exceed the search range, the grid regions are padded by copying reconstructed samples of a neighboring reference template or reference block. Specifically, whether boundaries need to be padded is determined according to the derived iVerMin, iVerMax, iHorMin and iHorMax.

leftPadding, rightPadding, topPadding and bottomPadding indicate whether a left grid region, a right grid region, a top grid region and a bottom grid region copy nearest reconstructed samples, that is:

$$\begin{matrix}leftPadding = ! ( pX\_Best > iHorMin ) ; \\ rightPadding = ! ( pX\_Best < iHorMax ) ; \\ topPadding = ! ( pY\_Best > iVerMin ) ; \\ bottomPadding = ! ( pY\_Best < iverMax ) .\end{matrix}$$

Here, if leftPadding is true, it means that samples in the left grid region exceed the BV search range, and reconstructed samples of a nearest neighboring reference template are copied; otherwise, reconstructed samples at this position are directly used. If rightPadding is true, it means that samples in the right grid region exceed the BV search range, and reconstructed samples of a nearest neighboring reference template or reference block are copied; otherwise, reconstructed samples at this position are directly used. If topPadding is true, it means that samples in the top grid region exceed the BV search range, and reconstructed samples of a nearest neighboring reference template are copied; otherwise, reconstructed samples at this position are directly used. If bottomPadding is true, it means that samples in the bottom grid region exceed the BV search range, and reconstructed samples of a neighboring reference template or reference block are copied; otherwise, reconstructed samples at this position are directly used.

Further, in the embodiment of the disclosure, a relevant mode selection flag (ibcFilterFlag) is transmitted at a CU layer. Manners of encoding ibcFilterFlag may be implemented in multiple manners. An implementable manner is to use equal-probability encoding; another implementable manner is to use context encoding, default context initial state and context update rate may be used, or context initial state and context update rate may be determined by statistics, which is not specifically limited here.

Further, in the embodiment of the disclosure, the method for decoding may be implemented in combination with various sub-modes in the IBC, which include, but are not limited to ordinary IBC merge, IBC TM merge, MBVD, IBC CIIP, IBC ABVP or the like, which is not specifically limited here, either.

Further, in the embodiment of the disclosure, the method for decoding is not limited to the intra prediction mode, nor is it limited to the IBC mode, and the method for decoding may be applicable to other modes to which the BV is applied. Or, the BV in the method for decoding is not limited to the BV used by the IBC, and the template in the method for decoding is not limited to the template used by the IBC, or the like, which is not specifically limited here.

The embodiment provides a method for decoding, in which a first template of a current block is determined first, and a BV candidate list of the current block is determined; then, a bitstream is decoded to determine BV indication information, and a first BV is determined according to the BV indication information and the BV candidate list; then, a matching template and a reference block corresponding to the matching template are determined according to the first BV; model parameters are determined according to the first template and the matching template, the reference block is filtered according to the model parameters, and a filtered reference block is determined; and finally, a prediction value of the current block is determined according to the filtered reference block. In this way, the model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

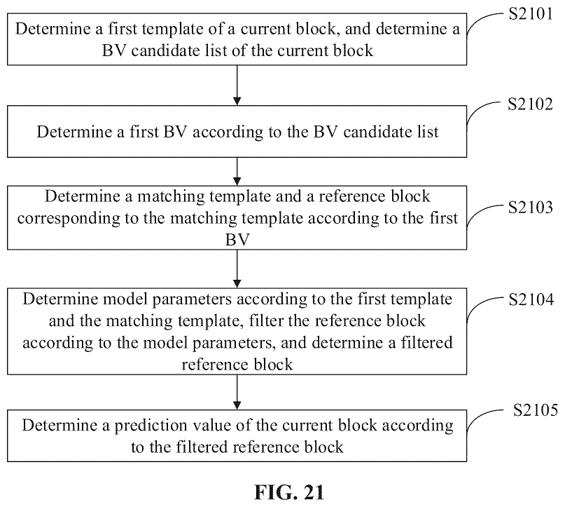

In another embodiment of the disclosure, with reference to FIG. 21, a schematic flowchart of a method for encoding provided in an embodiment of the disclosure is shown. As shown in FIG. 21, the method may include the following operations S2101 to S2105.

In operation S2101, a first template of a current block is determined, and a BV candidate list of the current block is determined.

It should be noted that the method for encoding according to the embodiment of the disclosure is applied to an encoder. Furthermore, the method for encoding may specifically refer to an intra prediction method, and more specifically, refers to an intra prediction method based on an IBC-FLM technology, but is not limited to the IBC mode, and may be applicable to other modes to which the BV is applied. The video picture may be divided into multiple CBS, and the current block in the embodiment of the disclosure refers to a CB to be intra predicted currently from the video picture. Furthermore, both the luma component and the chroma component may be predicted by the method for encoding according to the embodiment of the disclosure, which is not specifically limited here.

It should also be noted that in the embodiment of the disclosure, it needs to determine the first template of the current block first, such that a matching template and a reference block corresponding to the matching template may be determined according to the first template. In some embodiments, the operation of determining the first template of the current block may include the following operations.

A template type of the current block is determined.

The first template of the current block is determined according to the template type of the current block.

The template type may be represented by refTemplateType. In some embodiments, the operation of determining the template type of the current block may include the following operation. The template type of the current block is determined according to reference samples of the current block.

The reference samples of the current block include at least one of a left neighboring reference sample of the current block, a top neighboring reference sample of the current block, or a top-left neighboring reference sample of the current block.

Exemplarily, FIG. 16A to FIG. 16C show schematic diagrams of template types of an IBC mode provided in an embodiment of the disclosure. When a top-left reference sample, a top reference sample and a left reference sample are all available, refTemplateType has a value of 1, and shape of the template type is shown in FIG. 16A; when only the left reference sample is available, refTemplateType has a value of 2, and the shape of the template type is shown in FIG. 16B; and when only the top reference sample is available, refTemplateType has a value of 3, and the shape of the template type is shown in FIG. 16C.

That is, in the embodiment of the disclosure, reference samples of the current block are determined based on neighboring reconstructed regions of the current block. The neighboring reconstructed regions of the current block include at least one of a left neighboring region, a top neighboring region, or a top-left neighboring region. For example, a left neighboring reference sample of the current block may be determined by at least one column of reconstructed samples in the left neighboring region, a top neighboring reference sample of the current block may be determined by at least one row of reconstructed samples in the top neighboring region, a top-left neighboring reference sample of the current block may be determined by at least one column of reconstructed samples in the top-left neighboring region, or the like, which is not specifically limited here.

Further, the template types may be classified and the template type of the current block may be determined according to availability of neighboring reference samples. In some embodiments, the operation of determining the template type of the current block may include the following operation. If both the left neighboring reference sample of the current block and the top neighboring reference sample of the current block are available, the template type of the current block is encoded, and obtained encoded bits are signalled into a bitstream.

It should be noted that in the embodiment of the disclosure, the template type of the current block may be preset, or may be determined by signaling the template type into the bitstream. If all the left neighboring reference sample of the current block, the top neighboring reference sample of the current block and the top-left neighboring reference sample of the current block are available, the template type of the current block is determined as a first type value; if the left neighboring reference sample of the current block is available, the template type of the current block is determined as a second type value; and if the top neighboring reference sample of the current block is available, the template type of the current block is determined as a third type value. Exemplarily, if both the left neighboring reference sample and the top neighboring reference sample are available, there may also be a second type of template and a third type of template. At this time, which template is used may be specified by the bitstream.

In the embodiment of the disclosure, the first type value, the second type value and the third type value may be different from each other. Exemplarily, the first type value may be set to 1, the second type value may be set to 2, and the third type value may be set to 3. Furthermore, as to the three template types, reference may be made to FIG. 16A to FIG. 16C for their details.

It should also be noted that in the embodiment of the disclosure, the template type of the current block is usually L-shaped, that is, the template type of FIG. 16A. As to the L-shaped template, it may consist of the left neighboring reference sample of the current block and the top neighboring reference sample of the current block, or may consist of the left neighboring reference sample of the current block, the top neighboring reference sample of the current block and the top-left neighboring reference sample of the current block. It is unnecessary to specifically point out the top-left neighboring reference sample in general, since the L-shaped template may not include a top-left sample actually; in other words, when both left and top samples are available, the top-left neighboring sample is also available.

In some embodiments, the operation of determining the first template of the current block according to the template type of the current block may include the following operations. Template samples of the current block are acquired according to the template type of the current block and a corresponding template size. The template samples of the current block are determined as the first template of the current block.

In the embodiment of the disclosure, the template size may be preset, or may be determined according to a size of the current block, or may even be related to the template type of the current block, which is not specifically limited here.

Exemplarily, if the template type indicates that only a left template is acquired, a template width templateW_size may be set to 4; and if the template type indicates that only a top template is acquired, a template height templateH_size may be set to 4.

Furthermore, which part of reconstructed samples are acquired by the first template, may be determined according to the value of the template type. For example, when refTemplateType has a value of 1, reconstructed samples at a left side, a top-left side and a top side of the current block are acquired; when refTemplateType has a value of 2, only reconstructed samples on left four columns of the current block are acquired; and when refTemplateType has a value of 3, only reconstructed samples on top four rows of the current block are acquired.

It should also be noted that in the embodiment of the disclosure, the template type of the current block may also be signalled into the bitstream. In a specific embodiment, the method may further include the following operation. The template type of the current block is encoded, and obtained encoded bits are signalled into a bitstream. In this way, the template type of the current block may be subsequently determined at the decoding side by decoding the bitstream; and then the first template of the current block may be determined according to the template type, which is not limited in any way.

It may be understood that in the embodiment of the disclosure, it also needs to construct the BV candidate list for the IBC mode here. Taking an establishment process of an IBC merge candidate list as an example, an establishment process of an IBC ABVP candidate list is consistent with that of the IBC merge, while a maximum number of candidates is inconsistent between the two processes. For example, a length of the IBC merge candidate list may be defined as 6, and a length of the IBC ABVP candidate list may be defined as 2.

In some embodiments, the operation of determining the BV candidate list of the current block may include the following operations. At least one first candidate BV neighboring to the current block is determined based on a derivation manner of spatial BV candidates. The at least one first candidate BV is added to the BV candidate list. If a number of candidates in the BV candidate list meets a preset threshold, a current BV candidate list is used as the BV candidate list of the current block.

It should be noted that during construction of the BV candidate list, candidates in a spatial domain are derived first. Specifically, when usage conditions are met (for example, a size condition IsGt4by4 is equal to TRUE, that is, the variable IsGt4by4 is TRUE when a product of multiplying a luma width by a luma height is greater than 16), a derivation process of spatial BV candidates from neighboring CUs specified in a decoding specification is called as an input by using the position (xCb, yCb) of the luma CB, the width cbWidth and height cbHeight of the luma CB, and outputs are availability flags such as availableFlagA1, availableFlagB1 and BVs bvA1 and bvB1.

Detection of availability of each candidate is as follows. The following conditions are judged, and the candidate is available if all the following conditions are met:
whether an offset position obtained by adding the position of the current block to BVP does not exceed boundaries of a picture;
whether a block position pointed to by adding the position of the current block to the BVP does not cover the current block;
whether the offset position obtained by adding the position of the current block to the BVP does not exceed an IBC available region;
whether the block position pointed to by adding the position of the current block to the BVP has been reconstructed.

It should also be noted that in the embodiment of the disclosure, taking FIG. 3 as an example, relative positions of neighboring blocks where A1, B1 or the like are located and the current block refer to FIG. 3, and a traversal order in FIG. 3 may be A1->B1->B0->A0->B2.

Secondly, candidates in the spatial domain are added to the candidate list. When the usage conditions are met (for example, the size condition IsGt4by4 is equal to TRUE), the BV candidate list bvCandList is constructed as follows:

$$\begin{matrix}i = 0 ; \\ if ( availableFlagA 1 ) ; \\ bvCandList [ i + + ] = bvA 1 ; \\ if ( availableFlagB 1 ) ; \\ bvCandList [ i + + ] = bvB 1 ; \\ … …\end{matrix}$$

Thirdly, a number of valid candidates in the BV candidate list is checked. A derivation process of a variable numCurrCand (a number of candidates obtained currently) is as follows.

If the usage conditions are met (for example, the size condition IsGt4by4 is equal to TRUE), numCurrCand is set to be equal to a number of candidates in bvCandList; otherwise, numCurrCand is set to 0.

Further, in some embodiments, the method may further include the following operations. If the number of candidates in the BV candidate list does not meet the preset threshold, at least one second candidate BV is determined based on a derivation manner of history-based BV candidates, and the at least one second candidate BV is continuously added to the BV candidate list. If the number of candidates in the BV candidate list meets the preset threshold, the current BV candidate list is used as the BV candidate list of the current block.

It should also be noted that if the candidate list does not reach a specified number of items (for example, a specified number of items in the IBC merge mode is 6, and a specified number of items in an IBC ABVP mode is 2), derivation of history-based candidates, detection of availability and addition are performed continuously.

When numCurrCand is less than MaxNumIbcMergeCand (a maximum number of candidates in the IBC merge mode) and NumHmvpIbcCand (a maximum number of candidates for a history-based optimal BV (Hmvp) in the IBC mode) is greater than 0, a derivation process of history-based IBC BV candidates specified in the decoding specification is called with bvCandList and numCurrCand as inputs and with the modified bvCandList and numCurrCand as outputs.

Further, in some embodiments, the method may further include the following operation. If the number of candidates in the BV candidate list does not meet the preset threshold, at least one third candidate BV is determined based on derivation manners of other available candidates, and the at least one third candidate BV is continuously added to the BV candidate list, until the number of candidates in the BV candidate list meets the preset threshold.

In the embodiment of the disclosure, the derivation manners of other available candidates may include at least one of a derivation manner of pairwise average candidates, a derivation manner of zero-value BV candidates, or a derivation manner of candidates in a reference region corresponding to IBC.

It should also be noted that after the at least one second candidate BV is continuously added to the BV candidate list, the number of valid items in the candidate list is continuously checked, and other available candidates (such as pairwise average candidates, zero-value BV candidates, etc.) are added, until the specified number of items is reached.

Exemplarily, other available candidates are as follows.

(1) The pairwise average candidate may be constructed by using first and second candidates, specifically:

$$mvAvgLX = ( m v C a n d 0 LX + mvCand 1 LX + 1 ) >> 1.$$

(2) The zero-value BV may be directly set as follows:
bvCandList[numCurrCand][0] is set to be equal to 0. (a horizontal component of bv)
bvCandList[numCurrCand][1] is set to be equal to 0. (a vertical component of bv)

(3) A group of BVP candidates located in an IBC reference region may also be used as candidates that may be added. Coordinates of the group of BVP candidates are determined by the width and height of the current block and parameters ΔX and ΔY, as shown in FIG. 4.

It should also be noted that in the embodiment of the disclosure, each time an item is added, numCurrCand is increased by 1. In this way, establishment of a basic BV candidate list bvCandList is completed until numCurrCand meets the preset threshold.

Further, the method may further include the following operation after construction of the BV candidate list is completed. After determining the BV candidate list of the current block, the BV candidate list is sorted.

It should be noted that in the embodiment of the disclosure, in the IBC merge mode, an order of the list may also be re-sorted by using templates, to adjust an order of the candidate list, fully utilize high spatial correlation, reduce transmission of encoded bits, and effectively improve encoding efficiency. For example, as to the IBC merge mode, after an intermediate candidate list is constructed according to the above list construction method (it is noted that a length of the intermediate candidate list may be equal to or greater than the maximum number of candidates in the IBC merge mode), all candidates in the list are re-sorted by using templates and are sorted in an ascending order of template matching costs, and first N (for example, N=6) candidates are selected from the sorted list. A specific process thereof is as follows. SADs of a template position of a reference block pointed to by each candidate and a template position of the current block (as shown in FIG. 5) are calculated and are sorted in an ascending order, and first 6 candidates are selected as the candidate list of the IBC merge.

Further, the method may further include the following operation after construction of the BV candidate list is completed. After determining the BV candidate list of the current block, redundancy is removed according to a distance between candidate BVs in the BV candidate list.

It should be noted that in the embodiment of the disclosure, the operation of removing the redundancy may include the following operation. If a non-flip IBC mode is selected for the current block, at least one of at least two candidate BVs in the BV candidate list is deleted when a distance between the at least two candidate BVs meets a preset condition.

It should also be noted that in the embodiment of the disclosure, in the IBC ABVP mode, an operation of removing redundancy of candidates may also be performed according to a distance between the candidates. The number of the candidates remains unchanged at two, and candidate lists are established for integer-sample precision and 4-sample precision respectively.

If a non-RRIBC mode is selected for the IBC ABVP, if a number of valid BVP candidates exceeds two, at most six BVP candidates in the candidate list are clustered according to an Euclidean distance between the candidates, a radius (R) is a logarithmic function of a group of BVs determined as the width (cbWidth) and height (cbHeight) of the current block. If the Euclidean distance between reference positions pointed to by several BV candidates is less than R, the BV candidates are clustered: R=log₂((cbWidth·cbHeight)>>MIN_PU_SIZE).

Further, in some embodiments, the method may further include the following operations. If a flip IBC mode is selected for the current block, the candidate BV in the BV candidate list is adjusted to point to a boundary of a valid block copy search region according to a preset direction of the flip IBC mode. That is, if a RRIBC mode is selected for the IBC ABVP, the candidate may be adjusted to point to a boundary of a valid IBC search region in a horizontal or vertical direction according to the RRIBC mode.

In this way, construction of the BV candidate list is completed.

In operation S2102, a first BV is determined according to the BV candidate list.

It should be noted that in some embodiments, the operation of determining the first BV according to the BV candidate list may include the following operations. A cost calculation is performed on at least two candidate BVs in the BV candidate list, to determine costs of each of the at least two candidate BVs. A minimum cost is determined according to the costs of each of the at least two candidate BVs, and a candidate BV corresponding to the minimum cost is used as the first BV.

It should also be noted that in the embodiment of the disclosure, calculation of the cost of each candidate BV may be that a matching cost calculation is performed between a template corresponding to each candidate BV and the first template, based on a preset cost function. The preset cost function may be SAD, SATD, MSE, SSD, MAD, MSD, NCC or the like, which is not specifically limited here.

In some embodiments, the method may further include the following operations. A BV index number corresponding to the first BV is determined according to the BV candidate list. The BV index number is encoded, and obtained encoded bits are signalled into a bitstream. Here, the BV index number may be signalled into the bitstream as BV indication information, that is, the BV indication information is encoded, and obtained encoded bits are signalled into the bitstream.

In some embodiments, the method may further include the following operations. A BV index number corresponding to the first BV is determined according to the BV candidate list. A BVD value is determined according to an initial BV of the current block and the first BV. The BV index number and the BVD value are encoded, and obtained encoded bits are signalled into a bitstream. Here, the BV index number and the BVD value may be signalled into the bitstream as BV indication information, that is, the BV indication information is encoded, and obtained encoded bits are signalled into the bitstream.

It should be noted that in the embodiment of the disclosure, the BV indication information here may be different in different prediction modes, for example, the BV indication information may be a BV index number, a BVD value or the like, which is not specifically limited here.

In a possible implementation, the BV indication information may include a BV index number. Exemplarily, in the IBC merge mode, after determining the BV index number bvIdx, a specific bvL may be subsequently obtained at the decoding side according to the BV index number bvIdx and the BV candidate list bvCandList:

$$\begin{matrix}bvL [ 0 ] = b v C a n d L i s t [ b v I d x ] [ 0 ] ; \\ bvL [ 1 ] = b v C a n d L i s t [ b v I d x ] [ 1 ] ;\end{matrix}$$

This bvL is the final BV.

In another possible implementation, the BV indication information may include a BV index number. Exemplarily, in an IBC MBVD mode, similar to MMVD in the inter technology of VVC, a certain candidate in the IBC merge list is used as a starting point, a candidate is selected from a candidate point set corresponding to a predefined distance and direction set, and a BV corresponding to the candidate is used as the final BV.

Exemplarily, in the IBC MBVD, a distance set is defined as {1-pel, 2-pel, 4-pel, 8-pel, 12 pel, 16 pel, 24 pel, 32 pel, 40 pel, 48 pel, 56 pel, 64 pel, 72 pel, 80 pel, 88 pel, 96 pel, 104 pel, 112 pel, 120 pel, 128 pel}, and BVD directions are two horizontal directions that is positive and negative horizontal directions, and two vertical directions that is positive and negative vertical directions.

In this way, a base candidate may be selected from first five candidates in the re-sorted IBC merge list, and refinement positions of all possible MBVDs of each base candidate (that is, 20×4 candidates) are re-sorted based on SAD cost between the template and its reference at each refinement position. Finally, first eight refinement positions with a minimum template SAD are retained for encoding of an MBVD index. Candidates of IBC-MBVD do not inherit flip types from neighboring blocks encoded by RR-IBC. The MBVD index is binarized by a Rice code with parameters equal to 1.

In yet another possible implementation, the BV indication information may include a BV index number. Exemplarily, in an IBC TM merge mode, after obtaining bvL according to the BV index number bvIdx, the BV may also be locally refined by TM, specific operations thereof are that search is performed in a small range centered on the obtained bvL, and an optimal BV in the range is selected with a minimum template matching cost as a standard, as the final BV.

TM refinement is performed on the candidate list in the IBC merge mode, a specific implementation process thereof is as follows.

When candidates are constructed, a flip type is non-flip by default.

As to the IBC TM merge mode, in the IBC merge mode, a syntax element is transmitted to specify whether TM refinement with the integer-sample precision is performed. A refinement MV in each refinement operation and a position where the used template is located must comply with constraints of the reference region.

Search is performed near positions pointed to by the candidates, and an optimal position is determined by using SAD between the template of the reference block and the template of the current block, which includes, but is not limited to the following search manners. A search range is [−8, 8], an integer-sample diamond search is performed first to search eight points near a middle position, as shown in FIG. 7A and FIG. 7B; a maximum number of searches is 375, and after the optimal position is determined for the first time, the search is continuously performed to search 5 points at even positions and search 3 points at odd positions in subsequent search processes.

After the above diamond search process, an integer-sample cross search is performed and is performed only once. That is, after a current optimal position is found by the diamond search, four positions below, right, above and left of the current optimal position with a sample apart from the current optimal position are checked, to update a final optimal position, that is, update and obtain a refined candidate list.

In yet another possible implementation, the BV indication information may include a BV index number and a BVD value. Exemplarily, as to the IBC ABVP mode, bvL obtained by the BV index number bvIdx and the BV candidate list bvCandList is a predicted bvL, and it also needs to add bvL to BVD to obtain a real bvL, a generalized specific process thereof is as follows.

Operation 1: horizontal and vertical components of the BVD are obtained, here MvdL0 is a forward MV difference.

$$\begin{matrix}bvd [ 0 ] = M v d L 0 [ x C b ] [ y C b ] [ 0 ] ; \\ bvd [ 1 ] = M v d L 0 [ x C b ] [ y C b ] [ 1 ] .\end{matrix}$$

Operation 2: a rounding operation is performed on the predicted bvL acquired as above, here a parameter AmvrShift is right-shifted to perform rounding, and the parameter AmvrShift is left-shifted to improve resolution. Specifically:

$$\begin{matrix}offset = ( AmvrShift == 0 ) ? 0 : ( ( 1 << ( AmvrShift - 1 ) ) - 1 ) ; \\ bvL [ 0 ] = Sign ( bvL [ 0 ] ) * ( ( ( Abs ( bv L [ 0 ] ) + offset ) >> AmvrShift ) << AmvrShift ) ; \\ bvL [ 1 ] = Sign ( bvL [ 1 ] ) * ( ( ( Abs ( bv L [ 1 ] ) + offset ) >> AmvrShift ) << AmvrShift ) .\end{matrix}$$

Operation 3: the real bvL is derived as follows, and its range needs to be controlled between −217 and 217-1:

$$\begin{matrix}u [ 0 ] = ( b v L [ 0 ] + b v d [ 0 ] + 2 \; 18 ) \%218 ; \\ bvL [ 0 ] = ( u [ 0 ] >= 217 ) ? ( u [ 0 ] - 218 ) : u [ 0 ] ; \\ u [ 1 ] = ( bvL [ 1 ] + bvd [ 1 ] + 218 ) \%218 ; \\ bvL [ 1 ] = ( u [ 1 ] >= 217 ) ? ( u [ 1 ] - 218 ) : u [ 1 ] .\end{matrix}$$

It should be noted that the method for acquiring the BVD in Operation 1 may also be inferred from syntax elements obtained through other encoding methods. The BVD of the IBC ABVP takes a fractional-sample, an integer-sample or a 4-sample as a unit. During encoding, its sign may be predicted, and a suffix of an exponential-Golomb code obtained after its binarization may also be predicted. Therefore, its syntax elements may be defined by multiple information of a BVD value: a flag of 0 or not, a prefix, a sign and a suffix, an actual BVD value may be obtained by combining and parsing their information. A specific embodiment thereof is as follows.

It should also be noted that a flag indicating whether the BVD is 0 is context encoded. A value of (absolute value −1) is binarized by first-order exponential-Golomb, first 5 binary data (bins) of an EG1 prefix are context encoded, and remaining prefixes are bypass encoded. At most 4 bins of an EG1 suffix are context encoded to transmit a prediction index, and other bins of the EG1 suffix are bypass encoded. Two bins of the sign bit are context encoded to transmit a sign prediction index. FIG. 8 is a schematic diagram of a relationship among BV, BVP and BVD. As shown in FIG. 8, it is a prediction process where there is a suffix bin transmitting a prediction index in each of the horizontal direction and the vertical direction, and a bin transmitting a sign index in each of the horizontal direction and the vertical direction here, and it is sorted by using the template of the current block and the template at the corresponding BV, to derive prediction indices of the suffix and the sign.

It should be noted that in the embodiment of the disclosure, the BV derived finally should meet that it is within a specified range (a coordinate range with row and column as units), which is specifically shown in FIG. 9A to FIG. 9D, FIG. 10 and FIG. 11.

It may be understood that in the embodiment of the disclosure, the first BV may be a luma BV or a chroma BV, which is not specifically limited here. If the first BV is a luma BV, the luma BV is configured to determine a luma component-based prediction value of the current block at this time; and if the first BV is a chroma BV, the chroma BV is configured to determine a chroma component-based prediction value of the current block at this time.

Further, in an IBC mode of the chroma component, a chroma BV may be derived based on a luma BV. In a possible implementation, the first BV is a luma BV, the method may further include the following operation. The luma BV is scaled according to a preset chroma sampling format, to determine a chroma BV, here the chroma BV is configured to determine a chroma component-based prediction value of the current block.

In another possible implementation, the first BV is a luma BV, the method may further include the following operations. The luma BV is scaled according to a preset chroma sampling format, to determine a scaled BV. The scaled BV is refined to determine a chroma BV, here the chroma BV is configured to determine a chroma component-based prediction value of the current block.

In the embodiment of the disclosure, a process of deriving the chroma BV based on the luma BV is as follows.

Input: bvL of luma ( 1/16 sample precision); Output: bvC of chroma ( 1/32 sample precision).

The derivation process may be directly scaling, or scaling and then refining by TM, which is not specifically limited here.

As to the scaling operation, an example thereof is as follows:

$$\begin{matrix}bvC [ 0 ] = ( ( bvL [ 0 ] >> ( 3 + SubWidthC ) ) * 32 ) ; \\ bvC [ 1 ] = ( ( bvL [ 1 ] >> ( 3 + SubHeightC ) ) * 32 ) .\end{matrix}$$

Variables SubWidthC and SubHeightC specifically depend on a chroma format sampling structure specified by sps_chroma_format_idc, and specific correspondences refer to Table 1, which shows correspondences between sps_chroma_format_idc and the chroma format sampling structure.

The refining operation may include the following manners. After refining by TM, that is, obtaining the luma BV, an offset position is found by using position of a chroma block and the BV, a fine search is performed near the offset position by using a template, and an optimal BV (that is, a refined BV) is obtained with a minimum TM cost as a standard. As shown in FIG. 12, a region padded with oblique lines represents a chroma reconstructed region. As to the current block, a best matching template and a corresponding refined BV may be found in a TM manner, and a reference block at an optimal offset position obtained according to the refined BV is copied, such that a chroma prediction value of the current block may be determined.

In operation S2103, a matching template and a reference block corresponding to the matching template are determined according to the first BV.

It should be noted that in the embodiment of the disclosure, after the first BV is determined, a matching template and a reference block corresponding to the matching template may be determined according to the first BV. In some embodiments, the operation of determining the matching template and the reference block corresponding to the matching template according to the first BV may include the following operations.

A reference template and the corresponding reference block are determined according to the first BV.

If the reference template meets a first preset condition, first processing is performed on a neighboring region of the reference template, to determine the matching template.

In some embodiments, the operation of determining the matching template and the reference block corresponding to the matching template according to the first BV may include the following operations.

A reference template and the corresponding reference block are determined according to the first BV.

If the reference template meets a second preset condition, the reference template is used as the matching template.

It should also be noted that in the embodiment of the disclosure, the matching template may include samples in the reference template and samples in a neighboring region of the reference template.

It should also be noted that in the embodiment of the disclosure, available reconstructed samples may be determined according to the template type refTemplateType of the current block. For example, when the template type refTemplateType is 1, as shown in FIG. 17, it indicates that left, top-left and top neighboring reconstructed samples are available, a number of available reconstructed samples at the left side is templateW_size*nTbH, a number of available reconstructed samples at the top side is templateH_size*nTbW, and a number of available reconstructed samples at the top-left side is templateW_size*templateH_size.

In the embodiment of the disclosure, the first preset condition is different from the second preset condition. In some embodiments, the method may further include the following operation. If samples outside the reference template and the reference block are used, it is determined that the reference template meets the first preset condition.

In some embodiments, the method may further include the following operation. If samples outside the reference template and the reference block are not used, it is determined that the reference template meets the second preset condition.

It should be noted that in the embodiment of the disclosure, considering that reconstructed samples outside the reference template and the reference block may be used by the filter, it needs to pad boundary samples. Regions required to be padded at the boundaries are different according to different shapes of filters. A type of boundary padding region is shown in FIG. 18A, another type of boundary padding region is shown in FIG. 18B, here grid regions are regions required to be padded.

In some embodiments, when the reference template meets the first preset condition, the operation of performing the first processing on the neighboring region of the reference template may include the following operation. If the samples outside the reference template and the reference block are used, padding processing is performed on samples in the neighboring region of the reference template.

In the embodiment of the disclosure, regarding the padding processing, it needs to determine first whether the samples in the neighboring region of the reference template are available. In some embodiments, the operation of performing the padding processing on the samples in the neighboring region of the reference template may include the following operations.

It is determined whether the samples in the neighboring region of the reference template are available.

If the samples in the neighboring region of the reference template are available, the samples in the neighboring region of the reference template are directly used.

If the samples in the neighboring region of the reference template are unavailable, padding processing is performed on the neighboring region of the reference template by copying reconstructed samples in neighboring reference templates or neighboring reference blocks of the samples, to obtain the samples in the neighboring region of the reference template.

It should be noted that the samples in the neighboring region of the reference template being available may include at least one of:
the samples do not exceed a preset search range;
the samples do not exceed boundaries of a picture;
the samples do not exceed boundaries of a tile; or
the samples have been reconstructed.

In the embodiment of the disclosure, regarding the padding processing, a copying operation may also be directly performed without determining whether the samples in the neighboring region of the reference template are available. In some embodiments, the operation of performing the padding processing on the samples in the neighboring region of the reference template may include the following operation. Padding processing is performed on the neighboring region of the reference template by directly copying reconstructed samples in neighboring reference templates or neighboring reference blocks of the samples, to obtain the samples in the neighboring region of the reference template. It should be noted that “directly copying” here means that it is unnecessary to determine whether the samples in the neighboring region of the reference template are available.

In some embodiments, regarding the padding processing, the method may further include the following operation. If the samples outside the reference template and the reference block are used, padding processing is not performed on samples in the neighboring region of the reference template, and the samples are skipped when the model parameters are determined.

That is, there are also multiple different methods for the padding processing in the embodiment of the disclosure. A padding manner is to determine whether the grid regions are available. If the grid regions are available, the reconstructed samples are directly used; if the grid regions are unavailable, the grid regions are padded by copying reconstructed samples of the neighboring reference template or reference block. Or, another padding manner is to pad the grid regions by directly copying reconstructed samples of the neighboring reference template or reference block, without considering whether the grid regions are available. Or, yet another padding manner is that it may abandon using corresponding data to participate in calculation when boundary positions are encountered, without padding them, which is not specifically limited here.

In operation S2104, model parameters are determined according to the first template and the matching template, the reference block is filtered according to the model parameters, and a filtered reference block is determined.

It should be noted that in the embodiment of the disclosure, after determining the number of available reconstructed samples, a reconstructed region for calculating filter coefficients (that is, model parameters) is determined according to the available reconstructed samples, this region is referred to as R, and R usually includes all available reconstructed samples in the template. For example, when refTemplateType is 1, R includes all available reconstructed samples at left, top-left and top sides.

It should also be noted that in the embodiment of the disclosure, the model parameters may include coefficients of a target filter. In some embodiments, the method may further include the following operation. The coefficients of the target filter are determined according to sample reference values in the first template and sample reference values in the matching template.

It should also be noted that in the embodiment of the disclosure, the coefficients of the target filter may be determined by solving an optimization problem. Correspondingly, in some embodiments, the method further includes the following operation. The coefficients of the target filter are coefficients used by the target filter when a first error between output values after processing the sample reference values in the matching template by the target filter and the sample reference values in the first template meets a first condition.

It should be understood that as to the first error meeting the first condition, in a possible implementation, the first condition is that the first error is minimum. Or, in another possible implementation, the first condition is that the first error is within a first preset threshold range. Or, in yet another possible implementation, the first condition is that variation of the first error is within a second preset threshold range.

It should also be understood that both the first preset threshold range and the second preset threshold range are measurement criteria preset by the decoding side to determine whether the first error meets the first condition. Furthermore, the first error here may be MSE, or may be SSE, or may be SAD, or may be SATD after a Hadamard transform, or may be MAE or the like, which is not specifically limited in the embodiment of the disclosure, either.

In some embodiments, the operation of determining the coefficients of the target filter according to the sample reference values in the first template and the sample reference values in the matching template may include the following operations.

Autocorrelation parameters are determined according to the sample reference values in the matching template.

Cross-correlation parameters are determined according to the sample reference values in the first template and the sample reference values in the matching template.

The coefficients of the target filter are determined according to the autocorrelation parameters and the cross-correlation parameters.

It should be noted that in the embodiment of the disclosure, the sample reference values include at least one of a reconstructed sample value, a sample gradient value, or sample position information.

That is, in the embodiment of the disclosure, the target filter is used as a filter model in the embodiment of the disclosure, and input information of the target filter includes the sample reference values in the matching template. Here, the coefficients of the target filter may be represented by c_{k,l}, which may also be referred to as filter coefficients in the embodiment. Input information for calculating the filter coefficients may be the available reconstructed samples in the matching template; or, gradients (including, but not limited to a horizontal gradient, a vertical gradient, etc.) of each reconstructed sample in the matching template may be calculated, and the calculated gradients are used as the input information for calculating the filter coefficients; or, position information of each reconstructed sample may be used as the input information for calculating the filter coefficients, and the position information here may be information of an absolute position of each reconstructed sample in the entire picture, or may be information of a relative position of each reconstructed sample relative to a certain reference point, which is not specifically limited here.

In a specific embodiment, a reconstructed region R for calculating the filter coefficients is determined first, and then a group of filter coefficients may be derived by minimizing MSE between reconstructed samples in the region R and reconstructed samples in the first template, as shown in the foregoing formulas (3) and (4).

Further, a process of deriving the filter coefficients by minimizing MSE is specifically as follows.

First, a partial derivative of c_{k,l} is calculated and is set to 0, as shown in the foregoing formulas (5) and (6). Here k, l are between −1 and 1, and m, n are between −1 and 1.

Secondly, an equation shown in formula (7) is obtained by organizing according to formula (5) and formula (6).

Thirdly, after determining the reconstructed region R, formula (7) is expanded into a matrix form, which is specifically shown in the foregoing formulas (8)˜(10).

In this way, since an autocorrelation matrix of refTemp in the reconstructed region R and cross-correlation vectors of refTemp and recTemp are known quantities, the filter coefficients c_{k,l} may be calculated by solving a set of equations shown in formula (7), and the filter coefficients c_{k,l} may be implemented by fixed-points, or may not be implemented by fixed-points.

Furthermore, in the embodiment of the disclosure, as to the target filter, it also needs to determine a number of the coefficients of the target filter, a shape of the target filter, etc. The number of the coefficients of the target filter and the shape of the target filter may be preset fixed values, or may have an associated relationship with the size of the current block.

In some embodiments, as to the number of the coefficients of the target filter, the method may further include the following operation. A number of the coefficients of the target filter is equal to a first preset value.

In some embodiments, as to the number of the coefficients of the target filter, the method may further include the following operation. A number of the coefficients of the target filter is determined. The number of the coefficients of the target filter is encoded, and obtained encoded bits are signalled into a bitstream.

It should be noted that the number of the coefficients of the target filter may be represented by nTap. Exemplarily, value of nTap may be 4, 5, 6, 7, 8, 9 or the like, while it is not specifically limited.

It should also be noted that the number of the coefficients of the target filter may also be referred to as a number of taps of the target filter. Here, the number of the coefficients of the target filter may be a preset constant value, or may be determined according to the size of the current block, which is not specifically limited here.

In some embodiments, as to the shape of the target filter, the method may further include the following operation. The target filter is a one-dimensional or two-dimensional filter with a preset shape.

In some embodiments, as to the shape of the target filter, the method may further include the following operations. A shape of the target filter is determined. The shape of the target filter is encoded, and obtained encoded bits are signalled into a bitstream.

In some embodiments, the method may further include the following operation. A value of a filter shape parameter is determined, here the filter shape parameter indicates a shape of the target filter. Further, the method may further include the following operation. The value of the filter shape parameter is encoded, and obtained encoded bits are signalled into a bitstream.

It should be noted that the filter shape parameter may be represented by FilterIdx, and FilterIdx indicates the shape of the target filter. In the embodiment of the disclosure, the shape of the target filter may be a diamond shape, a rectangular shape, a cross shape, a strip shape, or may even be a one-dimensional filter, a two-dimensional filter or the like, while it is not specifically limited.

Exemplarily, if value of FilterIdx is equal to 0, the shape of the target filter is determined as a diamond shape; if the value of FilterIdx is equal to 1, the shape of the target filter is determined as a cross shape; if the value of FilterIdx is equal to 2, the shape of the target filter is determined as a rectangular shape.

Exemplarily, FIG. 19 is a schematic diagram of a shape of a filter provided in an embodiment of the disclosure. As shown in FIG. 19, the shape of the filter is a cross shape, and a number of taps of the filter is 5. Here, the number of taps of the filter may be dynamically adjusted according to the size of the current block.

It should also be noted that the shape of the target filter may be a preset shape, or may be determined by the value of the filter shape parameter, or may even be determined according to the size of the current block, which is not specifically limited here.

It should be noted that in the embodiment of the disclosure, after determining the model parameters, a prediction value of the current block may be determined according to the model parameters and the reference block. Specifically, the reference block is filtered according to the model parameters, and then the prediction value of the current block is determined according to the filtered reference block.

In some embodiments, the operation of filtering the reference block according to the model parameters, and determining the filtered reference block may include the following operations. The reference block is filtered according to the model parameters, and a first output value of the target filter is determined. The filtered reference block is determined based on the first output value of the target filter.

In some embodiments, the operation of filtering the reference block according to the model parameters, and determining the filtered reference block may include the following operation. If samples in a neighboring region of the reference block are used, padding processing is performed on the samples in the neighboring region of the reference block. That is, in the embodiment of the disclosure, if it needs to use the samples in the neighboring region of the reference block, it means that it needs to pad the samples in the neighboring region of the reference block.

In the embodiment of the disclosure, the first output value of the target filter may be calculated according to a reconstructed sample value of the reference block and the coefficients of the target filter from the model parameters, and then the filtered reference block may be determined according to the first output value of the target filter. The target filter here may be a linear filter model or a non-linear filter model, which is not specifically limited.

In a possible implementation, the operation of filtering the reference block according to the model parameters, and determining the first output value of the target filter may include the following operations.

A product of a reconstructed sample value of the reference block and a corresponding one of the coefficients of the target filter is calculated.

The first output value of the target filter is set to be equal to a sum of n products, here n represents a number of the coefficients of the target filter, and n is a positive integer.

It should be noted that the target filter in the embodiment of the disclosure is a linear filter model. The first output value of the target filter may be calculated by the foregoing formula (11).

In another possible implementation, the operation of filtering the reference block according to the model parameters, and determining the first output value of the target filter may include the following operations.

A first value of a reconstructed sample value of the reference block under a first mapping relationship is determined.

A product of the first value and a corresponding one of the coefficients of the target filter is calculated.

The first output value of the target filter is set to be equal to a sum of n products, here n represents a number of the coefficients of the target filter, and n is a positive integer.

It should be noted that the target filter in the embodiment of the disclosure is a non-linear filter model. Exemplarily, when MSE of the filter coefficients is minimized, the first output value of the target filter may be calculated by the foregoing formulas (12) and (13) at this time.

It should also be noted that in the embodiment of the disclosure, as to determining the filtered reference block based on the first output value of the target filter, it may be that the first output value of the target filter is directly set as the filtered reference block; or may be that first filtering is performed on the first output value of the target filter, to obtain the filtered reference block. The first filtering here may be low-pass filtering, up/down sampling filtering or the like, which is not specifically limited here.

It should also be noted that in the embodiment of the disclosure, after determining the first output value of the target filter, a first offset value (represented by bias) may be added to the first output value, to determine the filtered reference block.

In some embodiments, the operation of determining the filtered reference block based on the first output value of the target filter may include the following operations. A first offset value is determined. An addition operation is performed according to the first output value and the first offset value, to determine the filtered reference block.

In a possible implementation, the operation of determining the first offset value may include the following operation. The first offset value is set to be equal to a second preset value.

In another possible implementation, the operation of determining the first offset value may include the following operations. A number of samples corresponding to the target filter and participating in filtering is determined based on a shape of the target filter. If the number of samples corresponding to the target filter and participating in filtering is m, (m+1) coefficients of the target filter are determined, here m is a positive integer. The first offset value is determined according to a second offset value and one of the (m+1) coefficients.

In the embodiment of the disclosure, as to the target filter, the number of samples participating in a filtering operation is m, while with consideration of the second offset value, the target filter needs to determine (m+1) coefficients at this time; and then a weighted calculation is performed on m samples participating in the operation and a second offset value according to the (m+1) coefficients. As to the second offset value, a coefficient used by the second offset value may be a (m+1)-th coefficient; however, the coefficient used by the second offset value may also be other coefficients, which is not specifically limited here.

In the embodiment of the disclosure, as to the second offset value, the method may further include the following operations. The second offset value is set to be equal to a third preset value. Or, the second offset value is set to be equal to a value of a reconstructed sample value of the reference block under a second mapping relationship.

It should be noted that the second mapping relationship may be a linear mapping relationship or a non-linear mapping relationship, and there may be multiple non-linear mapping relationships, which is not specifically limited here.

In the embodiment of the disclosure, the calculated filter coefficients are used as a number of taps corresponding to a filter template, that is, the number of the filter coefficients is equal to the number of taps of the filter template, nTap. Furthermore, several biases may be added to the filter template. Exemplarily, in the embodiment of the disclosure, when nTap=5, the filter coefficients are tap coefficients c₀ to c₄ corresponding to the filter template at this time, and a prediction value at a position (i, j) of the filtered reference block is calculated, as shown in the above formula (14). At this time, a bias may be added, as shown in the above formula (15).

In the embodiment of the disclosure, cₙ=c_{i,j,k,l}. Here Constant may be a fixed constant, such as Constant=1<<(BitDepth−1); or, Constant may be a number related to a reconstructed sample value at the position (i, j) of the reference block, such as Constant=f(ref[i][j]); or, Constant may be a number related to a reconstructed sample value corresponding to a certain tap in the filter template except the (i, j) position, such as Constant=f(ref[k][l]). Constant=f(ref[i][j]) or Constant=f(ref[k][l]) may be a linear mapping relationship or a non-linear mapping relationship. One or more biases may be added, which is not specifically limited here.

In operation S2105, a prediction value of the current block is determined according to the filtered reference block.

Further, in some embodiments, the operation of determining the prediction value of the current block according to the filtered reference block may include the following operation. Second processing is performed on the filtered reference block, to obtain the prediction value of the current block.

In the embodiment of the disclosure, the second processing may be that the prediction value of the current block is set to be equal to the filtered reference block; or, the second processing may be a clip operation that limits the filtered reference block within a preset numerical range; or, the second processing may be other operations, which is not specifically limited here.

Here, as to the clip operation, the preset numerical range here may be between 0 and (1<<BitDepth)−1, here BitDepth represents a bit depth. If the filtered reference block exceeds values of the preset numerical range, it needs to perform a corresponding correction operation on the filtered reference block. Exemplarily, the filtered reference block may also be represented by Y^{pred}[i][j], and the correction operation may be performed on Y^{pred}[i][j] at this time, which is specifically as follows.

When value of Y^{pred}[i][j] is less than 0, the value is set to 0.

When the value of Y^{pred}[i][j] is equal to or greater than 0 and less than or equal to (1<<BitDepth)−1, the value is equal to Y^{pred}[i][j].

When the value of Y^{pred}[i][j] is greater than (1<<BitDepth)−1, the value is set to (1<<BitDepth)−1.

In this way, after performing the correction operation on Y^{pred}[i][j], it may be ensured that all sample values in the filtered reference block are between 0 and (1<<BitDepth)−1.

Further, a number of filter models may be expanded, multiple filter models may be established besides establishing only one filter model. Therefore, in some embodiments, the method may further include the following operations.

Multiple groups of model parameters are determined according to the first template and the matching template.

Multiple filter models are constructed according to the multiple groups of model parameters, the reference block is filtered according to the multiple filter models respectively, and multiple filtered reference blocks are determined.

The prediction value of the current block is determined according to the multiple filtered reference blocks.

In some embodiments, the operation of determining the multiple groups of model parameters according to the first template and the matching template may include the following operations. Reconstructed samples in the first template and the matching template are classified respectively according to a preset manner, to obtain multiple groups of sub-templates and multiple groups of sub-matching templates. The multiple groups of model parameters are determined according to the multiple groups of sub-templates and the multiple groups of sub-matching templates.

It should be noted that in the embodiment of the disclosure, the preset manner here may be values of the reconstructed samples, or may be position information of the reconstructed samples, or may be the shape of the filter or the like, which is not limited. After classifying according to the preset manner, a group of model parameters may be calculated according to each group of sub-templates and corresponding sub-matching templates, and a filter model may be determined according to each group of model parameters, such that multiple filter models may be constructed.

In a possible implementation, the method may further include the following operations. A target filter is determined from the multiple filter models. The reference block is filtered according to the target filter, and the prediction value of the current block is determined.

Further, in some embodiments, the method may further include the following operations. A target model index value is determined, here the target model index value indicates an index number of the target filter in the multiple filter models. The target model index value is encoded, and obtained encoded bits are signalled into a bitstream.

Further, in some embodiments, the operation of determining the target filter from the multiple filter models may include the following operations. An original value of the current block is determined. Cost calculations are performed respectively according to the original value of the current block and multiple initial prediction values of the current block, to determine costs of each of the multiple initial prediction values. A minimum cost is determined from the costs of each of the multiple initial prediction values. A filter model corresponding to the minimum cost is used as the target filter. It should be noted that the cost here may be a distortion value, or may be a rate distortion cost determined based on a RDO manner, or may even be other costs, which is not specifically limited.

In another possible implementation, the reference block is filtered according to multiple filter models respectively, and multiple filtered reference blocks may be determined. In some embodiments, the operation of determining the prediction value of the current block according to the multiple filtered reference blocks may include the following operation. A weighted calculation is performed on the multiple filtered reference blocks, to determine the prediction value of the current block.

It should be noted that if a weight value of each filtered reference block is equal and equal to a reciprocal of a number of reference blocks, the weighted calculation here may also be considered as an averaging calculation. In other words, an averaging calculation is performed on the multiple filtered reference blocks, to determine the prediction value of the current block.

Exemplarily, input information for calculating the filter coefficients is classified, and a filter model is established for each category of input information respectively. For example, when the filter model is established by using reconstruction information, an implementable manner is to classify by an average value of the reconstruction information, to establish a filter model for reconstruction information greater than the average value, and establish a filter model for reconstruction information less than the average value. Another implementable manner is to classify by positions of the reconstruction information, for example, a filter model may be established by using available reconstruction information at left and top sides, a second filter model may be established by using available reconstruction information at left and top-left sides, or the like, and usage of which model is determined at the encoding side. An implementable decision-making manner is that usage of which model is determined at the encoding side in a RDO manner, and corresponding decoding parameters are transmitted by the encoding side to the decoding side, such that which filter model is clearly selected at the decoding side subsequently. Another implementable manner is to classify by the shape of the filter, multiple different shapes of filters may be used, a filter model is established for each shape of filter, and usage of which shape of filter is determined at the encoding side. An implementable decision-making manner is that usage of which filter is determined at the encoding side in a RDO manner, and corresponding decoding parameters are transmitted by the encoding side to the decoding side, such that which filter model is clearly selected at the decoding side subsequently.

It should also be noted that in the embodiment of the disclosure, after determining the prediction value of the current block, a prediction residual of the current block may also be calculated. In some embodiments, the operation of determining the prediction residual of the current block according to the prediction value of the current block may include the following operations. An original value of the current block is determined. The prediction residual of the current block is determined according to the original value of the current block and the prediction value of the current block.

In a specific embodiment, the operation of determining the prediction residual of the current block according to the original value of the current block and the prediction value of the current block may include the following operation. A subtraction operation is performed on the original value of the current block and the prediction value of the current block, to determine the prediction residual of the current block.

It should also be noted that in the embodiment of the disclosure, whether the IBC is applied to the current block or whether the current block is used for the filter model, may be determined by different syntax element identification information here. In some embodiments, the method may further include the following operations. A value of first syntax element identification information is determined, here the first syntax element identification information indicates whether IBC is applied to the current block. The value of the first syntax element identification information is encoded, and obtained encoded bits are signalled into a bitstream.

In the embodiment of the disclosure, the operation of determining the value of the first syntax element identification information may include the following operations. If the IBC is applied to the current block, the value of the first syntax element identification information is determined as a first value. Or, if the IBC is not applied to the current block, the value of the first syntax element identification information is determined as a second value.

Further, in some embodiments, the method may further include the following operations when the first syntax element identification information indicates that the IBC is applied to the current block. A value of second syntax element identification information is determined, here the second syntax element identification information indicates whether a filter model is applied to the current block. The value of the second syntax element identification information is encoded, and obtained encoded bits are signalled into a bitstream.

In the embodiment of the disclosure, the operation of determining the value of the second syntax element identification information may include the following operations. If the filter model is applied to the current block, the value of the second syntax element identification information is determined as a first value. Or, if the filter model is not applied to the current block, the value of the second syntax element identification information is determined as a second value.

Further, in some embodiments, the method may further include the following operations.

If the filter model is applied to the current block, operations of filtering the reference block according to the model parameters, and determining the filtered reference block; and determining the prediction value of the current block according to the filtered reference block are performed.

If the filter model is not applied to the current block, a reconstructed sample value in the reference block is used as the prediction value of the current block.

It should be noted that in the embodiment of the disclosure, the first value is different from the second value, and the first value and the second value may be in a parameter form or in a numeral form. Specifically, the first syntax element identification information and the second syntax element identification information may be parameters written into a profile or a value of a flag, which is not specifically limited here. Exemplarily, as to the first value and the second value, the first value may be set to 1, and the second value may be set to 0; or, the first value may be set to true, and the second value may be set to false. However, specific limitation is not made thereto here.

It should also be noted that in the embodiment of the disclosure, whether the current block uses the filtered reference block as a final prediction value is determined by certain conditions, which include, but are not limited to the following three manners. Exemplarily, the three manners may be as follows.

Manner 1: whether the matching template is filtered is determined by comparing a distortion between the matching template and template of the current block, such as SAD, MSE, SATD, SSE or the like with a threshold T_Distortion1.

Manner 2: based on that Manner 1 is met and the filter model is used, whether the reference block is filtered is determined by comparing a distortion between the filtered matching template and template of the current block, such as SAD, MSE, SATD, SSE or the like with a threshold T_Distortion2.

Manner 3: the encoding side transmits a flag to indicate whether the filter model is applied. tmpFlag indicates whether intra template matching is applied to the current block, and filterFlag indicates whether the filter model is applied to the current block. When tmpFlag is 1, whether the reference block is filtered is determined at the encoding side by comparing distortions between the reference block before and after filtering and the current block, such as SAD, MSE, SATD or SSE. If the distortion after filtering is less than the distortion before filtering, filterFlag is 1, and the current block uses the filtered reference block as the prediction block; otherwise, filterFlag is 0, and the current block uses the reference block before filtering as the prediction block. filterFlag is transmitted by the encoding side to the decoding side.

Further, in some embodiments, the method may further include the following operations. Multiple reference blocks in a second search region and model parameters of each of the multiple reference blocks are determined. The multiple reference blocks are filtered respectively according to the model parameters of each of the multiple reference blocks, and multiple filtered reference blocks are determined. Cost calculations are performed between the multiple filtered reference blocks and the current block respectively, to determine costs of each of the multiple filtered reference blocks. A minimum cost is determined from the costs of each of the multiple filtered reference blocks, and the filtered reference block and a reference block index number corresponding the filtered reference block are determined according to the minimum cost. The reference block index number is encoded, and obtained encoded bits are signalled into a bitstream.

It should be noted that in the embodiment of the disclosure, the cost here may be a distortion value, or may be a rate distortion cost determined based on a RDO manner, or may even be other costs, which is not specifically limited.

It should also be noted that in the embodiment of the disclosure, as to the reference block to which the filter coefficients are applied, according to the foregoing embodiments, the filter coefficients are calculated only for the best matching template after the search completes, and the filter coefficients are applied to the best matching reference block; furthermore, the filter coefficients may also be applied to all or part of reference blocks in the search region here, and which filtered reference block is used as a final prediction block is determined by certain conditions, which include, but are not limited to the following manners.

Manner 1: the filter coefficients are solved for templates in the search range and used for filtering, and their costs with the current template are calculated to determine which template is used, that is, the filter coefficients are calculated for part or all of to-be-searched templates in the search range, then the filter coefficients are applied to the to-be-searched templates, costs of the templates with the current template are calculated, a filtered best matching template is selected according to the costs, and the reference block corresponding to the best matching template is filtered and used as the final prediction value.

Manner 2: the encoding side transmits a flag to indicate which filtered reference block is used as the final prediction block. tmpFlag indicates whether TM is applied to the current CB, and filterIdx indicates whether the filter model is applied to which reference block in a current search range. When tmpFlag is 1, an optimal reference block is selected at the encoding side by comparing distortions between reference blocks to which the filter coefficients are applied in the search range and a current original block, such as SAD, MSE, SATD or SSE, and a corresponding index is transmitted by the encoding side to the decoding side.

Further, in some embodiments, “samples in the template” may be replaced by “identified samples in the template”; and “samples in the reconstructed block corresponding to the template” may be replaced by “identified samples in the reconstructed block corresponding to the template”. The identified samples in the template refer to one or more samples located at a corner position of the template region, such as samples at a top-left corner and a bottom-right corner of a top template region when there is only a top template, or only samples at the bottom-right corner of the top template region. The identified samples in the reconstructed block corresponding to the template refer to one or more samples located at a corner position of the reconstructed block region, such as samples at a top-left corner and a bottom-right corner of the reconstructed block region, or only samples at the bottom-right corner of the reconstructed block region.

It should be noted that in the embodiment of the disclosure, considering that the filter may use reconstructed samples outside the reference template and the reference block, it needs to pad boundary samples. A boundary padding implementation is shown in FIG. 18A and FIG. 18B, here grid regions are regions required to be padded.

In some embodiments, a padding manner is to determine whether samples in the grid regions are available, one by one. If the samples are available, the reconstructed samples are directly used; if the samples are unavailable, the grid regions are padded by copying reconstructed samples of a nearest reference template or reference block.

A method for determining whether the samples are available includes, but is not limited to meeting one or more of the following conditions:
the samples are within boundaries of a picture;
the samples are within boundaries of a tile; or
the samples have been reconstructed.

In some other embodiments, a padding manner is to determine whether positions of the padding regions exceed a BV search range, according to the BV search range. If the positions of the padding regions do not exceed the search range, the reconstructed samples are directly used; if the positions of the padding regions exceed the search range, the grid regions are padded by copying reconstructed samples of a neighboring reference template or reference block. Specifically, whether boundaries need to be padded is determined according to the derived iVerMin, iVerMax, iHorMin and iHorMax.

leftPadding, rightPadding, topPadding and bottomPadding indicate whether a left grid region, a right grid region, a top grid region and a bottom grid region copy nearest reconstructed samples, that is:

$$\begin{matrix}leftPadding = ! ( pX\_Best > iHorMin ) ; \\ rightPadding = ! ( pX\_Best < iHorMax ) ; \\ topPadding = ! ( pY\_Best > iVerMin ) ; \\ bottomPadding = ! ( pY\_Best < iverMax ) .\end{matrix}$$

Here, if leftPadding is true, it means that samples in the left grid region exceed the BV search range, and reconstructed samples of a nearest neighboring reference template are copied; otherwise, reconstructed samples at this position are directly used. If rightPadding is true, it means that samples in the right grid region exceed the BV search range, and reconstructed samples of a nearest neighboring reference template or reference block are copied; otherwise, reconstructed samples at this position are directly used. If topPadding is true, it means that samples in the top grid region exceed the BV search range, and reconstructed samples of a nearest neighboring reference template are copied; otherwise, reconstructed samples at this position are directly used. If bottomPadding is true, it means that samples in the bottom grid region exceed the BV search range, and reconstructed samples of a neighboring reference template or reference block are copied; otherwise, reconstructed samples at this position are directly used.

Further, in the embodiment of the disclosure, a relevant mode selection flag (ibcFilterFlag) is transmitted at a CU layer. Manners of encoding ibcFilterFlag may be implemented in multiple manners. An implementable manner is to use equal-probability encoding; another implementable manner is to use context encoding, default context initial state and context update rate may be used, or context initial state and context update rate may be determined by statistics, which is not specifically limited here.

Further, in the embodiment of the disclosure, the method for encoding may be implemented in combination with various sub-modes in the IBC, which include, but are not limited to ordinary IBC merge, IBC TM merge, MBVD, IBC CIIP, IBC ABVP or the like, which is not specifically limited here, either.

Further, in the embodiment of the disclosure, the method for encoding is not limited to the intra prediction mode, nor is it limited to the IBC mode, and the method for encoding may be applicable to other modes to which the BV is applied. Furthermore, the BV in the method for encoding is not limited to the BV used by the IBC, and the template in the method for encoding is not limited to the template used by the IBC, or the like, which is not specifically limited here.

Further, an embodiment of the disclosure further provides a bitstream, the bitstream is generated by bit encoding according to to-be-encoded information, here the to-be-encoded information includes at least one of: a prediction residual of a current block, BV indication information, a reference block index number, a number of coefficients of a target filter, a shape of the target filter, a value of first syntax element identification information, or a value of second syntax element identification information.

In the embodiment of the disclosure, the BV indication information may include at least one of a BV index number or a BVD. Furthermore, the first syntax element identification information indicates whether IBC is applied to the current block, and the second syntax element identification information indicates whether a filter model is applied to the current block.

The embodiment provides a method for encoding, in which a first template of a current block is determined first, a BV candidate list of the current block is determined; then, a first BV is determined according to the BV candidate list; then, a matching template and a reference block corresponding to the matching template are determined according to the first BV; model parameters are determined according to the first template and the matching template, the reference block is filtered according to the model parameters, and a filtered reference block is determined; and finally, a prediction value of the current block is determined according to the filtered reference block. In this way, the model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

In yet another embodiment of the disclosure, based on the encoding/method for decoding described in the foregoing embodiments, during prediction of the IBC, the embodiment of the disclosure proposes to correct a best matching reconstructed block, and use corrected reconstructed samples as prediction samples of the current CB. Specifically, a linear filter model is established by using samples of the matching template and template of the current CB, the linear filter model is applied to the best matching reconstructed block, and the filtered samples are used as final prediction samples. This technical solution is referred to as an IBC-FLM technology.

A prediction process of the IBC-FLM technology will be introduced in detail below.

Input of the IBC-FLM: position (xTbCmp, yTbCmp) of the current block, width nTbW of the current block, and height nTbH of the current block.

Output of the IBC-FLM: prediction value predSamples[x][y] of the current block, here x=0 . . . nTbW−1, y=0 . . . nTbH−1.

A specific prediction process of the IBC-FLM technology may be divided into five steps as follows: determining a current template type, acquiring reconstructed samples of the current template, determining BVs within a predefined search range, establishing a linear filter model, and generating prediction values. It should be noted that an Intra Template Matching Prediction based on Filter-based Linear Model (TMP-FLM) technology may be used for predicting a luma component or a chroma component, which is not specifically limited here, either.

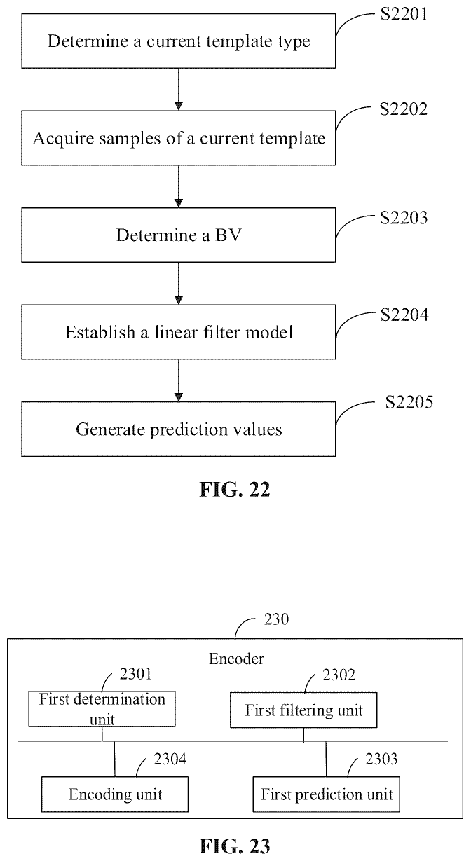

With reference to FIG. 22, a schematic diagram of a prediction process based on an IBC-FLM technology provided in an embodiment of the disclosure is shown. As shown in FIG. 22, the process may include the following operations S2201 to S2205.

In operation S2201, a current template type is determined.

It should be noted that according to the IBC technology, neighboring reconstructed samples of the current block are used as a template to search a matching template in a predefined search region, here the neighboring reconstructed samples may be a top reference sample, a top-left reference sample and a left reference sample of the CB, etc. Therefore, template types may be classified and the template type may be determined according to availability of the neighboring reference samples. The template type may be represented by refTemplateType. Exemplarily, when a top-left reference sample, a top reference sample and a left reference sample are all available, refTemplateType has a value of 1, and the template shape is shown in FIG. 16A; when only the left reference sample is available, refTemplateType has a value of 2, and the template shape is shown in FIG. 16B; and when only the top reference sample is available, refTemplateType has a value of 3, and the template shape is shown in FIG. 16C.

In operation S2202, samples of a current template are acquired.

The template of the IBC may consist of reconstructed samples of one or more regions at the top side, left side and top-left side of the CB. A template size may be preset. For example, when a left template is acquired, a template width templateW_size may be set to 4, and when a top template is acquired, a template height templateH_size may be set to 4.

Specifically, it may determine to acquire which part of reconstructed samples according to the value of refTemplateType.

For example, when refTemplateType has a value of 1, reconstructed samples at the left side, the top-left side and the top side of the current CB are acquired; or, when refTemplateType has a value of 2, only reconstructed samples on left four columns of the current CB are acquired; or, when refTemplateType has a value of 3, only reconstructed samples on top four rows of the current CB are acquired.

In operation S2203, a BV is determined.

It should be noted that in the embodiment of the disclosure, the BV may be a BV based on a luma component and/or a BV based on a chroma component, which will be respectively described in detail below.

### (i) Luma Component:

Input: luma position (xCb, yCb), which specifies a sample at a top-left corner of the current block relative to a luma sample at a top-left corner of the current picture; a variable cbWidth, which specifies a width of the current block in the luma sample; and a variable cbHeight, which specifies a height of the current block in the luma sample.

Output: bvL of luma.

The IBC mode may be substantially divided into two modes: IBC merge and IBC ABVP (similar to merge and AMVP modes of an inter mode in VVC), and their processes of acquiring the BV may be treated as the following three operations (1) to (3).

In operation (1), when bvL is derived, it needs to establish an IBC BV candidate list bvCandList.

In operation (2), a candidate in a selected candidate list is determined according to the bitstream.

In operation (3), a final BV is determined according to the candidate finally.

Information specifically stored in the IBC candidate includes at least one of the following information:
a prediction direction (L0 or L1, it is L0 by default in general);
BV information (a horizontal component, a vertical component);
a reference frame (it is the current picture by default);
a flip type (such as non-flip, horizontal flip, and vertical flip); or
whether LIC (a linear model) is used.

An establishment process of the BV candidate list will be introduced below. Taking an establishment process of an IBC merge list as an example, a basic establishment process of an IBC ABVP list is consistent with that of the IBC merge, while a maximum number of candidates is inconsistent between the two processes (for example, a length of the IBC merge candidate list is defined as 6, and a length of the IBC ABVP candidate list is defined as 2). A specific establishment process includes the following operations 1 and 5.

Operation 1: candidates in a spatial domain are derived.

When usage conditions are met (for example, a size condition IsGt4by4 is equal to TRUE, that is, the variable IsGt4by4 is TRUE when a product of multiplying a luma width by a luma height is greater than 16), a derivation process of spatial BV candidates from neighboring CUs specified in a decoding specification is called as an input by using the position (xCb, yCb) of the luma CB, the width cbWidth and height cbHeight of the luma CB, and outputs are availability flags such as availableFlagA1, availableFlagB1 and BVs bvA1 and bvB1.

Detection of availability of each candidate is as follows. The following conditions are judged, and the candidate is available if all the following conditions are met:
whether an offset position obtained by adding the position of the current block to BVP does not exceed boundaries of a picture;
whether a block position pointed to by adding the position of the current block to the BVP does not cover the current block;
whether the offset position obtained by adding the position of the current block to the BVP does not exceed an IBC available region;
whether the block position pointed to by adding the position of the current block to the BVP has been reconstructed.

Relative positions of neighboring blocks where A1, B1 or the like are located and the current block are shown in FIG. 3. A traversal order in FIG. 3 may be A1->B1->B0->A0->B2.

Operation 2: candidates in the spatial domain are added to the candidate list.

When the usage conditions are met (for example, the size condition IsGt4by4 is equal to TRUE), the BV candidate list bvCandList is constructed as follows:

$$\begin{matrix}i = 0 ; \\ if ( availableFlagA 1 ) ; \\ bvCandList [ i + + ] = bvA 1 ; \\ if ( availableFlagB 1 ) ; \\ bvCandList [ i + + ] = bvB 1 ; \\ … …\end{matrix}$$

Operation 3: a number of valid items in the candidate list is checked.

A derivation process of a variable numCurrCand (a number of candidates obtained currently) is as follows.

If the usage conditions are met (for example, the size condition IsGt4by4 is equal to TRUE), numCurrCand is set to be equal to a number of candidates in bvCandList; otherwise, numCurrCand is set to 0.

Operation 4: if the candidate list does not reach a specified number of items (for example, a specified number of items in the IBC merge mode is 6, and a specified number of items in an IBC ABVP mode is 2), derivation of history-based candidates, detection of availability and addition are performed continuously.

When numCurrCand is less than MaxNumIbcMergeCand (a maximum number of candidates in the IBC merge mode) and NumHmvpIbcCand (a maximum number of candidates for a history-based optimal BV (Hmvp) in the IBC mode) is greater than 0, a derivation process of history-based IBC BV candidates specified in the decoding specification is called with bvCandList and numCurrCand as inputs and with the modified bvCandList and numCurrCand as outputs.

Operation 5: the number of valid items in the candidate list is continuously checked, and other available candidates (such as pairwise average candidates, zero-value BV candidates, etc.) are added, until the specified number of items is reached.

Exemplarily, other available candidates are as follows.

(1) The pairwise average candidate may be constructed by using first and second candidates, specifically:

$$mvAvgLX = ( m v C a n d 0 LX + mvCand 1 LX + 1 ) >> 1.$$

(2) The zero-value BV may be directly set as follows:
bvCandList[numCurrCand][0] is set to be equal to 0. (a horizontal component of bv)
bvCandList[numCurrCand][1] is set to be equal to 0. (a vertical component of bv)

(3) A group of BVP candidates located in an IBC reference region may also be used as candidates that may be added. Coordinates of the group of BVP candidates are determined by the width and height of the current block and parameters ΔX and ΔY, as shown in FIG. 4.

Each time an item is added, numCurrCand is increased by 1.

In this way, establishment of a basic BV candidate list bvCandList is completed.

Based on this list, in the IBC merge mode, an order of the list may also be re-sorted by using templates, to adjust an order of the candidate list, fully utilize high spatial correlation, reduce transmission of encoded bits, and effectively improve encoding efficiency. For example, as to the IBC merge mode, after an intermediate candidate list is constructed according to the above list construction method (it is noted that a length of the intermediate candidate list may be equal to or greater than the maximum number of candidates in the IBC merge mode), all candidates in the list are re-sorted by using templates and are sorted in an ascending order of template matching costs, and first N (for example, N=6) candidates are selected from the sorted list. A specific process thereof is as follows. SADs of a template position of a reference block pointed to by each candidate and a template position of the current block (as shown in FIG. 5) are calculated and are sorted in an ascending order, and first 6 candidates are selected as the candidate list of the IBC merge.

Based on this list, in the IBC ABVP mode, an operation of removing redundancy of candidates may also be performed according to a distance between the candidates.

The number of the candidates remains unchanged at two, and candidate lists are established for integer-sample precision and 4-sample precision respectively.

If a non-RRIBC mode is selected for the IBC ABVP, if a number of valid BVP candidates exceeds two, at most six BVP candidates in the candidate list are clustered according to an Euclidean distance between the candidates, a radius (R) is a logarithmic function of a group of BVs determined as the width (cbWidth) and height (cbHeight) of the current block. If the Euclidean distance between reference positions pointed to by several BV candidates is less than R, the BV candidates are clustered. R is calculated as shown in the foregoing formula (2).

The clustering method is performed in an order of the candidate list, a BVP with a minimum TM cost in each category is selected as a representative candidate of the group, then representative candidates of all categories are sorted by templates, and representative candidates of first two groups are selected for a motion estimation process.

If a RRIBC mode is selected for the IBC ABVP, the candidate may be adjusted to point to a boundary of a valid IBC search region in a horizontal or vertical direction according to the RRIBC mode.

Further, the candidate in the selected candidate list is determined according to the bitstream, and specific operations thereof are as follows.

In the IBV merge mode (general_merge_flag[xCb][yCb] is true) and the IBC ABVP mode (general_merge_flag[xCb][yCb] is false), a candidate index bvIdx is derived as follows, here general_merge_flag indicates whether it is the IBC merge mode:

bvIdx=general_merge_flag[xCb][yCb]?merge_idx[xCb][yCb]:mvp_l0_flag[xCb][yCb].

The final BV is determined according to the candidate. [0703]

In the IBC merge mode, a specific bvL may be obtained according to the index bvIdx and the BV candidate list bvCandList:

$$\begin{matrix}bvL [ 0 ] = b v C a n d L i s t [ b v I d x ] [ 0 ] ; \\ bvL [ 1 ] = b v C a n d L i s t [ b v I d x ] [ 1 ] ;\end{matrix}$$

This bvL is the final BV.

In an IBC MBVD mode, similar to MMVD in the inter technology of VVC, a certain candidate in the IBC merge list is used as a starting point, a candidate is selected from a candidate point set corresponding to a predefined distance and direction set, and a BV corresponding to the candidate is used as the final BV.

Exemplarily, in the IBC MBVD, a distance set is defined as {1-pel, 2-pel, 4-pel, 8-pel, 12 pel, 16 pel, 24 pel, 32 pel, 40 pel, 48 pel, 56 pel, 64 pel, 72 pel, 80 pel, 88 pel, 96 pel, 104 pel, 112 pel, 120 pel, 128 pel}, and BVD directions are two horizontal directions that is positive and negative horizontal directions, and two vertical directions that is positive and negative vertical directions.

A base candidate may be selected from first five candidates in the re-sorted IBC merge list, and refinement positions of all possible MBVDs of each base candidate (that is, 20×4 candidates) are re-sorted based on SAD cost between the template and its reference at each refinement position. Finally, first eight refinement positions with a minimum template SAD are retained for encoding of an MBVD index. Candidates of IBC-MBVD do not inherit flip types from neighboring blocks encoded by RR-IBC. The MBVD index is binarized by a Rice code with parameters equal to 1.

In an IBC TM merge mode, after obtaining bvL according to the above information, the BV may also be locally refined by TM, specific operations thereof are that search is performed in a small range centered on the obtained bvL, and an optimal BV in the range is selected with a minimum template matching cost as a standard, as the final BV.

TM refinement is performed on the candidate list in the IBC merge mode, a specific implementation process thereof is as follows.

When candidates are constructed, a flip type is non-flip by default.

As to the IBC TM merge mode, in the IBC merge mode, a syntax element is transmitted to specify whether TM refinement with the integer-sample precision is performed. A refinement MV in each refinement operation and a position where the used template is located must comply with constraints of the reference region.

Search is performed near positions pointed to by the candidates, and an optimal position is determined by using SAD between the template of the reference block and the template of the current block, which includes, but is not limited to the following search manners. A search range is [−8, 8], an integer-sample diamond search is performed first to search eight points near a middle position, as shown in FIG. 7A and FIG. 7B; a maximum number of searches is 375, and after the optimal position is determined for the first time, the search is continuously performed to search 5 points at even positions and search 3 points at odd positions in subsequent search processes.

Exemplarily, a circle is made counterclockwise from a black point, which is an order of indices 0 to 7. The above process is specifically that when the black point position is selected as the optimal position, 5 or 3 points at point positions of the grid are continuously searched. FIG. 7A and FIG. 7B are only exemplary descriptions.

After the above diamond search process, an integer-sample cross search is performed and is performed only once. That is, after a current optimal position is found by the diamond search, four positions below, right, above and left of the current optimal position with a sample apart from the current optimal position are checked, to update a final optimal position, that is, update and obtain a refined candidate list.

As to the IBC ABVP mode, bvL obtained by the index bvIdx and the BV candidate list bvCandList is a predicted bvL, and it also needs to add bvL to BVD to obtain a real bvL, a generalized specific process thereof is as follows.

Operation 1: horizontal and vertical components of the BVD are obtained, here MvdL0 is a forward MV difference.

$$bvd [ 0 ] = MvdL 0 [ xCb ] [ yCb ] [ 0 ] ;$$

$$bvd [ 1 ] = MvdL 0 [ xCb ] [ yCb ] [ 1 ] .$$

Operation 2: a rounding operation is performed on the predicted bvL acquired as above, here a parameter AmvrShift is right-shifted to perform rounding, and the parameter AmvrShift is left-shifted to improve resolution. Specifically:

$$offset = ( AmvrShift == 0 ) ? 0 : ( ( 1 << ( AmvrShift - 1 ) ) - 1 ) ;$$

$$bvL [ 0 ] = Sign ( bvL [ 0 ] ) * ( ( ( Abs ( bvL [ 0 ] ) + offset ) >> AmvrShift ) << AmvrShift ) ;$$

$$bvL [ 1 ] = Sign ( bvL [ 1 ] ) * ( ( ( Abs ( bvL [ 1 ] ) + offset ) >> AmvrShift ) << AmvrShift ) .$$

Operation 3: the real bvL is derived as follows, and its range needs to be controlled between −217 and 217-1:

$$u [ 0 ] = ( bvL [ 0 ] + bvd [ 0 ] + 218 ) \%218 ;$$

$$bvL [ 0 ] = ( u [ 0 ] >= 217 ) ? ( u [ 0 ] - 2 \; 18 ) : u [ 0 ] ;$$

$$u [ 1 ] = ( bvL [ 1 ] + bvd [ 1 ] + 2 \; 18 ) \%218 ;$$

$$bvL [ 1 ] = ( u [ 1 ] >= 217 ) ? ( u [ 1 ] - 2 \; 18 ) : u [ 1 ] .$$

It should be noted that the method for acquiring the BVD in Operation 1 may also be inferred from syntax elements obtained through other encoding methods. The BVD of the IBC ABVP takes a fractional-sample, an integer-sample or a 4-sample as a unit. During encoding, its sign may be predicted, and a suffix of an exponential-Golomb code obtained after its binarization may also be predicted. Therefore, its syntax elements may be defined by multiple information of a BVD value: a flag of 0 or not, a prefix, a sign and a suffix, an actual BVD value may be obtained by combining and parsing their information. A specific embodiment thereof is as follows.

A flag indicating whether the BVD is 0 is context encoded. A value of (absolute value −1) is binarized by first-order exponential-Golomb, first 5 binary data (bins) of an EG1 prefix are context encoded, and remaining prefixes are bypass encoded. At most 4 bins of an EG1 suffix are context encoded to transmit a prediction index, and other bins of the EG1 suffix are bypass encoded. Two bins of the sign bit are context encoded to transmit a sign prediction index. FIG. 8 shows a prediction process where there is a suffix bin transmitting a prediction index in each of the horizontal direction and the vertical direction, and a bin transmitting a sign index in each of the horizontal direction and the vertical direction here, and it is sorted by using the template of the current block and the template at the corresponding BV, to derive prediction indices of the suffix and the sign.

In this way, the BV derived finally should meet that it is within a specified range (a coordinate range with row and column as units).

Exemplarily, the IBC reference region is 128×128 in VVC, and as to a CTU with a size of 128×128, its reference region is shown in FIG. 9A to FIG. 9D. In FIG. 9A to FIG. 9D, two CTUs are included here no matter it is FIG. 9A, FIG. 9B, FIG. 9C or FIG. 9D, a region padded with oblique lines is the reference region, and a small block padded with vertical lines represents the current block with a size of 64×64; “x” represents an unavailable reference region.

In ECM 7.0, as shown in FIG. 10, a box represents a CTU, a box padded with vertical lines represents a CTU where the current block is located, and boxes padded with oblique lines represent its reference region. Specifically, as to the current block to be encoded, assuming that it is located in CTU (m, n), the reference region includes CTUs with indices (m−2, n−2) . . . (W, n−2) . . . (0, n−1) . . . (W, n−1), (0, n) . . . (m, n). Here W represents a maximum horizontal index in a current tile, slice or picture.

When the CTU has a size of 256×256, two top rows of CTUs may require an additional memory. In order to prevent the IBC from occupying the additional memory, the reference region is adjusted, as shown in FIG. 11. In FIG. 11, a box represents a CTU, a box padded with vertical lines represents a CTU where the current block is located, and boxes padded with oblique lines represent its reference region.

A range of performing BV search (or local search) for each block is limited to [−(C<<1), C>>2] in the horizontal direction and [−C, C>>2] in the vertical direction, to adapt to extension of the reference region, here C represents size of the CTU.

### (ii) Chroma Component:

In an IBC mode of the chroma component, a chroma BV may be derived based on a luma BV, and then prediction and reconstruction may be achieved according to the chroma BV. A process of deriving the chroma BV based on the luma BV is as follows.

Input: bvL of luma ( 1/16 sample precision);

Output: bvC of chroma ( 1/32 sample precision).

The derivation process may be directly scaling, or scaling and then refining by TM.

As to the scaling operation, an example thereof is as follows:

$$bvC [ 0 ] = ( ( bvL [ 0 ] >> ( 3 + SubWidthC ) ) * 32 ) ;$$

$$bvC [ 1 ] = ( ( bvL [ 1 ] >> ( 3 + SubHeightC ) ) * 32 ) .$$

Variables SubWidthC and SubHeightC specifically depend on a chroma format sampling structure specified by sps_chroma_format_idc, and specific correspondences refer to the foregoing Table 1.

The refining operation may include the following manners.

After refining by TM, that is, obtaining the luma BV, an offset position is found by using position of a chroma block and the BV, a fine search is performed near the offset position by using a template, and an optimal BV (that is, a refined BV) is obtained with a minimum TM cost as a standard, as shown in FIG. 12.

In operation S2204, a linear filter model is established.

It should be noted that the linear filter model may be established by using the best matching template and the template of the current CB obtained by searching in the previous operation, which mainly includes the following two processes: determining a reconstructed region for calculating filter coefficients, and calculating the filter coefficients.

It should also be noted that a number of taps of the filter is defined as nTap. nTap may be a constant or a variable, for example, the number of taps of the filter may be dynamically adjusted according to a block size. In the embodiment of the disclosure, multiple shapes of filters may be selected. Exemplarily, a fixed shape of filter shown in FIG. 19 may be selected, therefore the number of taps of the filter, nTap is 5.

(a) A reconstructed region for calculating filter coefficients is determined.

It should be noted that available reconstructed samples are determined according to the template type refTemplateType. For example, when the template type refTemplateType is 1, as shown in FIG. 17, it indicates that left, top-left and top neighboring reconstructed samples are available, a number of available reconstructed samples at the left side is templateW_size*nTbH, a number of available reconstructed samples at the top side is templateH_size*nTbW, and a number of available reconstructed samples at the top-left side is templateW_size*templateH_size.

It should also be noted that boundary samples are padded. Considering that reconstructed samples outside the reference template and the reference block may be used by the filter, it needs to pad boundary samples. Regions required to be padded at the boundaries are different according to different shapes of filters. A type of boundary padding region is shown in FIG. 18A, another type of boundary padding region is shown in FIG. 18B, here grid regions are regions required to be padded.

In the embodiment of the disclosure, there are also multiple different methods for padding, which include, but are not limited to the following padding manners.

A padding manner is to determine whether the grid regions are available. If the grid regions are available, the reconstructed samples are directly used; if the grid regions are unavailable, the grid regions are padded by copying reconstructed samples of the neighboring reference template or reference block.

Another padding manner is to pad the grid regions by directly copying reconstructed samples of the neighboring reference template or reference block.

Or, yet another padding manner is that it may abandon using corresponding data to participate in calculation when boundary positions are encountered, without padding them.

In the embodiment of the disclosure, detection of availability includes, but is not limited to one or more of the following conditions:
the sample at this position has been reconstructed;
this position does not exceed the MV/BV search range;
this position does not exceed boundaries of a picture;
this position does not exceed boundaries of a tile.

In this way, after determining the number of available reconstructed samples, a reconstructed region for calculating filter coefficients is determined according to the available reconstructed samples, this region is referred to as R, and R usually includes all available reconstructed samples in the template. For example, when refTemplateType is 1, R includes all available reconstructed samples at left, top-left and top sides.

(b) The filter coefficients are calculated.

After determining the reconstructed region R for calculating the filter coefficients, a group of filter coefficients may be derived by minimizing MSE between reconstructed samples in the region R and reconstructed samples in the template of the current CB, that is:

$$M S E = E [ {( predTemp [ i ] [ j ] - recTemp [ i ] [ j ] )}^{2} ] = E [ {( {\sum }_{k , l = - 1 ∼ 1} {c}_{k , l} \cdot refTemp [ i + k ] [ j + l ] - recTemp [ i ] [ j ] )}^{2} ] .$$

Here refTemp[i][j] represents an input reconstructed sample value, recTemp[i][j] represents a reconstructed sample value of the template of the current CB, (i, j) represents a coordinate position, here (i, j)∈R, k, l represent coordinate offsets of a filter coefficient position relative to a center position of the filter. Taking FIG. 11 as an example, k, l are between −1 and 1, and values of (k, l) may include (0, 0), (0, −1), (−1, 0), (0, 1), (1, 0), c_{k,l} represents a required filter coefficient. E represents an operation of calculating an average value. The calculation formula is as follows:

$$M S E = \frac{1}{{N}_{pos}} {\sum }_{i} {\sum }_{j} {\vert predTemp [ i ] [ j ] - recTemp [ i ] [ j ] \vert}^{2} ;$$

Here Nₚₒₛ refers to a number of (i, j) pairs participating in calculation of |predTemp[i][j]−recTemp[i][j]|².

A process of deriving the filter coefficients by minimizing MSE is specifically as follows.

1) First, a partial derivative of c_{k,l} is calculated and is set to 0, that is:

$$\frac{\partial M S E}{\partial {c}_{m}} = E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] ,$$

m, n are between −1 and 1.

$$E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] = 0 ,$$

the following formula may be obtained by organizing the above formulas:

$${\sum }_{k , l = - 1 ∼ 1} {c}_{k , l} \cdot E ( refTemp [ i + k ] [ j + l ] \cdot refTemp [ i + m ] [ j + n ] )$$

$$= E ( recTemp [ i ] [ j ] \cdot refTemp [ i + m ] [ j + n ] ) .$$

2) After determining the reconstructed region R, the equation obtained in operation 1) is expanded into a matrix form, as follows:

$$\text{?}$$

$$[ \begin{matrix}{c}_{0 , 0} \\ {c}_{- 1 , 0} \\ ⋮ \\ {c}_{0 , 1}\end{matrix} ] = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j ] + 1 )\end{matrix} ] .$$

$$\text{?} \text{indicates text missing or illegible when filed}$$

3) An autocorrelation matrix of refTemp in the reconstructed region R and cross-correlation vectors of refTemp and recTemp of 2) are known quantities, and the filter coefficients c_{k,l} may be calculated by solving a set of equations of 2). The filter coefficients c_{k,l} may be implemented by fixed-points, or may not be implemented by fixed-points, which is not specifically limited here.

That is, in a process of solving the set of linear equations, the autocorrelation matrix of the reconstructed sample refTemp in the reconstructed region R is calculated first, and then cross-correlation vectors of refTemp and the reconstructed sample recTemp of the current template are calculated. Then, Cholesky decomposition or LDL decomposition is performed on the autocorrelation matrix. Finally, each filter coefficient cₙ is sequentially calculated in a reverse recursion manner, this group of filter coefficients may be implemented by fixed-points, or may not be implemented by fixed-points.

In operation S2205, prediction values are generated.

It should be noted that as to each current block to be encoded, a group of filter coefficients may be acquired in the above manners, and this group of filter coefficients are c₀, c₁, c₂ . . . c_{nTap-1}. Then, the best matching reconstructed block is filtered according to the filter shape and the filter coefficients, that is, the filter coefficients and reference samples at corresponding positions are weighted and summed to obtain current to-be-predicted samples. ref is recorded as the best matching reconstructed block and is defined as follows:

$$ref [ i ] [ j ] = recSamples [ i + pX\_BEST ] [ j + pY\_BEST ] .$$

Here i=0, . . . , nTbW−1, j=0, . . . , nTbH−1, recSamples are reconstructed samples of the current picture, and pX_BEST and pY_BEST are horizontal and vertical components of the optimal BV respectively.

A specific calculation process of prediction values is as follows.

Assuming that the number of taps of the filter, nTap is 5, the shape of the filter is shown in FIG. 20A, c₀ to c₄ are tap coefficients of the filter respectively, here a dot padded in a grid corresponding to the tap coefficient C₀ are a reconstructed sample ref[i][j] at a corresponding position of a current to-be-predicted sample Y^{pred}[i][j] in the best matching block, and remaining dots padded in white are reconstructed samples neighboring to a current spatial position in the best matching block. A dot padded in black in FIG. 20B is an obtained prediction sample Y^{pred}[i][j].

As to each current to-be-predicted sample (i, j), sample position in the filter template is defined as (k, l), then a corresponding reconstructed sample in the best matching block during filtering is defined as ref[i+k][j+1], and each filter coefficient at the position (k, l) in the filter template is defined as c_{k,l}:

$${c}_{k , l} = {c}_{n} ; here n = 0 , … , nTap - 1 , k and l are between - 1 and 1.$$

$$For i = 0 , … , nTbW - 1 , j = 0 , … , nTbH - 1 , {Y}^{pred} [ i ] [ j ] = {\sum }_{k} {\sum }_{l} ref [ i + k ] [ j + l ] \times {C}_{, k , l} .$$

The final prediction samples are: predSamples[i][j]=Clip3(0,(1<<BitDepth)−1, Y^{pred}[i][j]).

$$Here , Clip 3 ( x , y , z ) = \{ \begin{matrix}x ; & z < x \\ y ; & z > y \\ z ; & otherwise\end{matrix} .$$

Simply speaking, the embodiment of the disclosure proposes an IBC-FLM technology, in which a linear filter model is established by using template information of the matching template and the current CB, correlation between the matching template and template of the current CB is fully utilized, samples of the best matching reconstructed block are filtered and corrected, and the filtered reconstructed samples are used as prediction samples, which improves prediction accuracy to a certain extent and effectively solves a problem that linear variation is present between the best matching reconstructed block and the current CB.

Further, in the embodiment of the disclosure, a linear filter model is established between the best matching template obtained by search and template of the current CB, the filter coefficients are calculated by minimizing MSE between a predicted template (the predicted template=the filter coefficients×the matching template) and template of the current CB, the best matching reconstructed block is filtered and corrected, and the filtered reconstructed samples are used as the final prediction samples.

Input information for calculating the filter coefficients may be that the input information for calculating the filter coefficients are the available reconstructed samples in the matching template. Furthermore, gradients (including, but not limited to a horizontal gradient, a vertical gradient, etc.) of each reconstructed sample in the matching template may also be calculated, and the calculated gradients are used as the input information for calculating the filter coefficients. Furthermore, position information of each sample may also be used as the input information for calculating the filter coefficients, and the position information may be information of an absolute position of each sample in the entire picture, or may be information of a relative position of each sample relative to a certain reference point.

Further, in the embodiment of the disclosure, as to calculation of the filter coefficients, the filter coefficients finally calculated as above are tap coefficients corresponding to the filter template, that is, the number of the filter coefficients is equal to the number of taps of the filter template, nTap. Furthermore, several biases may be added to the filter template.

For example, in the main solution, when nTap=5, the filter coefficients are tap coefficients c₀ to c₄ corresponding to the filter template at this time, and a prediction value at a position (i, j) is calculated as follows:

$${Y}^{pred} [ i ] [ j ] = {\sum }_{n = 0}^{4} ref [ k ] [ l ] \times {C}_{n} .$$

At this time, a bias may be added, specifically:

$${Y}^{pred} [ i ] [ j ] = {\sum }_{n = 0}^{4} ref [ k ] [ l ] \times {C}_{n} + {C}_{5} \times Constant .$$

Here, cₙ=c_{i,j,k,l}. Here Constant may be a fixed constant, such as Constant=1<<(BitDepth−1); or, Constant may be a number related to a reconstructed sample value at the position (i, j) of the reference block, such as Constant=f(ref[i][j]); or, Constant may be a number related to a reconstructed sample value corresponding to a certain tap in the filter template except the (i, j) position, such as Constant=f(ref[k][l]). Constant=f(ref[i][j]) or Constant=f(ref[k][l]) may be a linear mapping relationship or a non-linear mapping relationship. One or more biases may be added.

Further, in the embodiment of the disclosure, as to a number of filter models, it may be that only one linear filter model is established, or multiple linear filter models are established. Exemplarily, input information for calculating the filter coefficients is classified, and a filter model is established for each category of input information respectively. For example, when the model is established by using reconstruction information, an implementable manner is to classify by an average value of the reconstruction information, to establish a model for reconstruction information greater than the average value, and establish a model for reconstruction information less than the average value.

Another implementable manner is to classify by positions of the reconstruction information, for example, a model may be established by using available reconstruction information at left and top sides, a second model may be established by using available reconstruction information at left and top-left sides, or the like, and usage of which model is determined at the encoding side. An implementable decision-making manner is that usage of which model is determined at the encoding side in a RDO manner, and a corresponding flag is transmitted by the encoding side to the decoding side.

Another implementable manner is to classify by the shape of the filter, multiple different shapes of filters may be used, a filter model is established for each shape of filter, and usage of which shape of filter is determined at the encoding side. An implementable decision-making manner is that usage of which filter is determined at the encoding side in a RDO manner, and a corresponding flag is transmitted by the encoding side to the decoding side.

Further, in the embodiment of the disclosure, with respect to types of filter models, a linear filter model may be established for filtering, or a non-linear filter model may be established for filtering, which is not specifically limited here.

Exemplarily, an implementable manner is to introduce quadratic terms to establish a non-linear filter model. For example, when MSE of the filter coefficients is minimized, the calculation method is modified as shown below:

$$M S E = E {( predTemp [ i ] [ j ] - recTemp [ i ] [ j ] )}^{2} ]$$

$$= E [ {( {\sum }_{k , l = - 1 ∼ 1} {c}_{k , l} \cdot {( refTemp [ i + k ] [ j + l ] )}^{2} - recTemp [ i ] [ j ] )}^{2} ] .$$

Furthermore, as to calculation of the prediction value, the calculation method may be modified as: Y^{pred}[i][j]=Σₖ Σₗ(ref[i+k][j+l])²×C_{k,l}.

Further, in the embodiment of the disclosure, as to the part of calculating the prediction value, whether the current block uses the filtered prediction value as the final prediction value may be determined by certain conditions. For example, there are the following manners (i) to (iii).

(i) Whether the matching template is filtered is determined by comparing a distortion between the matching template and template of the current CB, such as SAD, MSE, SATD, SSE or the like with a threshold T_Distortion1.

(ii) Based on that (i) is met and the filter model is used, whether the reference block is filtered is determined by comparing a distortion between the filtered matching template and template of the current CB, such as SAD, MSE, SATD, SSE or the like with a threshold T_Distortion2.

(iii) The encoding side transmits a flag to indicate whether the filter model is applied. ibcFlag indicates whether the IBC is applied to the current CB, and filterFlag indicates whether the filter model is applied to the current CB. When ibcFlag is 1, whether the reference block is filtered is determined at the encoding side by comparing distortions between the reference block before and after filtering and an original block, such as SAD, MSE, SATD or SSE. If the distortion after filtering is less than the distortion before filtering, filterFlag is 1, and the current CB uses the filtered reference block as the prediction block; otherwise, filterFlag is 0, and the current CB uses the reference block before filtering as the prediction block. filterFlag is transmitted by the encoding side to the decoding side.

Further, in the embodiment of the disclosure, as to the reference block to which the filter coefficients are applied, the filter coefficients are calculated for the best matching template after the search completes, and the filter coefficients are applied to the best matching reference block; furthermore, the filter coefficients may also be applied to all or part of reference blocks in the search region, and which filtered reference block is used as the final prediction block is determined by certain conditions. For example, there are the following manners (i) to (ii).

(i) The filter coefficients are solved for templates in the search range and used for filtering, and their costs with the current template are calculated to determine which template is used, that is, the filter coefficients are calculated for part or all of to-be-searched templates in the search range, then the filter coefficients are applied to the to-be-searched templates, costs of the templates with the current template are calculated, a filtered best matching template is selected according to the costs, and the reference block corresponding to the best matching template is filtered and used as the final prediction value.

(ii) The encoding side transmits a flag to indicate which filtered reference block is used as the final prediction block. tmpFlag indicates whether TM is applied to the current CB, and filterIdx indicates whether the filter model is applied to which reference block in a current search range. When tmpFlag is 1, an optimal reference block is selected at the encoding side by comparing distortions between reference blocks to which the filter coefficients are applied in the search range and a current original block, such as SAD, MSE, SATD or SSE, and a corresponding index is transmitted by the encoding side to the decoding side.

Further, in the embodiment of the disclosure, determination of availability may also be that “samples in the template” are replaced by “identified samples in the template”; and “samples in the reconstructed block corresponding to the template” are replaced by “identified samples in the reconstructed block corresponding to the template”.

The identified samples in the template refer to one or more samples located at a corner position of the template region, such as samples at a top-left corner and a bottom-right corner of a top template region when there is only a top template, or only samples at the bottom-right corner of the top template region.

The identified samples in the reconstructed block corresponding to the template refer to one or more samples located at a corner position of the reconstructed block region, such as samples at a top-left corner and a bottom-right corner of the reconstructed block region, or only samples at the bottom-right corner of the reconstructed block region.

That is, in the embodiment of the disclosure, considering that the filter may us reconstructed samples outside the reference template and the reference block, it needs to pad boundary samples. A boundary padding implementation is shown in FIG. 18A and FIG. 18B, here grid regions are regions required to be padded.

In an embodiment, a padding manner is to determine whether samples in the grid regions are available, one by one. If the samples are available, the reconstructed samples are directly used; if the samples are unavailable, the grid regions are padded by copying reconstructed samples of a nearest reference template or reference block.

A method for determining whether the samples are available includes, but is not limited to meeting one or more of the following conditions:
the samples are within boundaries of a picture;
the samples are within boundaries of a tile; or
the samples have been reconstructed.

In some embodiments, a padding manner is to determine whether positions of the padding regions exceed a BV search range, according to the BV search range. If the positions of the padding regions do not exceed the search range, the reconstructed samples are directly used; if the positions of the padding regions exceed the search range, the grid regions are padded by copying reconstructed samples of a neighboring reference template or reference block. Specifically, whether boundaries need to be padded is determined according to the derived iVerMin, iVerMax, iHorMin and iHorMax.

leftPadding, rightPadding, topPadding and bottomPadding indicate whether a left grid region, a right grid region, a top grid region and a bottom grid region copy nearest reconstructed samples, that is:

$$leftPadding = ! ( pX\_Best > iHorMin ) ;$$

$$rightPadding = ! ( pX\_Best < iHorMax ) ;$$

$$topPadding = ! ( pY\_Best > iVerMin ) ;$$

$$bottomPadding = ! ( pY\_Best < iverMax ) .$$

Here, if leftPadding is true, it means that samples in the left grid region exceed the BV search range, and reconstructed samples of a nearest neighboring reference template are copied; otherwise, reconstructed samples at this position are directly used. If rightPadding is true, it means that samples in the right grid region exceed the BV search range, and reconstructed samples of a nearest neighboring reference template or reference block are copied; otherwise, reconstructed samples at this position are directly used. If topPadding is true, it means that samples in the top grid region exceed the BV search range, and reconstructed samples of a nearest neighboring reference template are copied; otherwise, reconstructed samples at this position are directly used. If bottomPadding is true, it means that samples in the bottom grid region exceed the BV search range, and reconstructed samples of a neighboring reference template or reference block are copied; otherwise, reconstructed samples at this position are directly used.

Further, in the embodiment of the disclosure, this technical solution may be implemented in combination with various sub-modes in the IBC, which include, but are not limited to ordinary IBC merge, IBC TM merge, MBVD, IBC CIIP, IBC ABVP or the like, which is not specifically limited.

In a possible implementation, there may also be an acquisition method in which a predicted region needs to be flipped horizontally or vertically in an IBC flip mode, to be used as a prediction value. For example, whether to flip is represented by a syntax element, and if so, whether to flip horizontally or vertically is represented by the syntax element. At the decoding side, samples of the reference region are reversely rearranged in the horizontal or vertical direction according to indication of the syntax, to acquire a prediction sample value of the CB.

In another possible implementation, a model between the current block and the predicted region may also be established by using a template, and the prediction block is processed based on the model, to obtain the prediction value of the current block. For example, an IBC LIC mode is applied to the IBC merge and the IBC ABVP, to compensate for local illumination variation by using a linear equation. Similar to LIC of inter prediction of VVC, parameters of the linear equation may be represented by a scaling parameter α and an offset parameter β, that is, α*p[x]+β, to compensate for illumination variation, here p[x] is a reference sample pointed to by position x of the BV on the current picture. Parameters of the linear model are derived by a least square method.

In yet another possible implementation, Based on the above acquisition of the prediction value, a weighted prediction with other intra prediction manners may also be implemented, and a result after the weighted prediction is used as a final prediction result.

Manners of the weighted prediction include a manner based on CIIP of VVC, that is, at each sample position, performing a weighted combination on the result obtained by the above prediction process and a prediction result obtained by an ordinary intra directional prediction mode; further include a manner based on inter GPM of VVC, that is, using a wedge division as a basis, using results obtained by different prediction modes in different wedge regions, and performing weighted mixing complying with a certain rule near wedge division lines.

An example of operation processes in an IBC CIIP mode is as follows. A weighted fusion is performed on an IBC prediction value of the current block and a prediction value of a certain intra mode, and an IBC prediction part may be obtained by applying conventional merge, TM merge, MBVD and ABVP modes.

In case that the IBC prediction part is conventional IBC merge, TM merge and MBVD modes, a ratio of weights of IBC prediction and intra prediction is 13:3. The intra mode includes a TIMD mode of the current block and IPM at a candidate BV. If a second prediction mode in the intra mode is the same as a first prediction mode in the intra mode, it is determined whether the first prediction mode is a PLANAR mode. If so, the second prediction mode is replaced by a horizontal prediction mode; otherwise, the second prediction mode is replaced by the PLANAR mode.

In case that the IBC prediction part is the ABVP mode, a ratio of weights of IBC prediction and intra prediction is 1:1, and a first prediction mode where the TIMD mode is IPM is acquired. If the derived prediction mode is the horizontal prediction mode, a second prediction mode where PLANAR is IPM is acquired; otherwise, a second prediction mode where the horizontal prediction mode is IPM is acquired.

An example of operation processes in an IBC GPM mode is as follows. Conventional merge and TM merge may be applied to the IBC prediction part. Only a mode where a partition is IBC and a partition is INTRA is provided, an IPM candidate list is constructed by using the same method as the inter GPM, and a size of the IPM candidate list is predefined as 3. In a specific implementation, there are 48 GPMs in total, which may be divided into two GPM sets. Table 2 is a first GPM set, and Table 3 is a second GPM set.

When the IBC GPM is used, a flag of a GPM set of the IBC GPM is transmitted to indicate whether the first GMP set or the second GMP set is selected, and then a GPM index is transmitted; then an IBC-GPM intra partition flag is transmitted to indicate whether the intra prediction is used for a first sub-partition. An intra prediction part needs to transmit an IPM index, and the IBC prediction part needs to transmit a MEGRE index.

Further, in the embodiment of the disclosure, a relevant mode selection flag (ibcFilterFlag) is transmitted at a CU layer. Manners of encoding ibcFilterFlag may be implemented in multiple manners. An implementable manner is to use equal-probability encoding; another implementable manner is to use context encoding, default context initial state and context update rate may be used, or context initial state and context update rate may be determined by statistics, which is not specifically limited, either.

In the embodiment of the disclosure, the prediction value of the IBC technology may be effectively corrected, thereby improving prediction accuracy. Specifically, a linear filter model is established between the best matching template obtained by search and template of the current CB, the filter coefficients are calculated by minimizing MSE between a predicted template (the predicted template=the filter coefficients×the matching template) and template of the current CB. The filter coefficients fully reflect correlation between the matching template and template of the current CB, this correlation is applied to the best matching reconstructed block, reconstructed samples of the best matching reconstructed block are filtered and corrected, and the filtered reconstructed samples are used as the final prediction samples, which improves prediction accuracy to a certain extent.

In yet another embodiment of the disclosure, based on the same inventive concept as the foregoing embodiments, with reference to FIG. 23, a schematic diagram of compositional structures of an encoder provided in an embodiment of the disclosure is shown. As shown in FIG. 23, the encoder 230 may include a first determination unit 2301, a first filtering unit 2302, and a first prediction unit 2303.

The first determination unit 2301 is configured to: determine a first template of a current block, and determine a BV candidate list of the current block; determine a first BV according to the BV candidate list; and determine a matching template and a reference block corresponding to the matching template according to the first BV.

The first filtering unit 2302 is configured to determine model parameters according to the first template and the matching template, filter the reference block according to the model parameters, and determine a filtered reference block.

The first prediction unit 2303 is configured to determine a prediction value of the current block according to the filtered reference block.

In some embodiments, the first determination unit 2301 is further configured to: determine a template type of the current block; and determine the first template of the current block according to the template type of the current block.

In some embodiments, the first determination unit 2301 is further configured to determine the template type of the current block according to reference samples of the current block. The reference samples of the current block include at least one of a left neighboring reference sample of the current block, a top neighboring reference sample of the current block, or a top-left neighboring reference sample of the current block.

In some embodiments, the first determination unit 2301 is further configured to: if both the left neighboring reference sample of the current block and the top neighboring reference sample of the current block are available, encode the template type of the current block, and signal obtained encoded bits into a bitstream.

In some embodiments, the first determination unit 2301 is further configured to: determine at least one first candidate BV neighboring to the current block, based on a derivation manner of spatial BV candidates; add the at least one first candidate BV to the BV candidate list; and if a number of candidates in the BV candidate list meets a preset threshold, use a current BV candidate list as the BV candidate list of the current block.

In some embodiments, the first determination unit 2301 is further configured to: if the number of candidates in the BV candidate list does not meet the preset threshold, determine at least one second candidate BV based on a derivation manner of history-based BV candidates, and continuously add the at least one second candidate BV to the BV candidate list; and if the number of candidates in the BV candidate list meets the preset threshold, use the current BV candidate list as the BV candidate list of the current block.

In some embodiments, the first determination unit 2301 is further configured to: if the number of candidates in the BV candidate list does not meet the preset threshold, determine at least one third candidate BV based on derivation manners of other available candidates, and continuously add the at least one third candidate BV to the BV candidate list, until the number of candidates in the BV candidate list meets the preset threshold.

In some embodiments, the derivation manners of other available candidates include at least one of a derivation manner of pairwise average candidates, a derivation manner of zero-value BV candidates, or a derivation manner of candidates in a reference region corresponding to IBC.

In some embodiments, the first determination unit 2301 is further configured to: after determining the BV candidate list of the current block, sort the BV candidate list.

In some embodiments, the first determination unit 2301 is further configured to: after determining the BV candidate list of the current block, remove redundancy according to a distance between candidate BVs in the BV candidate list.

In some embodiments, the first determination unit 2301 is further configured to: if a non-flip IBC mode is selected for the current block, delete at least one of at least two candidate BVs in the BV candidate list when a distance between the at least two candidate BVs meets a preset condition.

In some embodiments, the first determination unit 2301 is further configured to: perform a cost calculation on at least two candidate BVs in the BV candidate list, to determine costs of each of the at least two candidate BVs; and determine a minimum cost according to the costs of each of the at least two candidate BVs, and use a candidate BV corresponding to the minimum cost as the first BV.

In some embodiments, as shown in FIG. 23, the encoder 230 may further include an encoding unit 2304.

The first determination unit 2301 is further configured to determine a BV index number corresponding to the first BV, according to the BV candidate list.

The encoding unit 2304 is configured to encode the BV index number, and signal obtained encoded bits into a bitstream.

In some embodiments, the first determination unit 2301 is further configured to: determine a BV index number corresponding to the first BV, according to the BV candidate list; and determine a BVD value according to an initial BV of the current block and the first BV.

The encoding unit 2304 is further configured to encode the BV index number and the BVD value, and signal obtained encoded bits into a bitstream.

In some embodiments, the first BV is a luma BV, and the luma BV is configured to determine a luma component-based prediction value of the current block.

In some embodiments, the first determination unit 2301 is further configured to scale the luma BV according to a preset chroma sampling format, to determine a chroma BV. The chroma BV is configured to determine a chroma component-based prediction value of the current block.

In some embodiments, the first determination unit 2301 is further configured to: scale the luma BV according to a preset chroma sampling format, to determine a scaled BV; and refine the scaled BV to determine a chroma BV. The chroma BV is configured to determine a chroma component-based prediction value of the current block.

In some embodiments, the first determination unit 2301 is further configured to: determine a reference template and the corresponding reference block according to the first BV; and if the reference template meets a first preset condition, perform first processing on a neighboring region of the reference template, to determine the matching template.

In some embodiments, the first determination unit 2301 is further configured to: determine a reference template and the corresponding reference block according to the first BV; and if the reference template meets a second preset condition, use the reference template as the matching template.

In some embodiments, the matching template includes samples in the reference template and samples in a neighboring region of the reference template.

In some embodiments, the first determination unit 2301 is further configured to: if samples outside the reference template and the reference block are used, determine that the reference template meets the first preset condition.

In some embodiments, the first determination unit 2301 is further configured to: if samples outside the reference template and the reference block are not used, determine that the reference template meets the second preset condition.

In some embodiments, the first determination unit 2301 is further configured to: if the samples outside the reference template and the reference block are used, perform padding processing on samples in the neighboring region of the reference template.

In some embodiments, the first determination unit 2301 is further configured to: determine whether the samples in the neighboring region of the reference template are available; if the samples in the neighboring region of the reference template are available, directly use the samples in the neighboring region of the reference template; and if the samples in the neighboring region of the reference template are unavailable, perform padding processing on the neighboring region of the reference template by copying reconstructed samples in neighboring reference templates or neighboring reference blocks of the samples, to obtain the samples in the neighboring region of the reference template.

In some embodiments, the first determination unit 2301 is further configured to: perform padding processing on the neighboring region of the reference template by directly copying reconstructed samples in neighboring reference templates or neighboring reference blocks of the samples, to obtain the samples in the neighboring region of the reference template.

In some embodiments, the first determination unit 2301 is further configured to: if the samples outside the reference template and the reference block are used, not perform padding processing on samples in the neighboring region of the reference template, and skip the samples when the model parameters are determined.

In some embodiments, the samples in the neighboring region of the reference template being available includes at least one of:
the samples do not exceed a preset search range;
the samples do not exceed boundaries of a picture;
the samples do not exceed boundaries of a tile; or
the samples have been reconstructed.

In some embodiments, the first determination unit 2301 is further configured to: if samples in a neighboring region of the reference block are used, perform padding processing on the samples in the neighboring region of the reference block.

In some embodiments, the model parameters include coefficients of a target filter.

In some embodiments, the first determination unit 2301 is further configured to determine the coefficients of the target filter according to sample reference values in the first template and sample reference values in the matching template.

In some embodiments, the first determination unit 2301 is further configured to set the coefficients of the target filter to be coefficients used by the target filter when a first error between output values after processing the sample reference values in the matching template by the target filter and the sample reference values in the first template meets a first condition.

In some embodiments, the first condition is that the first error is minimum.

In some embodiments, the first condition is that the first error is within a first preset threshold range.

In some embodiments, the first condition is that variation of the first error is within a second preset threshold range.

In some embodiments, the first determination unit 2301 is further configured to: determine autocorrelation parameters according to the sample reference values in the matching template; determine cross-correlation parameters according to the sample reference values in the first template and the sample reference values in the matching template; and determine the coefficients of the target filter according to the autocorrelation parameters and the cross-correlation parameters.

In some embodiments, the sample reference values include at least one of a reconstructed sample value, a sample gradient value, or sample position information.

In some embodiments, a number of the coefficients of the target filter is equal to a first preset value.

In some embodiments, the first determination unit 2301 is further configured to determine a number of the coefficients of the target filter.

The encoding unit 2304 is further configured to encode the number of the coefficients of the target filter, and signal obtained encoded bits into a bitstream.

In some embodiments, the target filter is a one-dimensional or two-dimensional filter with a preset shape.

In some embodiments, the first determination unit 2301 is further configured to determine a shape of the target filter. The CU is further configured to encode the shape of the target filter, and signal obtained encoded bits into a bitstream.

In some embodiments, the first filtering unit 2302 is further configured to: filter the reference block according to the model parameters, and determine a first output value of the target filter; and determine the filtered reference block based on the first output value of the target filter.

In some embodiments, the first filtering unit 2302 is further configured to: calculate a product of a reconstructed sample value of the reference block and a corresponding one of the coefficients of the target filter; and set the first output value of the target filter to be equal to a sum of n products, here n represents a number of the coefficients of the target filter, and n is a positive integer.

In some embodiments, the first filtering unit 2302 is further configured to: determine a first value of a reconstructed sample value of the reference block under a first mapping relationship; calculate a product of the first value and a corresponding one of the coefficients of the target filter; and set the first output value of the target filter to be equal to a sum of n products, here n represents a number of the coefficients of the target filter, and n is a positive integer.

In some embodiments, the first filtering unit 2302 is further configured to: determine a first offset value; and perform an addition operation according to the first output value and the first offset value, to determine the filtered reference block.

In some embodiments, the first determination unit 2301 is further configured to set the first offset value to be equal to a second preset value.

In some embodiments, the first determination unit 2301 is further configured to: determine a number of samples corresponding to the target filter and participating in filtering, based on a shape of the target filter; if the number of samples corresponding to the target filter and participating in filtering is m, determine (m+1) coefficients of the target filter, here m is a positive integer; and determine the first offset value according to a second offset value and one of the (m+1) coefficients.

In some embodiments, the first determination unit 2301 is further configured to: set the second offset value to be equal to a third preset value; or, set the second offset value to be equal to a value of a reconstructed sample value of the reference block under a second mapping relationship.

In some embodiments, the first prediction unit 2303 is further configured to perform second processing on the filtered reference block, to obtain the prediction value of the current block.

In some embodiments, the second processing is that the prediction value of the current block is set to be equal to the filtered reference block.

In some embodiments, the second processing is a clip operation that limits the filtered reference block within a preset numerical range.

In some embodiments, the first determination unit 2301 is further configured to: determine multiple groups of model parameters according to the first template and the matching template; construct multiple filter models according to the multiple groups of model parameters, filter the reference block according to the multiple filter models respectively, and determine multiple filtered reference blocks; and determine the prediction value of the current block according to the multiple filtered reference blocks.

In some embodiments, the first prediction unit 2303 is further configured to perform a weighted calculation on the multiple filtered reference blocks, to determine the prediction value of the current block.

In some embodiments, the first determination unit 2301 is further configured to determine a target filter from the multiple filter models.

The first prediction unit 2303 is further configured to filter the reference block according to the target filter, and determine the prediction value of the current block.

In some embodiments, the first determination unit 2301 is further configured to determine a target model index value. The target model index value indicates an index number of the target filter in the multiple filter models.

The encoding unit 2304 is further configured to encode the target model index value, and signal obtained encoded bits into a bitstream.

In some embodiments, the first determination unit 2301 is further configured to: determine an original value of the current block; perform cost calculations respectively according to the original value of the current block and multiple initial prediction values of the current block, to determine costs of each of the multiple initial prediction values; determine a minimum cost from the costs of each of the multiple initial prediction values; and use a filter model corresponding to the minimum cost as the target filter.

In some embodiments, the first determination unit 2301 is further configured to: classify reconstructed samples in the first template and the matching template respectively according to a preset manner, to obtain multiple groups of sub-templates and multiple groups of sub-matching templates; and determine the multiple groups of model parameters according to the multiple groups of sub-templates and the multiple groups of sub-matching templates.

In some embodiments, the first determination unit 2301 is further configured to determine a value of first syntax element identification information. The first syntax element identification information indicates whether IBC is applied to the current block.

The encoding unit 2304 is further configured to encode the value of the first syntax element identification information, and signal obtained encoded bits into a bitstream.

In some embodiments, the first determination unit 2301 is further configured to: if the IBC is applied to the current block, determine the value of the first syntax element identification information as a first value; or, if the IBC is not applied to the current block, determine the value of the first syntax element identification information as a second value.

In some embodiments, the first determination unit 2301 is further configured to determine a value of second syntax element identification information. The second syntax element identification information indicates whether a filter model is applied to the current block.

The encoding unit 2304 is further configured to encode the value of the second syntax element identification information, and signal obtained encoded bits into a bitstream.

In some embodiments, the first determination unit 2301 is further configured to: if the filter model is applied to the current block, determine the value of the second syntax element identification information as a first value; or, if the filter model is not applied to the current block, determine the value of the second syntax element identification information as a second value.

In some embodiments, the first determination unit 2301 is further configured to: if the filter model is applied to the current block, perform operations of filtering the reference block according to the model parameters, and determining the filtered reference block; and determining the prediction value of the current block according to the filtered reference block; and if the filter model is not applied to the current block, use a reconstructed sample value in the reference block as the prediction value of the current block.

In some embodiments, the first determination unit 2301 is further configured to: determine multiple reference blocks in a second search region and model parameters of each of the multiple reference blocks; filter the multiple reference blocks respectively according to the model parameters of each of the multiple reference blocks, and determine multiple filtered reference blocks; perform cost calculations between the multiple filtered reference blocks and the current block respectively, to determine costs of each of the multiple filtered reference blocks; and determine a minimum cost from the costs of each of the multiple filtered reference blocks, and determine the filtered reference block and a reference block index number corresponding the filtered reference block according to the minimum cost.

The encoding unit 2304 is further configured to encode the reference block index number, and signal obtained encoded bits into a bitstream.

In some embodiments, the first determination unit 2301 is further configured to: determine an original value of the current block; and determine a prediction residual of the current block according to the original value of the current block and the prediction value of the current block.

It may be understood that in the embodiment of the disclosure, the “unit” may be a part of a circuit, a part of a processor, a part of a program or software, etc. Of course, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the technical solution of the embodiment substantially, or parts making contributions to the related art, or all or part of the technical solution may be embodied in a form of software product, and the computer software product is stored in a storage medium, and includes several instructions configured to enable a computer device (which may be a personal computer, a server, a network device, etc.) or a processor to perform all or part of operations of the method described in the embodiment. The foregoing storage medium includes various media capable of storing program codes, such as a U disk, a mobile hard disk, a Read Only Memory (ROM), a Random Access Memory (RAM), a magnetic disk, or an optical disk, etc.

Therefore, an embodiment of the disclosure provides a computer-readable storage medium, the computer-readable storage medium is applied to the encoder 230. The computer-readable storage medium has stored thereon a computer program, and when the computer program is executed by a first processor, the method described in any one of the foregoing embodiments is implemented.

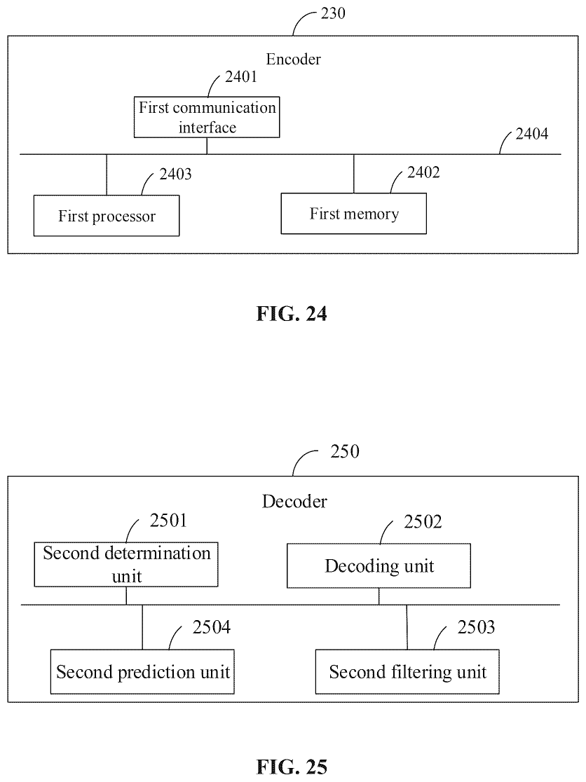

Based on compositions of the encoder 230 and the computer-readable storage medium, with reference to FIG. 24, a schematic diagram of specific hardware structures of the encoder 230 provided in an embodiment of the disclosure is shown. As shown in FIG. 24, the encoder 230 may include a first communication interface 2401, a first memory 2402 and a first processor 2403, various components are coupled together through a first bus system 2404. It may be understood that the first bus system 2404 is configured to achieve connection and communication between these components. The first bus system 2404 includes a power bus, a control bus and a status signal bus, besides a data bus. However, for the sake of clear explanations, various buses are marked as the first bus system 2404 in FIG. 24.

The first communication interface 2401 is configured to receive and send signals in a process of receiving/sending information from/to other external network elements.

The first memory 2402 is configured to store a computer program executable on the first processor 2403.

The first processor 2403 is configured to: when it executes the computer program, perform operations of:
determining a first template of a current block, and determining a BV candidate list of the current block;
determining a first BV according to the BV candidate list; determining a matching template and a reference block corresponding to the matching template according to the first BV;
determining model parameters according to the first template and the matching template, filtering the reference block according to the model parameters, and determining a filtered reference block; and determining a prediction value of the current block according to the filtered reference block.

It may be understood that the first memory 2402 in the embodiment of the disclosure may be a volatile memory or a non-volatile memory, or may include both volatile and non-volatile memories. The non-volatile memory may be a ROM, a Programmable ROM (PROM), an Erasable PROM (EPROM), an electrically EPROM (EEPROM), or a flash memory. The volatile memory may be a RAM, which is used as an external cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DR RAM). The first memory 2402 of the system and method described in the disclosure is intended to include, but is not limited to these memories and any other suitable types of memories.

The first processor 2403 may be an integrated circuit chip with a signal processing capability. During implementation, each operation of the above method may be completed by an integrated logical circuit in a form of hardware in the first processor 2403 or instructions in a form of software. The above first processor 2403 may be a general purpose processor, a Digital Signal Processor (DSP), an Application Specific Integrated Circuit (ASIC), a Field Programmable Gate Array (FPGA) or other programmable logical devices, a discrete gate or transistor logical device, a discrete hardware component, etc. Various methods, operations and logic block diagrams disclosed in the embodiments of the disclosure may be implemented or performed. The general purpose processor may be a microprocessor, or the processor may be any conventional processor, etc. Operations in the methods disclosed in combination with the embodiments of the disclosure may be directly embodied as being performed and completed by a hardware decoding processor, or performed and completed by a combination of hardware in the decoding processor and a software module. The software module may be located in a mature storage medium in this field such as a RAM, a flash memory, a ROM, a PROM or an EEPROM, a register, etc. The storage medium is located in the first memory 2402, and the first processor 2403 reads information in the first memory 2402, and completes the operations in the above methods in combination with the hardware thereof.

It may be understood that these embodiments described in the disclosure may be implemented by hardware, software, firmware, middleware, microcode or a combination thereof. As to implementation by hardware, the processing unit may be implemented in one or more ASICS, DSPs, DSP Devices (DSPDs), Programmable Logic Devices (PLDs), FPGAs, general purpose processors, controllers, microcontrollers, microprocessors, other electronic units configured to perform functions described in the disclosure, or combinations thereof. As to implementation by software, technologies described in the disclosure may be implemented by modules (such as processes, functions, etc.) performing the functions described in the disclosure. Software codes may be stored in a memory and executed by a processor. The memory may be implemented in or out of the processor.

Optionally, as another embodiment, the first processor 2403 is further configured to perform the method described in any one of the foregoing embodiments when it executes the computer program.

The embodiment provides an encoder, in which model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

In yet another embodiment of the disclosure, based on the same inventive concept as the foregoing embodiments, with reference to FIG. 25, a schematic diagram of compositional structures of a decoder provided in an embodiment of the disclosure is shown. As shown in FIG. 25, the decoder 250 may include a second determination unit 2501, a decoding unit 2502, a second filtering unit 2503, and a second prediction unit 2504.

The second determination unit 2501 is configured to determine a first template of a current block, and determine a BV candidate list of the current block.

The decoding unit 2502 is configured to decode a bitstream to determine BV indication information.

The second determination unit 2501 is further configured to determine a first BV according to the BV indication information and the BV candidate list, and determine a matching template and a reference block corresponding to the matching template according to the first BV.

The second filtering unit 2503 is configured to determine model parameters according to the first template and the matching template, filter the reference block according to the model parameters, and determine a filtered reference block.

The second prediction unit 2504 is configured to determine a prediction value of the current block according to the filtered reference block.

In some embodiments, the second determination unit 2501 is further configured to: determine a template type of the current block; and determine the first template of the current block according to the template type of the current block.

In some embodiments, the second determination unit 2501 is further configured to determine the template type of the current block according to reference samples of the current block. The reference samples of the current block include at least one of a left neighboring reference sample of the current block, a top neighboring reference sample of the current block, or a top-left neighboring reference sample of the current block.

In some embodiments, the second determination unit 2501 is further configured to: if both the left neighboring reference sample of the current block and the top neighboring reference sample of the current block are available, decode the bitstream to determine the template type of the current block.

In some embodiments, the second determination unit 2501 is further configured to: determine at least one first candidate BV neighboring to the current block, based on a derivation manner of spatial BV candidates; add the at least one first candidate BV to the BV candidate list; and if a number of candidates in the BV candidate list meets a preset threshold, use a current BV candidate list as the BV candidate list of the current block.

In some embodiments, the second determination unit 2501 is further configured to: if the number of candidates in the BV candidate list does not meet the preset threshold, determine at least one second candidate BV based on a derivation manner of history-based BV candidates, and continuously add the at least one second candidate BV to the BV candidate list; and if the number of candidates in the BV candidate list meets the preset threshold, use the current BV candidate list as the BV candidate list of the current block.

In some embodiments, the second determination unit 2501 is further configured to: if the number of candidates in the BV candidate list does not meet the preset threshold, determine at least one third candidate BV based on derivation manners of other available candidates, and continuously add the at least one third candidate BV to the BV candidate list, until the number of candidates in the BV candidate list meets the preset threshold.

In some embodiments, the derivation manners of other available candidates include at least one of a derivation manner of pairwise average candidates, a derivation manner of zero-value BV candidates, or a derivation manner of candidates in a reference region corresponding to IBC.

In some embodiments, the second determination unit 2501 is further configured to: after determining the BV candidate list of the current block, sort the BV candidate list.

In some embodiments, the second determination unit 2501 is further configured to: after determining the BV candidate list of the current block, remove redundancy according to a distance between candidate BVs in the BV candidate list.

In some embodiments, the second determination unit 2501 is further configured to: if a non-flip IBC mode is selected for the current block, delete at least one of at least two candidate BVs in the BV candidate list when a distance between the at least two candidate BVs meets a preset condition.

In some embodiments, the BV indication information includes a BV index number. The second determination unit 2501 is further configured to: determine, from the BV candidate list, a candidate BV corresponding to the BV index number; and use the candidate BV as the first BV.

In some embodiments, the BV indication information includes a BV index number and a BVD value. The second determination unit 2501 is further configured to: determine, from the BV candidate list, a candidate BV corresponding to the BV index number; and determine the first BV according to the candidate BV and the BVD value.

In some embodiments, the BV indication information includes a BV index number. The second determination unit 2501 is further configured to: determine, from the BV candidate list, a candidate BV corresponding to the BV index number; determine a first candidate set according to the candidate BV and predefined parameters; and perform a BV search within the first candidate set, to determine the first BV.

In some embodiments, the BV indication information includes a BV index number. The second determination unit 2501 is further configured to: determine, from the BV candidate list, a candidate BV corresponding to the BV index number; and determine a first search region centered on the candidate BV, and search in the first search region based on a template matching manner, to determine the first BV.

In some embodiments, the first BV is a luma BV, and the luma BV is configured to determine a luma component-based prediction value of the current block.

In some embodiments, the first BV is a luma BV. The second determination unit 2501 is further configured to scale the luma BV according to a preset chroma sampling format, to determine a chroma BV. The chroma BV is configured to determine a chroma component-based prediction value of the current block.

In some embodiments, the first BV is a luma BV. The second determination unit 2501 is further configured to: scale the luma BV according to a preset chroma sampling format, to determine a scaled BV; and refine the scaled BV to determine a chroma BV. The chroma BV is configured to determine a chroma component-based prediction value of the current block.

In some embodiments, the second determination unit 2501 is further configured to: determine a reference template and the corresponding reference block according to the first BV; and if the reference template meets a first preset condition, perform first processing on a neighboring region of the reference template, to determine the matching template.

In some embodiments, the second determination unit 2501 is further configured to: determine a reference template and the corresponding reference block according to the first BV; and if the reference template meets a second preset condition, use the reference template as the matching template.

In some embodiments, the matching template includes samples in the reference template and samples in a neighboring region of the reference template.

In some embodiments, the second determination unit 2501 is further configured to: if samples outside the reference template and the reference block are used, determine that the reference template meets the first preset condition.

In some embodiments, the second determination unit 2501 is further configured to: if samples outside the reference template and the reference block are not used, determine that the reference template meets the second preset condition.

In some embodiments, the second determination unit 2501 is further configured to: if the samples outside the reference template and the reference block are used, perform padding processing on samples in the neighboring region of the reference template.

In some embodiments, the second determination unit 2501 is further configured to: determine whether the samples in the neighboring region of the reference template are available; if the samples in the neighboring region of the reference template are available, directly use the samples in the neighboring region of the reference template; and if the samples in the neighboring region of the reference template are unavailable, perform padding processing on the neighboring region of the reference template by copying reconstructed samples in neighboring reference templates or neighboring reference blocks of the samples, to obtain the samples in the neighboring region of the reference template.

In some embodiments, the second determination unit 2501 is further configured to: perform padding processing on the neighboring region of the reference template by directly copying reconstructed samples in neighboring reference templates or neighboring reference blocks of the samples, to obtain the samples in the neighboring region of the reference template.

In some embodiments, the second determination unit 2501 is further configured to: if the samples outside the reference template and the reference block are used, not perform padding processing on samples in the neighboring region of the reference template, and skip the samples when the model parameters are determined.

In some embodiments, the samples in the neighboring region of the reference template being available includes at least one of:
the samples do not exceed a preset search range;
the samples do not exceed boundaries of a picture;
the samples do not exceed boundaries of a tile; or
the samples have been reconstructed.

In some embodiments, the second determination unit 2501 is further configured to: if samples in a neighboring region of the reference block are used, perform padding processing on the samples in the neighboring region of the reference block.

In some embodiments, the model parameters include coefficients of a target filter.

In some embodiments, the second determination unit 2501 is further configured to determine the coefficients of the target filter according to sample reference values in the first template and sample reference values in the matching template.

In some embodiments, the second determination unit 2501 is further configured to set the coefficients of the target filter to be coefficients used by the target filter when a first error between output values after processing the sample reference values in the matching template by the target filter and the sample reference values in the first template meets a first condition.

In some embodiments, the first condition is that the first error is minimum.

In some embodiments, the first condition is that the first error is within a first preset threshold range.

In some embodiments, the first condition is that variation of the first error is within a second preset threshold range.

In some embodiments, the second determination unit 2501 is further configured to: determine autocorrelation parameters according to the sample reference values in the matching template; determine cross-correlation parameters according to the sample reference values in the first template and the sample reference values in the matching template; and determine the coefficients of the target filter according to the autocorrelation parameters and the cross-correlation parameters.

In some embodiments, the sample reference values include at least one of a reconstructed sample value, a sample gradient value, or sample position information.

In some embodiments, a number of the coefficients of the target filter is equal to a first preset value.

In some embodiments, the decoding unit 2502 is further configured to decode the bitstream to determine a number of the coefficients of the target filter.

In some embodiments, the target filter is a one-dimensional or two-dimensional filter with a preset shape.

In some embodiments, the decoding unit 2502 is further configured to decode the bitstream to determine a shape of the target filter.

In some embodiments, the second filtering unit 2503 is further configured to: filter the reference block according to the model parameters, and determining a first output value of the target filter; and determine the filtered reference block based on the first output value of the target filter.

In some embodiments, the second filtering unit 2503 is further configured to: calculate a product of a reconstructed sample value of the reference block and a corresponding one of the coefficients of the target filter; and set the first output value of the target filter to be equal to a sum of n products, here n represents a number of the coefficients of the target filter, and n is a positive integer.

In some embodiments, the second filtering unit 2503 is further configured to: determine a first value of a reconstructed sample value of the reference block under a first mapping relationship; calculate a product of the first value and a corresponding one of the coefficients of the target filter; and set the first output value of the target filter to be equal to a sum of n products, here n represents a number of the coefficients of the target filter, and n is a positive integer.

In some embodiments, the second filtering unit 2503 is further configured to: determine a first offset value; and perform an addition operation according to the first output value and the first offset value, to determine the filtered reference block.

In some embodiments, the second determination unit 2501 is further configured to set the first offset value to be equal to a second preset value.

In some embodiments, the second determination unit 2501 is further configured to: determine a number of samples corresponding to the target filter and participating in filtering, based on a shape of the target filter; if the number of samples corresponding to the target filter and participating in filtering is m, determine (m+1) coefficients of the target filter, here m is a positive integer; and determine the first offset value according to a second offset value and one of the (m+1) coefficients.

In some embodiments, the second determination unit 2501 is further configured to: set the second offset value to be equal to a third preset value; or, set the second offset value to be equal to a value of a reconstructed sample value of the reference block under a second mapping relationship.

In some embodiments, the second prediction unit 2504 is further configured to perform second processing on the filtered reference block, to obtain the prediction value of the current block.

In some embodiments, the second processing is that the prediction value of the current block is set to be equal to the filtered reference block.

In some embodiments, the second processing is a clip operation that limits the filtered reference block within a preset numerical range.

In some embodiments, the second determination unit 2501 is further configured to: determine multiple groups of model parameters according to the first template and the matching template; construct multiple filter models according to the multiple groups of model parameters, filter the reference block according to the multiple filter models respectively, and determine multiple filtered reference blocks; and determine the prediction value of the current block according to the multiple filtered reference blocks.

In some embodiments, the second prediction unit 2504 is further configured to perform a weighted calculation on the multiple filtered reference blocks, to determine the prediction value of the current block.

In some embodiments, the decoding unit 2502 is further configured to decode the bitstream to determine a target model index value.

The second determination unit 2501 is further configured to determine, from the multiple filter models according to the target model index value, a target filter corresponding to the target model index value.

The second filtering unit 2503 is further configured to filter the reference block according to the target filter, and determine the prediction value of the current block.

In some embodiments, the second determination unit 2501 is further configured to: classify reconstructed samples in the first template and the matching template respectively according to a preset manner, to obtain multiple groups of sub-templates and multiple groups of sub-matching templates; and determine the multiple groups of model parameters according to the multiple groups of sub-templates and the multiple groups of sub-matching templates.

In some embodiments, the decoding unit 2502 is further configured to: decode the bitstream to determine a value of first syntax element identification information; and if the first syntax element identification information indicates that IBC is applied to the current block, decode the bitstream to determine a value of second syntax element identification information.

The second determination unit 2501 is further configured to: if the second syntax element identification information indicates that a filter model is applied to the current block, perform operations of filtering the reference block according to the model parameters, and determining the filtered reference block; and determining the prediction value of the current block according to the filtered reference block.

In some embodiments, the second determination unit 2501 is further configured to: if the second syntax element identification information indicates that the filter model is not applied to the current block, use a reconstructed sample value in the reference block as the prediction value of the current block.

In some embodiments, the second determination unit 2501 is further configured to: determine multiple reference blocks in a second search region and model parameters of each of the multiple reference blocks.

The second filtering unit 2503 is further configured to filter the multiple reference blocks respectively according to the model parameters of each of the multiple reference blocks, and determine multiple filtered reference blocks.

The second prediction unit 2504 is further configured to determine the prediction value of the current block according to the multiple filtered reference blocks.

In some embodiments, the decoding unit 2502 is further configured to decode the bitstream to determine a reference block index number. The second determination unit 2501 is further configured to determine the filtered reference block from the multiple filtered reference blocks according to the reference block index number.

In some embodiments, the decoding unit 2502 is further configured to decode the bitstream to determine a prediction residual of the current block.

The second determination unit 2501 is further configured to determine a reconstructed value of the current block according to the prediction value of the current block and the prediction residual of the current block.

It may be understood that in the embodiment of the disclosure, the “unit” may be a part of a circuit, a part of a processor, a part of a program or software, etc. Of course, the “unit” may be a module, or may be non-modular. Furthermore, various components in the embodiment may be integrated into a processing unit, or each unit may physically exist separately, or two or more units may be integrated into a unit. The above integrated unit may be implemented in a form of hardware or in a form of software functional module.

If the integrated unit is implemented in a form of software functional module and is not sold or used as an independent product, the integrated unit may be stored in a computer-readable storage medium. Based on such understanding, the embodiment provides a computer-readable storage medium, the computer-readable storage medium is applied to the decoder 250. The computer-readable storage medium has stored thereon a computer program, and when the computer program is executed by a second processor, the method described in any one of the foregoing embodiments is implemented.

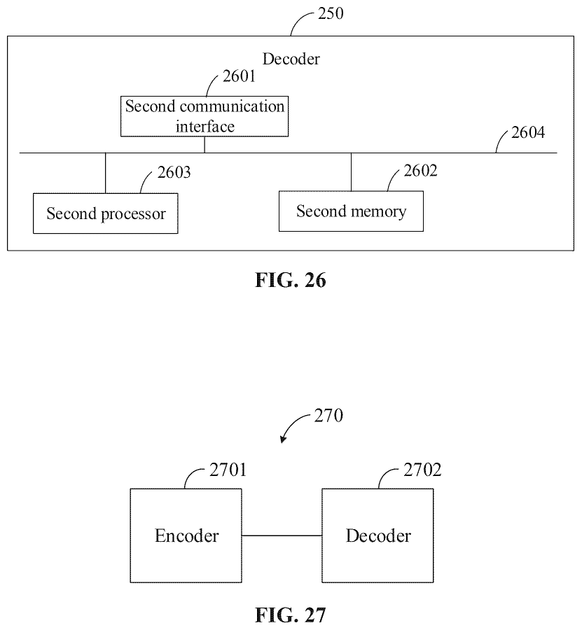

Based on compositions of the decoder 250 and the computer-readable storage medium, with reference to FIG. 26, a schematic diagram of specific hardware structures of the decoder 250 provided in an embodiment of the disclosure is shown. As shown in FIG. 26, the decoder 250 may include a second communication interface 2601, a second memory 2602 and a second processor 2603, various components are coupled together through a second bus system 2604. It may be understood that the second bus system 2604 is configured to achieve connection and communication between these components. The second bus system 2604 includes a power bus, a control bus and a status signal bus, besides a data bus. However, for the sake of clear explanations, various buses are marked as the second bus system 2604 in FIG. 26.

The second communication interface 2601 is configured to receive and send signals in a process of receiving/sending information from/to other external network elements.

The second memory 2602 is configured to store a computer program executable on the second processor 2603.

The second processor 2603 is configured to: when it executes the computer program, perform operations of:
determining a first template of a current block, and determining a BV candidate list of the current block;
decoding a bitstream to determine BV indication information, and determining a first BV according to the BV indication information and the BV candidate list;
determining a matching template and a reference block corresponding to the matching template according to the first BV; determining model parameters according to the first template and the matching template, filtering the reference block according to the model parameters, and determining a filtered reference block; and determining a prediction value of the current block according to the filtered reference block.

Optionally, as another embodiment, the second processor 2603 is further configured to perform the method described in any one of the foregoing embodiments when it executes the computer program.

It may be understood that hardware functions of the second memory 2602 are similar to those of the first memory 2402, and hardware functions of the second processor 2603 are similar to those of the first processor 2403, which will not be described in detail here.

The embodiment provides a decoder, in which model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

In yet another embodiment of the disclosure, with reference to FIG. 27, a schematic diagram of compositional structures of an encoding and decoding system provided in an embodiment of the disclosure is shown. As shown in FIG. 27, the encoding and decoding system 270 may include an encoder 2701 and a decoder 2702.

In the embodiment of the disclosure, the encoder 2701 may be the encoder described in any one of the foregoing embodiments, and the decoder 2702 may be the decoder described in any one of the foregoing embodiments.

The disclosure provides a method for encoding, a method for decoding, a bitstream, an encoder, a decoder, and a storage medium, which may improve prediction accuracy of the IBC, thereby saving the bit rate and improving encoding and decoding performance.

Technical solutions of the disclosure may be implemented as follows.

According to a first aspect, an embodiment of the disclosure provides a method for decoding, which is applied to a decoder, and includes the following operations.

A first template of a current block is determined, and a BV candidate list of the current block is determined.

A bitstream is decoded to determine BV indication information, and determine a first BV according to the BV indication information and the BV candidate list.

A matching template and a reference block corresponding to the matching template are determined according to the first BV.

Model parameters are determined according to the first template and the matching template, the reference block is filtered according to the model parameters, and a filtered reference block is determined.

A prediction value of the current block is determined according to the filtered reference block.

According to a second aspect, an embodiment of the disclosure provides a method for encoding, which is applied to an encoder, and includes the following operations.

A first template of a current block is determined, and a BV candidate list of the current block is determined.

A first BV is determined according to the BV candidate list.

A matching template and a reference block corresponding to the matching template are determined according to the first BV.

Model parameters are determined according to the first template and the matching template, the reference block is filtered according to the model parameters, and a filtered reference block is determined.

A prediction value of the current block is determined according to the filtered reference block.

According to a third aspect, an embodiment of the disclosure provides a bitstream, which is generated by bit encoding according to to-be-encoded information. The to-be-encoded information includes at least one of the following.

A prediction residual of a current block, BV indication information, a number of coefficients of a target filter, a shape of the target filter, a value of first syntax element identification information, or a value of second syntax element identification information, here the first syntax element identification information indicates whether IBC is applied to the current block, and the second syntax element identification information indicates whether a filter model is applied to the current block.

According to a fourth aspect, an embodiment of the disclosure provides an encoder, the encoder includes a first determination unit, a first filtering unit, and a first prediction unit.

The first determination unit is configured to determine a first template of a current block, and determine a BV candidate list of the current block.

The first determination unit is further configured to determine a first BV according to the BV candidate list, and determine a matching template and a reference block corresponding to the matching template according to the first BV.

The first filtering unit is configured to determine model parameters according to the first template and the matching template, filter the reference block according to the model parameters, and determine a filtered reference block.

The first prediction unit is configured to determine a prediction value of the current block according to the filtered reference block.

According to a fifth aspect, an embodiment of the disclosure provides an encoder, the encoder includes a first memory and a first processor.

The first memory is configured to store a computer program executable on the first processor.

The first processor is configured to perform the method as described in the second aspect when it executes the computer program.

According to a sixth aspect, an embodiment of the disclosure provides a decoder, the decoder includes a second determination unit, a decoding unit, a second filtering unit, and a second prediction unit.

The second determination unit is configured to determine a first template of a current block, and determine a BV candidate list of the current block.

The decoding unit is configured to decode a bitstream to determine BV indication information.

The second determination unit is further configured to determine a first BV according to the BV indication information and the BV candidate list, and determine a matching template and a reference block corresponding to the matching template according to the first BV.

The second filtering unit is configured to determine model parameters according to the first template and the matching template, filter the reference block according to the model parameters, and determine a filtered reference block.

The second prediction unit is configured to determine a prediction value of the current block according to the filtered reference block.

According to a seventh aspect, an embodiment of the disclosure provides a decoder, the decoder includes a second memory and a second processor.

The second memory is configured to store a computer program executable on the second processor.

The second processor is configured to perform the method as described in the first aspect when it executes the computer program.

According to an eighth aspect, an embodiment of the disclosure provides a computer-readable storage medium, the computer-readable storage medium has stored thereon a computer program. When the computer program is executed, the method as described in the first aspect is implemented, or the method as described in the second aspect is implemented.

It should be noted that in the disclosure, terms “including”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above serial numbers of the embodiments of the disclosure are only for the purpose of descriptions, and do not represent advantages and disadvantages of the embodiments.

The methods disclosed in several method embodiments provided in the disclosure may be arbitrarily combined without conflict, to obtain new method embodiments.

The features disclosed in several product embodiments provided in the disclosure may be arbitrarily combined without conflict, to obtain new product embodiments.

The features disclosed in several method or device embodiments provided in the disclosure may be arbitrarily combined without conflict, to obtain new method or device embodiments.

The above descriptions are only specific implementations of the disclosure, however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure should be subject to the scope of protection of the claims.

### INDUSTRIAL APPLICABILITY

In the embodiments of the disclosure, no matter at the encoding side or the decoding side, a first template of a current block is determined, a BV candidate list of the current block is determined, and a first BV is determined according to the BV candidate list; then, a matching template and a reference block corresponding to the matching template are determined according to the first BV; model parameters are determined according to the first template and the matching template, the reference block is filtered according to the model parameters, and a filtered reference block is determined; and a prediction value of the current block is determined according to the filtered reference block. At the decoding side, as to determination of the first BV, it also needs to decode a bitstream to determine BV indication information, and then determine the first BV according to the BV indication information and the BV candidate list, to determine the matching template and the reference block corresponding to the matching template. In this way, the model parameters are determined according to the first template and the matching template, the model parameters fully reflect correlation between the matching template and the first template of the current block, this correlation is applied to the reference block, such that reconstructed samples of the reference block are filtered and corrected, and then the filtered reconstructed samples are used as prediction samples of the current block, which may not only improve prediction accuracy and save the bit rate, but also effectively solve a problem that linear variation is present between the reference block and the current block; and may further improve encoding and decoding efficiency, thereby enhancing encoding and decoding performance.

1. A method for decoding, applied to a decoder, the method comprising:
determining a first template of a current block, and determining a Block Vector (BV) candidate list of the current block;
decoding a bitstream to determine BV indication information, and determining a first BV according to the BV indication information and the BV candidate list;
determining a matching template and a reference block corresponding to the matching template according to the first BV;
determining model parameters according to the first template and the matching template, filtering the reference block according to the model parameters, and determining a filtered reference block; and
determining a prediction value of the current block according to the filtered reference block.

2. The method of claim 1, wherein determining the BV candidate list of the current block comprises constructing the BV candidate list of the current block based on at least one candidate BV determined by at least one of the following manners:
at least one candidate BV determined based on a derivation manner of spatial BV candidates;
at least one candidate BV determined based on a derivation manner of history-based BV candidates;
at least one candidate BV determined based on a derivation manner of pairwise average candidates;
at least one candidate BV determined based on a derivation manner of zero-value BV candidates;
at least one candidate BV determined based on a derivation manner of candidates in a reference region corresponding to Intra Block Copy (IBC).

3. The method of claim 1, wherein the BV indication information comprises a BV index number,
determining the first BV according to the BV indication information and the BV candidate list comprises:
determining, from the BV candidate list, a candidate BV corresponding to the BV index number; and
using the candidate BV as the first BV.

4. The method of claim 1, wherein the BV indication information comprises a BV index number and a Block Vector Difference (BVD) value,
determining the first BV according to the BV indication information and the BV candidate list comprises:
determining, from the BV candidate list, a candidate BV corresponding to the BV index number; and
determining the first BV according to the candidate BV and the BVD value.

5. The method of claim 1, wherein the first BV is a luma BV, and the luma BV is configured to determine a luma component-based prediction value of the current block.

6. The method of claim 1, wherein the first BV is a luma BV, the method further comprises:
scaling the luma BV according to a preset chroma sampling format, to determine a scaled BV; and
refining the scaled BV to determine a chroma BV, wherein the chroma BV is configured to determine a chroma component-based prediction value of the current block.

7. The method of claim 1, wherein determining the matching template and the reference block corresponding to the matching template according to the first BV comprises:
determining a reference template and the reference block according to the first BV; and
in a case that the reference template meets a first preset condition, performing padding processing on samples in a neighboring region of the reference template, to determine the matching template.

8. The method of claim 1, wherein determining the matching template and the reference block corresponding to the matching template according to the first BV comprises:
determining a reference template and the reference block according to the first BV; and
in a case that the reference template meets a second preset condition, using the reference template as the matching template.

9. The method of claim 7, wherein performing the padding processing on the samples in the neighboring region of the reference template comprises:
determining whether the samples in the neighboring region of the reference template are available;
in a case that the samples in the neighboring region of the reference template are available, directly using the samples in the neighboring region of the reference template; and
in a case that the samples in the neighboring region of the reference template are unavailable, performing padding processing on the neighboring region of the reference template by copying reconstructed samples in neighboring reference templates or neighboring reference blocks of the samples, to obtain the samples in the neighboring region of the reference template.

10. The method of claim 9, wherein the samples in the neighboring region of the reference template being available comprises at least one of:
the samples do not exceed a preset search range;
the samples do not exceed boundaries of a picture;
the samples do not exceed boundaries of a tile; or
the samples have been reconstructed.

11. The method of claim 7, wherein filtering the reference block according to the model parameters, and determining the filtered reference block comprises:
in a case that samples in a neighboring region of the reference block are used, performing padding processing on the samples in the neighboring region of the reference block.

12. The method of claim 1, wherein determining the model parameters according to the first template and the matching template comprises: the model parameters comprising coefficients of a target filter,
wherein the method further comprises:
determining the coefficients of the target filter according to sample reference values in the first template and sample reference values in the matching template.

13. The method of claim 1, further comprising:
decoding the bitstream to determine a value of first syntax element identification information;
in a case that the first syntax element identification information indicates that Intra Block Copy (IBC) is applied to the current block, decoding the bitstream to determine a value of second syntax element identification information; and
in a case that the second syntax element identification information indicates that a filter model is applied to the current block, performing steps of filtering the reference block according to the model parameters, and determining the filtered reference block; and determining the prediction value of the current block according to the filtered reference block.

14. A method for encoding, applied to an encoder, comprising:
determining a first template of a current block, and determining a Block Vector (BV) candidate list of the current block;
determining a first BV according to the BV candidate list;
determining a matching template and a reference block corresponding to the matching template according to the first BV;
determining model parameters according to the first template and the matching template, filtering the reference block according to the model parameters, and determining a filtered reference block; and
determining a prediction value of the current block according to the filtered reference block.

15. The method of claim 14, further comprising:
determining a BV index number corresponding to the first BV, according to the BV candidate list; and
encoding the BV index number, and signalling obtained encoded bits into a bitstream.

16. The method of claim 14, further comprising:
determining a BV index number corresponding to the first BV, according to the BV candidate list;
determining a Block Vector Difference (BVD) value according to an initial BV of the current block and the first BV; and
encoding the BV index number and the BVD value, and signalling obtained encoded bits into a bitstream.

17. The method of claim 14, wherein determining the matching template and the reference block corresponding to the matching template according to the first BV comprises:
determining a reference template and the reference block according to the first BV; and
in a case that the reference template meets a first preset condition, performing padding processing on samples in a neighboring region of the reference template, to determine the matching template.

18. The method of claim 17, wherein filtering the reference block according to the model parameters, and determining the filtered reference block comprises:
in a case that samples in a neighboring region of the reference block are used, performing padding processing on the samples in the neighboring region of the reference block.

19. The method of claim 14, wherein determining the model parameters according to the first template and the matching template comprises: the model parameters comprising coefficients of a target filter,
wherein the method further comprising:
determining the coefficients of the target filter according to sample reference values in the first template and sample reference values in the matching template.

20. A non-transitory computer-readable storage medium, having a computer program and a bitstream stored thereon, wherein the computer program, when executed by a processor, enables the processor to perform operations to generate the bitstream, wherein the operations comprise:
determining a first template of a current block, and determining a Block Vector (BV) candidate list of the current block;
determining a first BV according to the BV candidate list;
determining a matching template and a reference block corresponding to the matching template according to the first BV;
determining model parameters according to the first template and the matching template, filtering the reference block according to the model parameters, and determining a filtered reference block; and
determining a prediction value of the current block according to the filtered reference block.
